(19) United States
(12) Patent Application Publication
(10) Pub. No.: US 2019/0281346 A1
(43) Pub. Date: Sep. 12, 2019

(54) BROADCAST SIGNAL RECEPTION APPARATUS AND BROADCAST SIGNAL PROCESSING METHOD

(71) Applicant: LG ELECTRONICS INC., Seoul (KR)

(72) Inventors: Somi PARK, Seoul (KR); Seungryul YANG, Seoul (KR); Minsung KWAK, Seoul (KR); Woosuk KO, Seoul (KR); Sungryong HONG, Seoul (KR)

(21) Appl. No.: 16/302,203

(22) PCT Filed: Jun. 9, 2017
(86) PCT No.: PCT/KR2017/006021

§ 371 Date: Nov. 16, 2018

Related U.S. Application Data
(60) Provisional application No. 62/348,153, filed on Jun. 10, 2016.
(60) Provisional application No. 62/354,120, filed on Jun. 24, 2016.
(60) Provisional application No. 62/435,833, filed on Dec. 18, 2016.

(51) Int. Cl. H04N 21/433; H04N 21/426; H04L 29/06; H04N 21/643

(52) U.S. Cl. CPC H04N 21/4331; H04N 21/64322; H04L 65/4076; H04N 21/426

(57) ABSTRACT

A broadcast signal reception apparatus according to one embodiment of the present invention comprises: a broadcast processor comprising a tuner, and a real-time object delivery over unidirectional transport (ROUTE) cache, wherein the tuner receives a broadcast signal including an ROUTE file, and the ROUTE cache stores the ROUTE file; and user agent for executing a broadcaster application; and an interface for connecting the broadcaster application to the broadcast processor, wherein the broadcaster application transmits a first request to the interface, and the broadcast processor transmits, to the interface, a first response corresponding to the first request.

### TECHNICAL FIELD

The present invention relates to a broadcast signal reception device and a method of processing a broadcast signal.

The present invention relates to a technology that enables a broadcaster application to access a resource in next generation broadcasting environment where a broadcasting network and Internet are interlocked. More particularly, the present invention relates to a technology that enables a broadcaster application to access a broadcast network resource and/or an internet resource stored (downloaded) in a receiver.

### BACKGROUND ART

As analog broadcast signal transmission is terminated, various technologies for transmitting and receiving a digital broadcast signal have been developed. A digital broadcast signal is capable of containing a larger amount of video/audio data than an analog broadcast signal and further containing various types of additional data as well as video/audio data.

### DISCLOSURE OF THE INVENTION

### Technical Problem

One object of the present invention is to provide a storage system capable of being accessed by an application and an EMP (embedded media player) of a receiver while following a sandbox policy via a cache storage system.

### Technical Solution

According to one aspect of the present invention, a broadcast signal reception device is disclosed.

To achieve these and other advantages and in accordance with the purpose of the present invention, as embodied and broadly described, according to one embodiment, a broadcast signal reception device includes a broadcast processor including a tuner and a ROUTE (Real-Time Object Delivery over Unidirectional Transport) cache, wherein the tuner receives a broadcast signal including a ROUTE file and the ROUTE cache stores the ROUTE file, a user agent configured to execute a broadcaster application, and an interface configured to connect the broadcast processor with the broadcaster application. In this case, the broadcaster application transmits a first request to the interface and the broadcast processor can transmit a first response to the interface in response to the first request.

According to a different embodiment of the present invention, the broadcast signal reception device can further include a ROUTE cache manager configured to manage the ROUTE file stored in the ROUTE cache.

According to a further different embodiment of the present invention, the broadcast processor further includes a local cache manager, the local cache manager manages a file stored in a local cache belonging to the broadcast processor, the local cache manager receives the first request from the interface, and the first response can be transmitted to the interface from the local cache manager.

According to a further different embodiment of the present invention, the local cache manager transmits the first request received from the interface to the ROUTE cache manager and the first response can be transmitted to the local cache manager from the ROUTE cache manager.

According to a further different embodiment of the present invention, the broadcast processor further includes a cache storage manager and cache storage, the cache storage manager manages a file stored in the cache storage, the local cache manager transmits the first request received from the interface to the cache storage manager, and the first response can be transmitted to the local cache manager from the cache storage manager.

According to a further different embodiment of the present invention, the cache storage can include a long term cache and a short term cache.

According to a further different embodiment of the present invention, the broadcaster application and the interface can be connected via a websocket protocol.

According to a further different embodiment of the present invention, the first request and the first response may correspond to JSON-RPC messages.

According to a further different embodiment of the present invention, the broadcast processor is included in a primary device and the user agent can be included in a companion device.

According to another aspect of the present invention, a method of processing a broadcast signal is disclosed.

To further achieve these and other advantages and in accordance with the purpose of the present invention, according to one embodiment, a method of processing a broadcast signal using a broadcast processor and a user agent configured to execute a broadcaster application, includes the steps of transmitting, by the broadcaster application, a first request via an interface configured to connect the broadcast processor with the broadcaster application, performing, by the broadcast processor, an action in response to the first request, and transmitting, by the broadcast processor, a first response to the interface in response to the first request.

According to a different embodiment, the method can further include the steps of receiving, by the broadcast processor, a broadcast signal including a ROUTE (Real-Time Object Delivery over Unidirectional Transport) file and storing, by the broadcast processor, the ROUTE file in a ROUTE cache included in the broadcast processor.

According to a further different embodiment, the broadcaster application and the interface can be connected via a websocket protocol.

According to a further different embodiment, the first request and the first response may correspond to JSON-RPC messages.

### Advantageous Effects

According to one embodiment of the present invention, it is able to provide a storage system capable of being accessed by an application and an EMP (embedded media player) of a receiver while following a sandbox policy via a cache storage system.

According to one embodiment of the present invention, an application is able to access a file transmitted via a broadcast network and an EMP (embedded media player) of a receiver can access a file for a web browser.

### DESCRIPTION OF DRAWINGS

FIG. 1 is a diagram showing a protocol stack according to an embodiment of the present invention;

FIG. 2 is a diagram showing a service discovery procedure according to one embodiment of the present invention;

FIG. 3 is a diagram showing a low level signaling (LLS) table and a service list table (SLT) according to one embodiment of the present invention;

FIG. 4 is a diagram showing a USBD and an S-TSID delivered through ROUTE according to one embodiment of the present invention;

FIG. 5 is a diagram showing a USBD delivered through an MMT according to one embodiment of the present invention;

FIG. 6 is a diagram showing link layer operation according to one embodiment of the present invention;

FIG. 7 is a diagram showing a link mapping table (LMT) according to one embodiment of the present invention;

FIG. 8 is a diagram showing a structure of a broadcast signal transmission device of a next-generation broadcast service according to an embodiment of the present invention;

FIG. 9 is a writing operation of a time interleaver according to an embodiment of the present invention;

FIG. 10 is a block diagram of an interleaving address generator including a main-PRBS generator and a sub-PRBS generator according to each HT mode, included in the frequency interleaver, according to an embodiment of the present invention;

FIG. 11 illustrates a hybrid broadcast reception device according to an embodiment of the present invention.

FIG. 12 is a block diagram illustrating a hybrid broadcast receiver according to an embodiment of the present invention;

FIG. 13 illustrates a hybrid broadcast reception device according to a different embodiment of the present invention;

FIG. 14 is a table illustrating whether or not it is able to access a segment file using a combination of an MPD location and a segment file location indicated by MPD and an MPD location of each combination;

FIG. 15 is a diagram illustrating a structure of a manifest according to one embodiment of the present invention;

FIG. 16 is a diagram illustrating a configuration and an operation of a receiver according to one embodiment of the present invention;

FIG. 17 is a diagram illustrating a configuration and an operation of a receiver according to a different embodiment of the present invention;

FIG. 18 is a diagram illustrating a configuration and an operation of a receiver according to a further different embodiment of the present invention;

FIG. 19 is a diagram illustrating a configuration and an operation of a receiver according to a further different embodiment of the present invention;

FIG. 20 is a diagram illustrating an embodiment of implementing API provided by HTTP proxy using JSON RPC;

FIG. 21 is a diagram illustrating IsStorgae scheme and an example;

FIG. 22 is a diagram illustrating a RequestManifest scheme;

FIG. 23 is a diagram illustrating an example of a RequestManifest scheme;

FIG. 24 is a diagram illustrating a Request Cache Storage Status scheme and an example;

FIG. 25 is a diagram illustrating a Cache Fetch scheme and an example;

FIG. 26 is a diagram illustrating a Cache Save scheme;

FIG. 27 is a diagram illustrating an example of a Cache Save scheme;

FIG. 28 is a diagram illustrating a Cache Delete scheme and an example;

FIG. 29 is a diagram illustrating a Cache Move scheme;

FIG. 30 is a diagram illustrating an example of a Cache Move scheme;

FIG. 31 is a diagram illustrating an Is Cache scheme and an example;

FIG. 32 is a diagram illustrating a Cache clear scheme and an example;

FIG. 33 is a diagram illustrating an operation of a receiver according to one embodiment of the present invention;

FIG. 34 is a diagram illustrating a manifest configured according to an operation of a receiver illustrated in FIG. 33;

FIG. 35 is a diagram illustrating an operation of a receiver according to a different embodiment of the present invention;

FIG. 36 is a diagram illustrating an operation of a receiver according to a further different embodiment of the present invention;

FIG. 37 is a diagram illustrating a manifest configured according to an operation of a receiver illustrated in FIG. 36;

FIG. 38 is a diagram illustrating an operation of a receiver according to a further different embodiment of the present invention;

FIG. 39 is a diagram illustrating an operation of a receiver according to a further different embodiment of the present invention;

FIG. 40 is a diagram illustrating an operation of a receiver according to a further different embodiment of the present invention;

FIG. 41 is a diagram illustrating an operation of a receiver according to a further different embodiment of the present invention;

FIG. 42 is a diagram illustrating a manifest configured according to an operation of a receiver illustrated in FIG. 41;

FIG. 43 is a diagram illustrating an operation of a receiver according to a further different embodiment of the present invention;

FIG. 44 is a diagram illustrating an operation of a receiver according to a further different embodiment of the present invention;

FIG. 45 is a diagram illustrating an operation of a receiver according to a further different embodiment of the present invention;

FIG. 46 is a diagram illustrating an operation of a receiver according to a further different embodiment of the present invention;

FIG. 47 is a diagram illustrating a manifest configured according to an operation of a receiver illustrated in FIG. 46;

FIG. 48 is a diagram illustrating an operation of a receiver according to one embodiment of the present invention;

FIG. 49 is a diagram illustrating a manifest configured according to an operation of a receiver illustrated in FIG. 48;

FIG. 50 is a block diagram illustrating a broadcast signal reception device according to one embodiment of the present invention;

FIG. 51 is a flowchart for a method of processing a broadcast signal according to one embodiment of the present invention.

### BEST MODE

Reference will now be made in detail to the preferred embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the present invention. The following detailed description includes specific details in order to provide a thorough understanding of the present invention. However, it will be apparent to those skilled in the art that the present invention may be practiced without such specific details.

Although the terms used in the present invention are selected from generally known and used terms, some of the terms mentioned in the description of the present invention have been selected by the applicant at his or her discretion, the detailed meanings of which are described in relevant parts of the description herein. Furthermore, it is required that the present invention is understood, not simply by the actual terms used but by the meanings of each term lying within.

The present invention provides apparatuses and methods for transmitting and receiving broadcast signals for future broadcast services. Future broadcast services according to an embodiment of the present invention include a terrestrial broadcast service, a mobile broadcast service, an ultra high definition television (UHDTV) service, etc. The present invention may process broadcast signals for the future broadcast services through non-MIMO (Multiple Input Multiple Output) or MIMO according to one embodiment. A non-MIMO scheme according to an embodiment of the present invention may include a MISO (Multiple Input Single Output) scheme, a SISO (Single Input Single Output) scheme, etc.

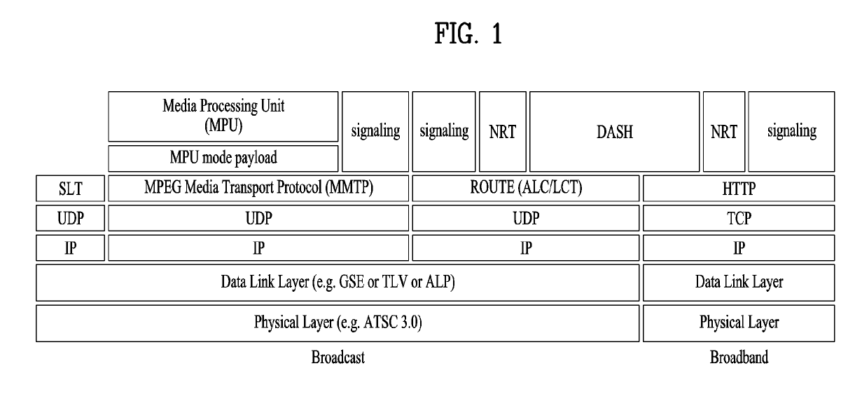

FIG. 1 is a diagram showing a protocol stack according to an embodiment of the present invention.

A service may be delivered to a receiver through a plurality of layers. First, a transmission side may generate service data. The service data may be processed for transmission at a delivery layer of the transmission side and the service data may be encoded into a broadcast signal and transmitted over a broadcast or broadband network at a physical layer.

Here, the service data may be generated in an ISO base media file format (BMFF). ISO BMFF media files may be used for broadcast/broadband network delivery, media encapsulation and/or synchronization format. Here, the service data is all data related to the service and may include service components configuring a linear service, signaling information thereof, non real time (NRT) data and other files.

The delivery layer will be described. The delivery layer may provide a function for transmitting service data. The service data may be delivered over a broadcast and/or broadband network.

Broadcast service delivery may include two methods.

As a first method, service data may be processed in media processing units (MPUs) based on MPEG media transport (MMT) and transmitted using an MMT protocol (MMTP). In this case, the service data delivered using the MMTP may include service components for a linear service and/or service signaling information thereof.

As a second method, service data may be processed into DASH segments and transmitted using real time object delivery over unidirectional transport (ROUTE), based on MPEG DASH. In this case, the service data delivered through the ROUTE protocol may include service components for a linear service, service signaling information thereof and/or NRT data. That is, the NRT data and non-timed data such as files may be delivered through ROUTE.

Data processed according to MMTP or ROUTE protocol may be processed into IP packets through a UDP/IP layer. In service data delivery over the broadcast network, a service list table (SLT) may also be delivered over the broadcast network through a UDP/IP layer. The SLT may be delivered in a low level signaling (LLS) table. The SLT and LLS table will be described later.

IP packets may be processed into link layer packets in a link layer. The link layer may encapsulate various formats of data delivered from a higher layer into link layer packets and then deliver the packets to a physical layer. The link layer will be described later.

In hybrid service delivery, at least one service element may be delivered through a broadband path. In hybrid service delivery, data delivered over broadband may include service components of a DASH format, service signaling information thereof and/or NRT data. This data may be processed through HTTP/TCP/IP and delivered to a physical layer for broadband transmission through a link layer for broadband transmission.

The physical layer may process the data received from the delivery layer (higher layer and/or link layer) and transmit the data over the broadcast or broadband network. A detailed description of the physical layer will be given later.

The service will be described. The service may be a collection of service components displayed to a user, the components may be of various media types, the service may be continuous or intermittent, the service may be real time or non real time, and a real-time service may include a sequence of TV programs.

The service may have various types. First, the service may be a linear audio/video or audio service having app based enhancement. Second, the service may be an app based service, reproduction/configuration of which is controlled by a downloaded application. Third, the service may be an ESG service for providing an electronic service guide (ESG). Fourth, the service may be an emergency alert (EA) service for providing emergency alert information.

When a linear service without app based enhancement is delivered over the broadcast network, the service component may be delivered by (1) one or more ROUTE sessions or (2) one or more MMTP sessions.

When a linear service having app based enhancement is delivered over the broadcast network, the service component may be delivered by (1) one or more ROUTE sessions or (2) zero or more MMTP sessions. In this case, data used for app based enhancement may be delivered through a ROUTE session in the form of NRT data or other files. In one embodiment of the present invention, simultaneous delivery of linear service components (streaming media components) of one service using two protocols may not be allowed.

When an app based service is delivered over the broadcast network, the service component may be delivered by one or more ROUTE sessions. In this case, the service data used for the app based service may be delivered through the ROUTE session in the form of NRT data or other files.

Some service components of such a service, some NRT data, files, etc. may be delivered through broadband (hybrid service delivery).

That is, in one embodiment of the present invention, linear service components of one service may be delivered through the MMT protocol. In another embodiment of the present invention, the linear service components of one service may be delivered through the ROUTE protocol. In another embodiment of the present invention, the linear service components of one service and NRT data (NRT service components) may be delivered through the ROUTE protocol. In another embodiment of the present invention, the linear service components of one service may be delivered through the MMT protocol and the NRT data (NRT service components) may be delivered through the ROUTE protocol. In the above-described embodiments, some service components of the service or some NRT data may be delivered through broadband. Here, the app based service and data regarding app based enhancement may be delivered over the broadcast network according to ROUTE or through broadband in the form of NRT data. NRT data may be referred to as locally cached data.

Each ROUTE session includes one or more LCT sessions for wholly or partially delivering content components configuring the service. In streaming service delivery, the LCT session may deliver individual components of a user service, such as audio, video or closed caption stream. The streaming media is formatted into a DASH segment.

Each MMTP session includes one or more MMTP packet flows for delivering all or some of content components or an MMT signaling message. The MMTP packet flow may deliver a component formatted into MPU or an MMT signaling message.

For delivery of an NRT user service or system metadata, the LCT session delivers a file based content item. Such content files may include consecutive (timed) or discrete (non-timed) media components of the NRT service or metadata such as service signaling or ESG fragments. System metadata such as service signaling or ESG fragments may be delivered through the signaling message mode of the MMTP.

A receiver may detect a broadcast signal while a tuner tunes to frequencies. The receiver may extract and send an SLT to a processing module. The SLT parser may parse the SLT and acquire and store data in a channel map. The receiver may acquire and deliver bootstrap information of the SLT to a ROUTE or MMT client. The receiver may acquire and store an SLS. USBD may be acquired and parsed by a signaling parser.

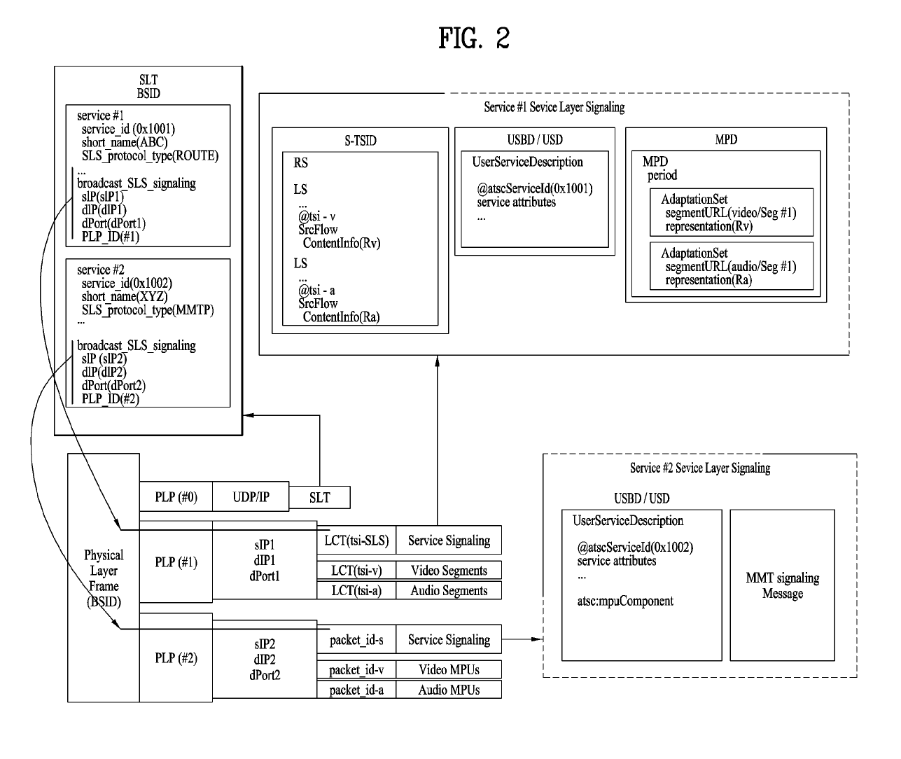

FIG. 2 is a diagram showing a service discovery procedure according to one embodiment of the present invention.

A broadcast stream delivered by a broadcast signal frame of a physical layer may carry low level signaling (LLS). LLS data may be carried through payload of IP packets delivered to a well-known IP address/port. This LLS may include an SLT according to type thereof. The LLS data may be formatted in the form of an LLS table. A first byte of every UDP/IP packet carrying the LLS data may be the start of the LLS table. Unlike the shown embodiment, an IP stream for delivering the LLS data may be delivered to a PLP along with other service data.

The SLT may enable the receiver to generate a service list through fast channel scan and provides access information for locating the SLS. The SLT includes bootstrap information. This bootstrap information may enable the receiver to acquire service layer signaling (SLS) of each service. When the SLS, that is, service signaling information, is delivered through ROUTE, the bootstrap information may include an LCT channel carrying the SLS, a destination IP address of a ROUTE session including the LCT channel and destination port information. When the SLS is delivered through the MMT, the bootstrap information may include a destination IP address of an MMTP session carrying the SLS and destination port information.

In the shown embodiment, the SLS of service #1 described in the SLT is delivered through ROUTE and the SLT may include bootstrap information sIP1, dIP1 and dPort1 of the ROUTE session including the LCT channel delivered by the SLS. The SLS of service #2 described in the SLT is delivered through MMT and the SLT may include bootstrap information sIP2, dIP2 and dPort2 of the MMTP session including the MMTP packet flow delivered by the SLS.

The SLS is signaling information describing the properties of the service and may include receiver capability information for significantly reproducing the service or providing information for acquiring the service and the service component of the service. When each service has separate service signaling, the receiver acquires appropriate SLS for a desired service without parsing all SLSs delivered within a broadcast stream.

When the SLS is delivered through the ROUTE protocol, the SLS may be delivered through a dedicated LCT channel of a ROUTE session indicated by the SLT. In some embodiments, this LCT channel may be an LCT channel identified by tsi=0. In this case, the SLS may include a user service bundle description (USBD)/user service description (USD), service-based transport session instance description (S-TSID) and/or media presentation description (MPD).

Here, USBD/USD is one of SLS fragments and may serve as a signaling hub describing detailed description information of a service. The USBD may include service identification information, device capability information, etc. The USBD may include reference information (URI reference) of other SLS fragments (S-TSID, MPD, etc.). That is, the USBD/USD may reference the S-TSID and the MPD. In addition, the USBD may further include metadata information for enabling the receiver to decide a transmission mode (broadcast/broadband network). A detailed description of the USBD/USD will be given below.

The S-TSID is one of SLS fragments and may provide overall session description information of a transport session carrying the service component of the service. The S-TSID may provide the ROUTE session through which the service component of the service is delivered and/or transport session description information for the LCT channel of the ROUTE session. The S-TSID may provide component acquisition information of service components associated with one service. The S-TSID may provide mapping between DASH representation of the MPD and the tsi of the service component. The component acquisition information of the S-TSID may be provided in the form of the identifier of the associated DASH representation and tsi and may or may not include a PLP ID in some embodiments. Through the component acquisition information, the receiver may collect audio/video components of one service and perform buffering and decoding of DASH media segments. The S-TSID may be referenced by the USBD as described above. A detailed description of the S-TSID will be given below.

The MPD is one of SLS fragments and may provide a description of DASH media presentation of the service. The MPD may provide a resource identifier of media segments and provide context information within the media presentation of the identified resources. The MPD may describe DASH representation (service component) delivered over the broadcast network and describe additional DASH presentation delivered over broadband (hybrid delivery). The MPD may be referenced by the USBD as described above.

When the SLS is delivered through the MMT protocol, the SLS may be delivered through a dedicated MMTP packet flow of the MMTP session indicated by the SLT. In some embodiments, the packet_id of the MMTP packets delivering the SLS may have a value of 00. In this case, the SLS may include a USBD/USD and/or MMT packet (MP) table.

Here, the USBD is one of SLS fragments and may describe detailed description information of a service as in ROUTE. This USBD may include reference information (URI information) of other SLS fragments. The USBD of the MMT may reference an MP table of MMT signaling. In some embodiments, the USBD of the MMT may include reference information of the S-TSID and/or the MPD. Here, the S-TSID is for NRT data delivered through the ROUTE protocol. Even when a linear service component is delivered through the MMT protocol, NRT data may be delivered via the ROUTE protocol. The MPD is for a service component delivered over broadband in hybrid service delivery. The detailed description of the USBD of the MMT will be given below.

The MP table is a signaling message of the MMT for MPU components and may provide overall session description information of an MMTP session carrying the service component of the service. In addition, the MP table may include a description of an asset delivered through the MMTP session. The MP table is streaming signaling information for MPU components and may provide a list of assets corresponding to one service and location information (component acquisition information) of these components. The detailed description of the MP table may be defined in the MMT or modified. Here, the asset is a multimedia data entity, is combined by one unique ID, and may mean a data entity used to one multimedia presentation. The asset may correspond to service components configuring one service. A streaming service component (MPU) corresponding to a desired service may be accessed using the MP table. The MP table may be referenced by the USBD as described above.

The other MMT signaling messages may be defined. Additional information associated with the service and the MMTP session may be described by such MMT signaling messages.

The ROUTE session is identified by a source IP address, a destination IP address and a destination port number. The LCT session is identified by a unique transport session identifier (TSI) within the range of a parent ROUTE session. The MMTP session is identified by a destination IP address and a destination port number. The MMTP packet flow is identified by a unique packet_id within the range of a parent MMTP session.

In case of ROUTE, the S-TSID, the USBD/USD, the MPD or the LCT session delivering the same may be referred to as a service signaling channel. In case of MMTP, the USBD/UD, the MMT signaling message or the packet flow delivering the same may be referred to as a service signaling channel.

Unlike the shown embodiment, one ROUTE or MMTP session may be delivered over a plurality of PLPs. That is, one service may be delivered through one or more PLPs. Unlike the shown embodiment, in some embodiments, components configuring one service may be delivered through different ROUTE sessions. In addition, in some embodiments, components configuring one service may be delivered through different MMTP sessions. In some embodiments, components configuring one service may be divided and delivered in a ROUTE session and an MMTP session. Although not shown, components configuring one service may be delivered through broadband (hybrid delivery).

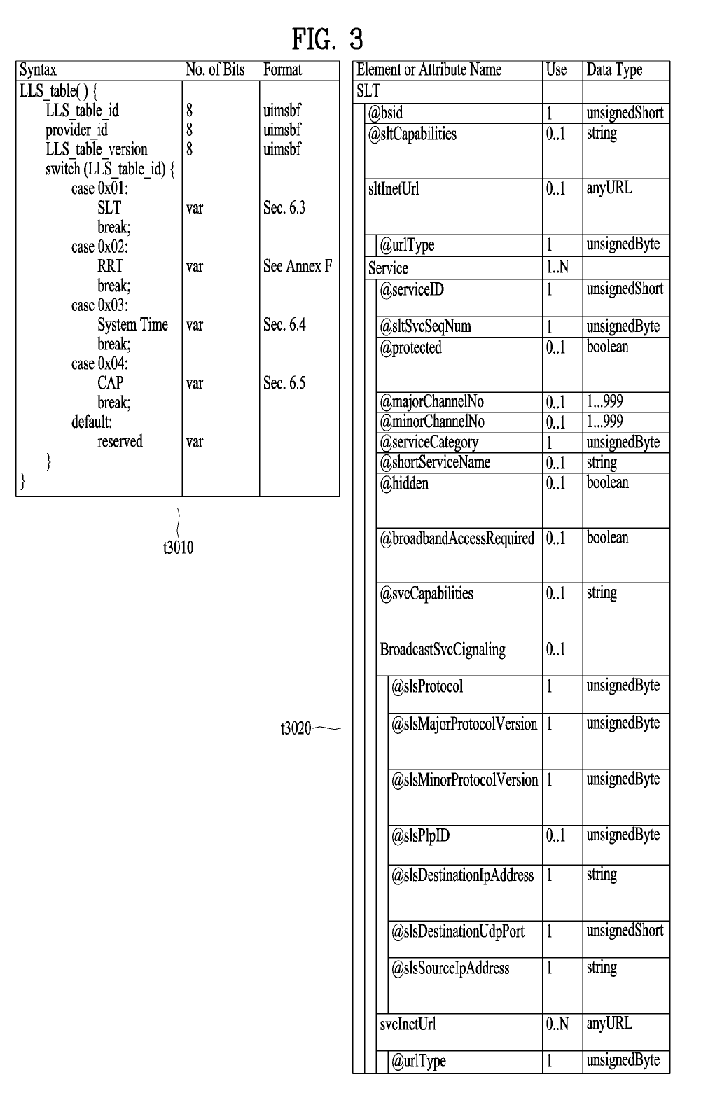

FIG. 3 is a diagram showing a low level signaling (LLS) table and a service list table (SLT) according to one embodiment of the present invention.

One embodiment t3010 of the LLS table may include information according to an LLS_table_id field, a provider_id field, an LLS_table_version field and/or an LLS_table_id field.

The LLS_table_id field may identify the type of the LLS table, and the provider_id field may identify a service provider associated with services signaled by the LLS table. Here, the service provider is a broadcaster using all or some of the broadcast streams and the provider_id field may identify one of a plurality of broadcasters which is using the broadcast streams. The LLS_table_version field may provide the version information of the LLS table.

According to the value of the LLS_table_id field, the LLS table may include one of the above-described SLT, a rating region table (RRT) including information on a content advisory rating, SystemTime information for providing information associated with a system time, a common alert protocol (CAP) message for providing information associated with emergency alert. In some embodiments, the other information may be included in the LLS table.

One embodiment t3020 of the shown SLT may include an @bsid attribute, an @sltCapabilities attribute, an sltInetUrl element and/or a Service element. Each field may be omitted according to the value of the shown Use column or a plurality of fields may be present.

The @bsid attribute may be the identifier of a broadcast stream. The @sltCapabilities attribute may provide capability information required to decode and significantly reproduce all services described in the SLT. The sltInetUrl element may provide base URL information used to obtain service signaling information and ESG for the services of the SLT over broadband. The sltInetUrl element may further include an @urlType attribute, which may indicate the type of data capable of being obtained through the URL.

The Service element may include information on services described in the SLT, and the Service element of each service may be present. The Service element may include an @serviceId attribute, an @sltSvcSeqNum attribute, an @protected attribute, an @majorChannelNo attribute, an @minorChannelNo attribute, an @serviceCategory attribute, an @shortServiceName attribute, an @hidden attribute, an @broadbandAccessRequired attribute, an @svcCapabilities attribute, a BroadcastSvcSignaling element and/or an svcInetUrl element.

The @serviceId attribute is the identifier of the service and the @sltSvcSeqNum attribute may indicate the sequence number of the SLT information of the service. The @protected attribute may indicate whether at least one service component necessary for significant reproduction of the service is protected. The @majorChannelNo attribute and the @minorChannelNo attribute may indicate the major channel number and minor channel number of the service, respectively.

The @serviceCategory attribute may indicate the category of the service. The category of the service may include a linear A/V service, a linear audio service, an app based service, an ESG service, an EAS service, etc. The @shortServiceName attribute may provide the short name of the service. The @hidden attribute may indicate whether the service is for testing or proprietary use. The @broadbandAccessRequired attribute may indicate whether broadband access is necessary for significant reproduction of the service. The @svcCapabilities attribute may provide capability information necessary for decoding and significant reproduction of the service.

The BroadcastSvcSignaling element may provide information associated with broadcast signaling of the service. This element may provide information such as location, protocol and address with respect to signaling over the broadcast network of the service. Details thereof will be described below.

The svcInetUrl element may provide URL information for accessing the signaling information of the service over broadband. The sltInetUrl element may further include an @urlType attribute, which may indicate the type of data capable of being obtained through the URL.

The above-described BroadcastSvcSignaling element may include an @slsProtocol attribute, an @slsMajorProtocolVersion attribute, an @slsMinorProtocolVersion attribute, an @slsPlpId attribute, an @slsDestinationIpAddress attribute, an @slsDestinationUdpPort attribute and/or an @slsSourceIpAddress attribute.

The @slsProtocol attribute may indicate the protocol used to deliver the SLS of the service (ROUTE, MMT, etc.). The @slsMajorProtocolVersion attribute and the @slsMinorProtocolVersion attribute may indicate the major version number and minor version number of the protocol used to deliver the SLS of the service, respectively.

The @slsPlpId attribute may provide a PLP identifier for identifying the PLP delivering the SLS of the service. In some embodiments, this field may be omitted and the PLP information delivered by the SLS may be checked using a combination of the information of the below-described LMT and the bootstrap information of the SLT.

The @slsDestinationIpAddress attribute, the @slsDestinationUdpPort attribute and the @slsSourceIpAddress attribute may indicate the destination IP address, destination UDP port and source IP address of the transport packets delivering the SLS of the service, respectively. These may identify the transport session (ROUTE session or MMTP session) delivered by the SLS. These may be included in the bootstrap information.

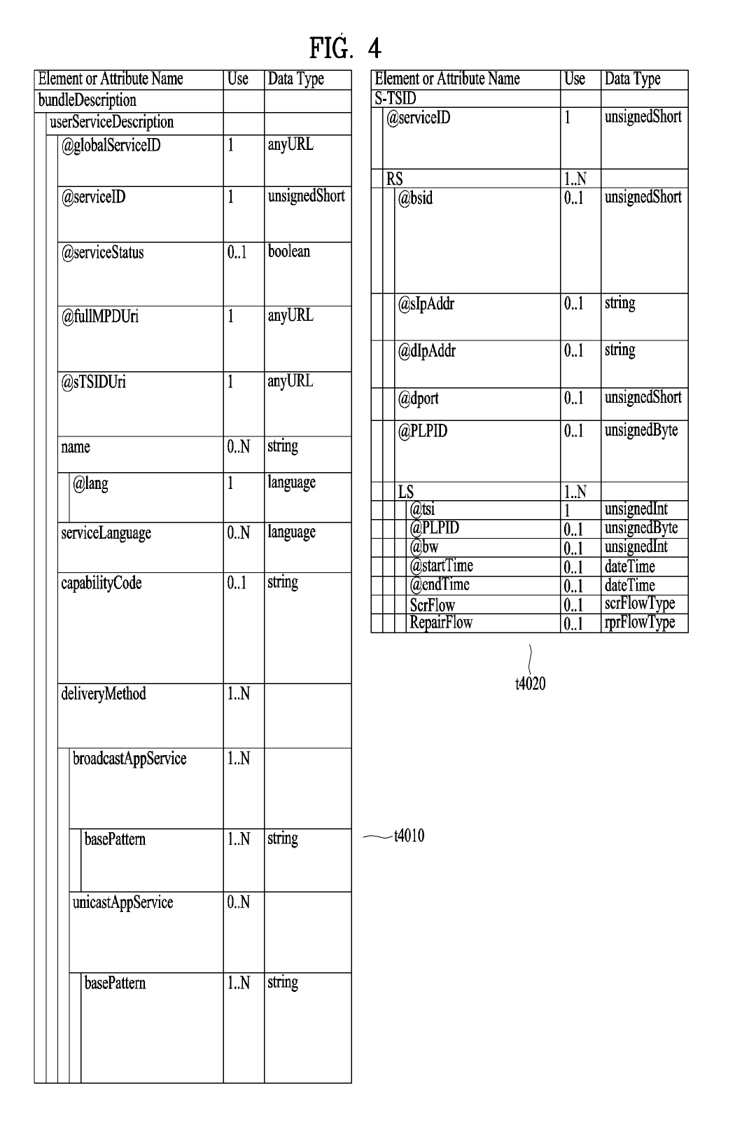

FIG. 4 is a diagram showing a USBD and an S-TSID delivered through ROUTE according to one embodiment of the present invention.

One embodiment t4010 of the shown USBD may have a bundleDescription root element. The bundleDescription root element may have a userServiceDescription element. The userServiceDescription element may be an instance of one service.

The userServiceDescription element may include an @globalServiceID attribute, an @serviceId attribute, an @serviceStatus attribute, an @fullMPDUri attribute, an @sTSIDUri attribute, a name element, a serviceLanguage element, a capabilityCode element and/or a deliveryMethod element. Each field may be omitted according to the value of the shown Use column or a plurality of fields may be present.

The @globalServiceID attribute is the globally unique identifier of the service and may be used for link with ESG data (Service@globalServiceID). The @serviceId attribute is a reference corresponding to the service entry of the SLT and may be equal to the service ID information of the SLT. The @serviceStatus attribute may indicate the status of the service. This field may indicate whether the service is active or inactive.

The @fullMPDUri attribute may reference the MPD fragment of the service. The MPD may provide a reproduction description of a service component delivered over the broadcast or broadband network as described above. The @sTSIDUri attribute may reference the S-TSID fragment of the service. The S-TSID may provide parameters associated with access to the transport session carrying the service as described above.

The name element may provide the name of the service. This element may further include an @lang attribute and this field may indicate the language of the name provided by the name element. The serviceLanguage element may indicate available languages of the service. That is, this element may arrange the languages capable of being provided by the service.

The capabilityCode element may indicate capability or capability group information of a receiver necessary to significantly reproduce the service. This information is compatible with capability information format provided in service announcement.

The deliveryMethod element may provide transmission related information with respect to content accessed over the broadcast or broadband network of the service. The deliveryMethod element may include a broadcastAppService element and/or a unicastAppService element. Each of these elements may have a basePattern element as a sub element.

The broadcastAppService element may include transmission associated information of the DASH representation delivered over the broadcast network. The DASH representation may include media components over all periods of the service presentation.

The basePattern element of this element may indicate a character pattern used for the receiver to perform matching with the segment URL. This may be used for a DASH client to request the segments of the representation. Matching may imply delivery of the media segment over the broadcast network.

The unicastAppService element may include transmission related information of the DASH representation delivered over broadband. The DASH representation may include media components over all periods of the service media presentation.

The basePattern element of this element may indicate a character pattern used for the receiver to perform matching with the segment URL. This may be used for a DASH client to request the segments of the representation. Matching may imply delivery of the media segment over broadband.

One embodiment t4020 of the shown S-TSID may have an S-TSID root element. The S-TSID root element may include an @serviceId attribute and/or an RS element. Each field may be omitted according to the value of the shown Use column or a plurality of fields may be present.

The @serviceId attribute is the identifier of the service and may reference the service of the USBD/USD. The RS element may describe information on ROUTE sessions through which the service components of the service are delivered. According to the number of ROUTE sessions, a plurality of elements may be present. The RS element may further include an @bsid attribute, an @sIpAddr attribute, an @dIpAddr attribute, an @dport attribute, an @PLPID attribute and/or an LS element.

The @bsid attribute may be the identifier of a broadcast stream in which the service components of the service are delivered. If this field is omitted, a default broadcast stream may be a broadcast stream including the PLP delivering the SLS of the service. The value of this field may be equal to that of the @bsid attribute.

The @sIpAddr attribute, the @dIpAddr attribute and the @dport attribute may indicate the source IP address, destination IP address and destination UDP port of the ROUTE session, respectively. When these fields are omitted, the default values may be the source address, destination IP address and destination UDP port values of the current ROUTE session delivering the SLS, that is, the S-TSID. This field may not be omitted in another ROUTE session delivering the service components of the service, not in the current ROUTE session.

The @PLPID attribute may indicate the PLP ID information of the ROUTE session. If this field is omitted, the default value may be the PLP ID value of the current PLP delivered by the S-TSID. In some embodiments, this field is omitted and the PLP ID information of the ROUTE session may be checked using a combination of the information of the below-described LMT and the IP address/UDP port information of the RS element.

The LS element may describe information on LCT channels through which the service components of the service are transmitted. According to the number of LCT channel, a plurality of elements may be present. The LS element may include an @tsi attribute, an @PLPID attribute, an @bw attribute, an @startTime attribute, an @endTime attribute, a SrcFlow element and/or a RepairFlow element.

The @tsi attribute may indicate the tsi information of the LCT channel. Using this, the LCT channels through which the service components of the service are delivered may be identified. The @PLPID attribute may indicate the PLP ID information of the LCT channel. In some embodiments, this field may be omitted. The @bw attribute may indicate the maximum bandwidth of the LCT channel. The @startTime attribute may indicate the start time of the LCT session and the @endTime attribute may indicate the end time of the LCT channel.

The SrcFlow element may describe the source flow of ROUTE. The source protocol of ROUTE is used to transmit a delivery object and at least one source flow may be established within one ROUTE session. The source flow may deliver associated objects as an object flow.

The RepairFlow element may describe the repair flow of ROUTE. Delivery objects delivered according to the source protocol may be protected according to forward error correction (FEC) and the repair protocol may define an FEC framework enabling FEC protection.

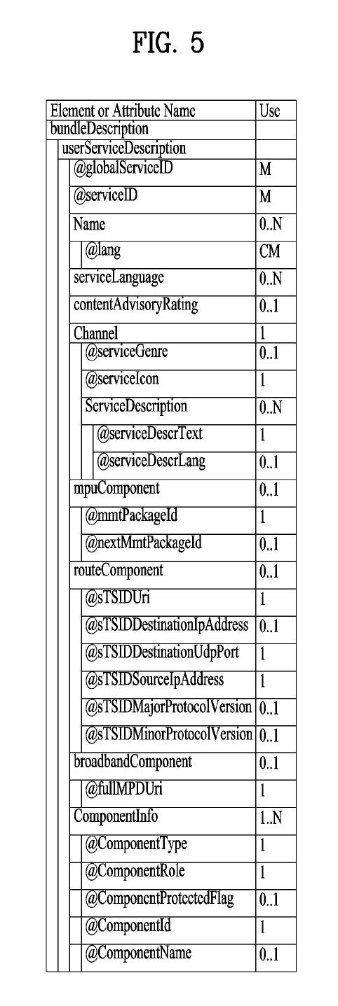

FIG. 5 is a diagram showing a USBD delivered through MMT according to one embodiment of the present invention.

One embodiment of the shown USBD may have a bundleDescription root element. The bundleDescription root element may have a userServiceDescription element. The userServiceDescription element may be an instance of one service.

The userServiceDescription element may include an @globalServiceID attribute, an @serviceId attribute, a Name element, a serviceLanguage element, a contentAdvisoryRating element, a Channel element, a mpuComponent element, a routeComponent element, a broadbandComponent element and/or a ComponentInfo element. Each field may be omitted according to the value of the shown Use column or a plurality of fields may be present.

The @globalServiceID attribute, the @serviceId attribute, the Name element and/or the serviceLanguage element may be equal to the fields of the USBD delivered through ROUTE. The contentAdvisoryRating element may indicate the content advisory rating of the service. This information is compatible with content advisory rating information format provided in service announcement. The Channel element may include information associated with the service. A detailed description of this element will be given below.

The mpuComponent element may provide a description of service components delivered as the MPU of the service. This element may further include an @mmtPackageId attribute and/or an @nextMmtPackageId attribute. The @mmtPackageId attribute may reference the MMT package of the service components delivered as the MPU of the service. The @nextMmtPackageId attribute may reference an MMT package to be used after the MMT package referenced by the @mmtPackageId attribute in terms of time. Through the information of this element, the MP table may be referenced.

The routeComponent element may include a description of the service components of the service. Even when linear service components are delivered through the MMT protocol, NRT data may be delivered according to the ROUTE protocol as described above. This element may describe information on such NRT data. A detailed description of this element will be given below.

The broadbandComponent element may include the description of the service components of the service delivered over broadband. In hybrid service delivery, some service components of one service or other files may be delivered over broadband. This element may describe information on such data. This element may further an @fullMPDUri attribute. This attribute may reference the MPD describing the service component delivered over broadband. In addition to hybrid service delivery, the broadcast signal may be weakened due to traveling in a tunnel and thus this element may be necessary to support handoff between broadband and broadband. When the broadcast signal is weak, the service component is acquired over broadband and, when the broadcast signal becomes strong, the service component is acquired over the broadcast network to secure service continuity.

The ComponentInfo element may include information on the service components of the service. According to the number of service components of the service, a plurality of elements may be present. This element may describe the type, role, name, identifier or protection of each service component. Detailed information of this element will be described below.

The above-described Channel element may further include an @serviceGenre attribute, an @serviceIcon attribute and/or a ServiceDescription element. The @serviceGenre attribute may indicate the genre of the service and the @serviceIcon attribute may include the URL information of the representative icon of the service. The ServiceDescription element may provide the service description of the service and this element may further include an @serviceDescrText attribute and/or an @serviceDescrLang attribute. These attributes may indicate the text of the service description and the language used in the text.

The above-described routeComponent element may further include an @sTSIDUri attribute, an @sTSIDDestinationIpAddress attribute, an @sTSIDDestinationUdpPort attribute, an @sTSIDSourceIpAddress attribute, an @sTSIDMajorProtocolVersion attribute and/or an @sTSIDMinorProtocolVersion attribute.

The @sTSIDUri attribute may reference an S-TSID fragment. This field may be equal to the field of the USBD delivered through ROUTE. This S-TSID may provide access related information of the service components delivered through ROUTE. This S-TSID may be present for NRT data delivered according to the ROUTE protocol in a state of delivering linear service component according to the MMT protocol.

The @sTSIDDestinationIpAddress attribute, the @sTSIDDestinationUdpPort attribute and the @sTSIDSourceIpAddress attribute may indicate the destination IP address, destination UDP port and source IP address of the transport packets carrying the above-described S-TSID. That is, these fields may identify the transport session (MMTP session or the ROUTE session) carrying the above-described S-TSID.

The @sTSIDMajorProtocolVersion attribute and the @sTSIDMinorProtocolVersion attribute may indicate the major version number and minor version number of the transport protocol used to deliver the above-described S-TSID, respectively.

The above-described ComponentInfo element may further include an @componentType attribute, an @componentRole attribute, an @componentProtectedFlag attribute, an @componentId attribute and/or an @componentName attribute.

The @componentType attribute may indicate the type of the component. For example, this attribute may indicate whether the component is an audio, video or closed caption component. The @componentRole attribute may indicate the role of the component. For example, this attribute may indicate main audio, music, commentary, etc. if the component is an audio component. This attribute may indicate primary video if the component is a video component. This attribute may indicate a normal caption or an easy reader type if the component is a closed caption component.

The @componentProtectedFlag attribute may indicate whether the service component is protected, for example, encrypted. The @componentId attribute may indicate the identifier of the service component. The value of this attribute may be the asset id (asset ID) of the MP table corresponding to this service component. The @componentName attribute may indicate the name of the service component.

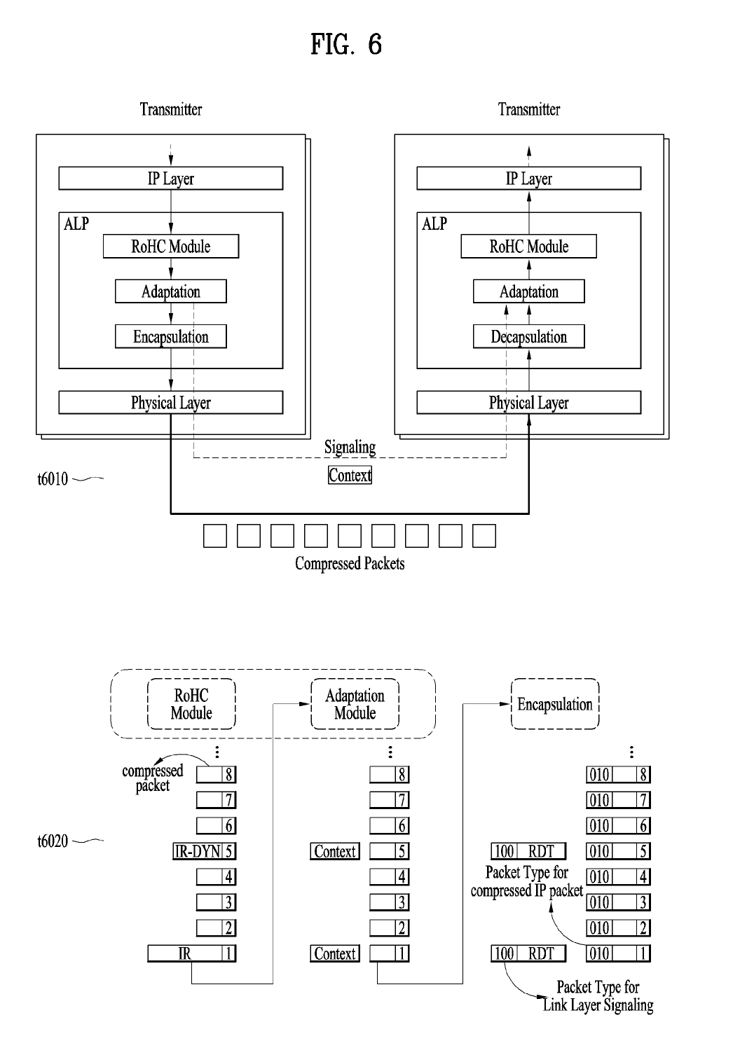

FIG. 6 is a diagram showing link layer operation according to one embodiment of the present invention.

The link layer may be a layer between a physical layer and a network layer. A transmission side may transmit data from the network layer to the physical layer and a reception side may transmit data from the physical layer to the network layer (t6010). The purpose of the link layer is to compress (abstract) all input packet types into one format for processing by the physical layer and to secure flexibility and expandability of an input packet type which is not defined yet. In addition, the link layer may provide option for compressing (abstracting) unnecessary information of the header of input packets to efficiently transmit input data. Operation such as overhead reduction, encapsulation, etc. of the link layer is referred to as a link layer protocol and packets generated using this protocol may be referred to as link layer packets. The link layer may perform functions such as packet encapsulation, overhead reduction and/or signaling transmission.

At the transmission side, the link layer (ALP) may perform an overhead reduction procedure with respect to input packets and then encapsulate the input packets into link layer packets. In addition, in some embodiments, the link layer may perform encapsulation into the link layer packets without performing the overhead reduction procedure. Due to use of the link layer protocol, data transmission overhead on the physical layer may be significantly reduced and the link layer protocol according to the present invention may provide IP overhead reduction and/or MPEG-2 TS overhead reduction.

When the shown IP packets are input as input packets (t6010), the link layer may sequentially perform IP header compression, adaptation and/or encapsulation. In some embodiments, some processes may be omitted. For example, the RoHC module may perform IP packet header compression to reduce unnecessary overhead. Context information may be extracted through the adaptation procedure and transmitted out of band. The IP header compression and adaption procedure may be collectively referred to as IP header compression. Thereafter, the IP packets may be encapsulated into link layer packets through the encapsulation procedure.

When MPEG 2 TS packets are input as input packets, the link layer may sequentially perform overhead reduction and/or an encapsulation procedure with respect to the TS packets. In some embodiments, some procedures may be omitted. In overhead reduction, the link layer may provide sync byte removal, null packet deletion and/or common header removal (compression). Through sync byte removal, overhead reduction of 1 byte may be provided per TS packet. Null packet deletion may be performed in a manner in which reinsertion is possible at the reception side. In addition, deletion (compression) may be performed in a manner in which common information between consecutive headers may be restored at the reception side. Some of the overhead reduction procedures may be omitted. Thereafter, through the encapsulation procedure, the TS packets may be encapsulated into link layer packets. The link layer packet structure for encapsulation of the TS packets may be different from that of the other types of packets.

First, IP header compression will be described.

The IP packets may have a fixed header format but some information necessary for a communication environment may be unnecessary for a broadcast environment. The link layer protocol may compress the header of the IP packet to provide a mechanism for reducing broadcast overhead.

IP header compression may include a header compressor/decompressor and/or an adaptation module. The IP header compressor (RoHC compressor) may reduce the size of each IP packet based on a RoHC method. Then, adaptation module may extract context information and generate signaling information from each packet stream. A receiver may parse signaling information related to a corresponding packet stream and attach the context information to the packet stream. The RoHC decompressor may recover a packet header to reconfigure an original IP packet. Hereinafter, IP header compression may refer to only IP header compressor via header compressor and may be a concept that combines IP header compression and the adaptation procedure by the adaptation module. This may be the same as in decompressing.

Hereinafter, adaptation will be described.

In transmission of a single-direction link, when the receiver does not have context information, the decompressor cannot restore the received packet header until complete context is received. This may lead to channel change delay and turn-on delay. Accordingly, through the adaptation function, configuration parameters and context information between the compressor and the decompressor may be transmitted out of band. The adaptation function may construct link layer signaling using context information and/or configuration parameters. The adaptation function may periodically transmit link layer signaling through each physical frame using a previous configuration parameter and/or context information.

Context information is extracted from the compressed IP packets and various methods may be used according to adaptation mode.

Mode #1 refers to a mode in which no operation is performed with respect to the compressed packet stream and an adaptation module operates as a buffer.

Mode #2 refers to a mode in which an IR packet is detected from a compressed packet stream to extract context information (static chain). After extraction, the IR packet is converted into an IR-DYN packet and the IR-DYN packet may be transmitted in the same order within the packet stream in place of an original IR packet.

Mode #3 (t6020) refers to a mode in which IR and IR-DYN packets are detected from a compressed packet stream to extract context information. A static chain and a dynamic chain may be extracted from the IR packet and a dynamic chain may be extracted from the IR-DYN packet. After extraction, the IR and IR-DYN packets are converted into normal compression packets. The converted packets may be transmitted in the same order within the packet stream in place of original IR and IR-DYN packets.

In each mode, the context information is extracted and the remaining packets may be encapsulated and transmitted according to the link layer packet structure for the compressed IP packets. The context information may be encapsulated and transmitted according to the link layer packet structure for signaling information, as link layer signaling.

The extracted context information may be included in a RoHC-U description table (RDT) and may be transmitted separately from the RoHC packet flow. Context information may be transmitted through a specific physical data path along with other signaling information. The specific physical data path may mean one of normal PLPs, a PLP in which low level signaling (LLS) is delivered, a dedicated PLP or an L1 signaling path. Here, the RDT may be context information (static chain and/or dynamic chain) and/or signaling information including information associated with header compression. In some embodiments, the RDT may be transmitted whenever context information is changed. In some embodiments, the RDT may be transmitted in every physical frame. To transmit the RDT in every physical frame, a previous RDT may be re-used.

The receiver may select a first PLP and first acquire signaling information of the SLT, the RDT, etc., prior to acquisition of a packet stream. Upon acquiring the signaling information, the receiver may combine the information to acquire mapping of service-IP information-context information-PLP. That is, the receiver may recognize IP streams through which a service is transmitted, IP streams transmitted through a PLP, and so on and acquire corresponding context information of the PLPs. The receiver may select a PLP for delivery of a specific packet stream and decode the PLP. The adaptation module may parse the context information and combine the context information with the compressed packets. Thereby, the packet stream may be recovered and transmitted to the RoHC de compressor. Then, decompression may be started. In this case, the receiver may detect an IR packet and start decompression from a first received IR packet according to an adaptation mode (mode 1), may detect an IR-DYN packet and start decompression from a first received IR-DYN packet (mode 2), or may start decompression from any general compressed packet (mode 3).

Hereinafter, packet encapsulation will be described.

The link layer protocol may encapsulate all types of input packets such as IP packets, TS packets, etc. into link layer packets. To this end, the physical layer processes only one packet format independently of the protocol type of the network layer (here, an MPEG-2 TS packet is considered as a network layer packet). Each network layer packet or input packet is modified into the payload of a generic link layer packet.

In the packet encapsulation procedure, segmentation may be used. If the network layer packet is too large to be processed in the physical layer, the network layer packet may be segmented into two or more segments. The link layer packet header may include fields for segmentation of the transmission side and recombination of the reception side. Each segment may be encapsulated into the link layer packet in the same order as the original location.

In the packet encapsulation procedure, concatenation may also be used. If the network layer packet is sufficiently small such that the payload of the link layer packet includes several network layer packets, concatenation may be performed. The link layer packet header may include fields for performing concatenation. In concatenation, the input packets may be encapsulated into the payload of the link layer packet in the same order as the original input order.

The link layer packet may include a header and a payload. The header may include a base header, an additional header and/or an optional header. The additional header may be further added according to situation such as concatenation or segmentation and the additional header may include fields suitable for situations. In addition, for delivery of the additional information, the optional header may be further included. Each header structure may be pre-defined. As described above, if the input packets are TS packets, a link layer header having packets different from the other packets may be used.

Hereinafter, link layer signaling will be described.

Link layer signaling may operate at a level lower than that of the IP layer. The reception side may acquire link layer signaling faster than IP level signaling of the LLS, the SLT, the SLS, etc. Accordingly, link layer signaling may be acquired before session establishment.

Link layer signaling may include internal link layer signaling and external link layer signaling. Internal link layer signaling may be signaling information generated at the link layer. This includes the above-described RDT or the below-described LMT. External link layer signaling may be signaling information received from an external module, an external protocol or a higher layer. The link layer may encapsulate link layer signaling into a link layer packet and deliver the link layer packet. A link layer packet structure (header structure) for link layer signaling may be defined and link layer signaling information may be encapsulated according to this structure.

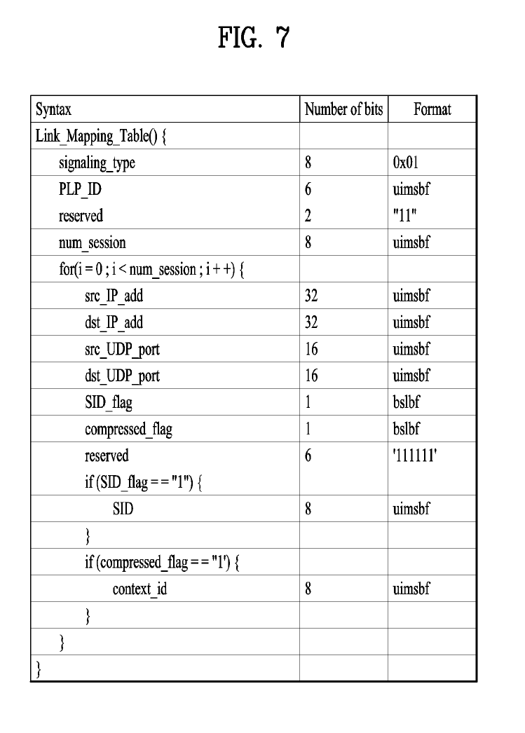

FIG. 7 is a diagram showing a link mapping table (LMT) according to one embodiment of the present invention.

The LMT may provide a list of higher layer sessions carried through the PLP. In addition, the LMT may provide additional information for processing link layer packets carrying the higher layer sessions. Here, the higher layer session may be referred to as multicast. Information on IP streams or transport sessions transmitted through one PLP may be acquired through the LMT. In contrast, information on through which PLP a specific transport session is delivered may be acquired.

The LMT may be transmitted through any PLP identified to deliver the LLS. Here, the PLP for delivering the LLS may be identified by an LLS flag of L1 detail signaling information of a physical layer. The LLS flag may be a flag field indicating whether the LLS is transmitted through a corresponding PLP with respect to each PLP. Here, the L1 detail signaling information may be correspond to PLS2 data which will be described later.

That is, the LMT may also be transmitted through the same PLP along with the LLS. Each LMT may describe mapping between PLPs and IP address/port as described above. As described above, the LLS may include an SLT and, in this regard, the IP address/ports described by the LMT may be any IP address/ports related to any service, described by the SLT transmitted through the PLP such as a corresponding LMT.

In some embodiments, the PLP identifier information in the above-described SLT, SLS, etc. may be used to confirm information indicating through which PLP a specific transport session indicated by the SLT or SLS is transmitted may be confirmed.

In another embodiment, the PLP identifier information in the above-described SLT, SLS, etc. will be omitted and PLP information of the specific transport session indicated by the SLT or SLS may be confirmed by referring to the information in the LMT. In this case, the receiver may combine the LMT and other IP level signaling information to identify the PLP. Even in this embodiment, the PLP information in the SLT, SLS, etc. is not omitted and may remain in the SLT, SLS, etc.

The LMT according to the shown embodiment may include a signaling_type field, a PLP_ID field, a num_session field and/or information on each session. Although the LMT of the shown embodiment describes IP streams transmitted through one PLP, a PLP loop may be added to the LMT to describe information on a plurality of PLPs in some embodiments. In this case, as described above, the LMT may describe PLPs of all IP addresses/ports related to all service described by the SLT transmitted together using a PLP loop.

The signaling_type field may indicate the type of signaling information delivered by the table. The value of signaling_type field for the LMT may be set to 0x01. The signaling_type field may signaling_type field may be omitted. The PLP_ID field may identify a target PLP to be described. When the PLP loop is used, each PLP_ID field may identify each target PLP. Fields from the PLP_ID field may be included in the PLP loop. Here, the below-described PLP_ID field may be an identifier of one PLP of the PLP loop and the following fields may be fields corresponding to the corresponding PLP.

The num_session field may indicate the number of higher layer sessions delivered through the PLP identified by the PLP_ID field. According to the number indicated by the num_session field, information on each session may be included. This information may include a src_IP_add field, a dst_IP_add field, a src_UDP_port field, a dst_UDP_port field, an SID_flag field, a compressed_flag field, an SID field, and/or a context_id field.

The src_IP_add field, the dst_IP_add field, the src_UDP_port field, and the dst_UDP_port field may indicate the source IP address, the destination IP address, the source UDP port and the destination UDP port of the transport session among the higher layer sessions delivered through the PLP identified by the PLP_ID field.

The SID_flag field may indicate whether the link layer packet delivering the transport session has an SID field in the optional header. The link layer packet delivering the higher layer session may have an SID field in the optional header and the SID field value may be equal to that of the SID field in the LMT.

The compressed_flag field may indicate whether header compression is applied to the data of the link layer packet delivering the transport session. In addition, presence/absence of the below-described context_id field may be determined according to the value of this field. When header compression is applied (compressed_flag=1), the RDT may be present and the PLP_ID field of the RDT may have the same value as the corresponding PLP_ID field related to the present compressed_flag field.

The SID field may indicate a sub stream ID (SID) of link layer packets for delivering a corresponding transfer session. The link layer packets may include the SID having the same value as the present SID field in the optional header. Thereby, the receiver may filter link layer packets using information of the LMT and SID information of a link layer packet header without parsing of all link layer packets.

The context_id field may provide a reference for a context_id (CID) in the RDT. The CID information of the RDT may indicate the context ID of the compression IP packet stream. The RDT may provide context information of the compression IP packet stream. Through this field, the RDT and the LMT may be associated.

In the above-described embodiments of the signaling information/table of the present invention, the fields, elements or attributes may be omitted or may be replaced with other fields. In some embodiments, additional fields, elements or attributes may be added.

In one embodiment of the present invention, service components of one service may be delivered through a plurality of ROUTE sessions. In this case, an SLS may be acquired through bootstrap information of an SLT. An S-TSID and an MPD may be referenced through the USBD of the SLS. The S-TSID may describe not only the ROUTE session delivered by the SLS but also transport session description information of another ROUTE session carried by the service components. To this end, the service components delivered through the plurality of ROUTE sessions may all be collected. This is similarly applicable to the case in which the service components of one service are delivered through a plurality of MMTP sessions. For reference, one service component may be simultaneously used by the plurality of services.

In another embodiment of the present invention, bootstrapping of an ESG service may be performed by a broadcast or broadband network. By acquiring the ESG over broadband, URL information of the SLT may be used. ESG information may be requested using this URL.

In another embodiment of the present invention, one service component of one service may be delivered over the broadcast network and the other service component may be delivered over broadband (hybrid). The S-TSID may describe components delivered over the broadcast network such that the ROUTE client acquires desired service components. In addition, the USBD may have base pattern information to describe which segments (which components) are delivered through which path. Accordingly, the receiver can confirm a segment to be requested from the broadband service and a segment to be detected in a broadcast stream.

In another embodiment of the present invention, scalable coding of a service may be performed. The USBD may have all capability information necessary to render the service. For example, when one service is provided in HD or UHD, the capability information of the USBD may have a value of “HD or UHD”. The receiver may check which component is reproduced in order to render the UHD or HD service using the MPD.

In another embodiment of the present invention, through a TOI field of the LCT packets delivered through the LCT channel delivering the SLS, which SLS fragment is delivered using the LCT packets (USBD, S-TSID, MPD, etc.) may be identified.

In another embodiment of the present invention, app components to be used for app based enhancement/an app based service may be delivered over the broadcast network as NRT components or may be delivered over broadband. In addition, app signaling for app based enhancement may be performed by an application signaling table (AST) delivered along with the SLS. In addition, an event which is signaling for operation to be performed by the app may be delivered in the form of an event message table (EMT) along with the SLS, may be signaled in the MPD or may be in-band signaled in the form of a box within DASH representation. The AST, the EMT, etc. may be delivered over broadband. App based enhancement, etc. may be provided using the collected app components and such signaling information.

In another embodiment of the present invention, a CAP message may be included and provided in the above-described LLS table for emergency alert. Rich media content for emergency alert may also be provided. Rich media may be signaled by a CAP message and, if rich media is present, the rich media may be provided as an EAS service signaled by the SLT.

In another embodiment of the present invention, linear service components may be delivered over the broadcast network according to the MMT protocol. In this case, NRT data (e.g., app components) of the service may be delivered over the broadcast network according to the ROUTE protocol. In addition, the data of the service may be delivered over broadband. The receiver may access the MMTP session delivering the SLS using the bootstrap information of the SLT. The USBD of the SLS according to the MMT may reference the MP table such that the receiver acquires linear service components formatted into the MPU delivered according to the MMT protocol. In addition, the USBD may further reference the S-TSID such that the receiver acquires NRT data delivered according to the ROUTE protocol. In addition, the USBD may further reference the MPD to provide a reproduction description of data delivered over broadband.

In another embodiment of the present invention, the receiver may deliver location URL information capable of acquiring a file content item (file, etc.) and/or a streaming component to a companion device through a web socket method. The application of the companion device may acquire components, data, etc. through a request through HTTP GET using this URL. In addition, the receiver may deliver information such as system time information, emergency alert information, etc. to the companion device.

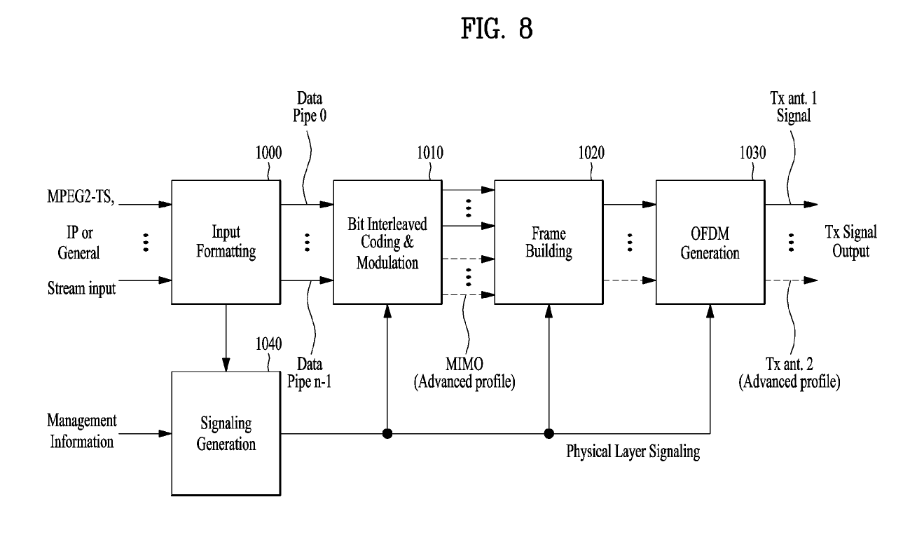

FIG. 8 is a diagram showing a structure of a broadcast signal transmission device of a next-generation broadcast service according to an embodiment of the present invention.

The broadcast signal transmission device of the next-generation broadcast service according to an embodiment of the present invention may include an input format block 1000, a bit interleaved coding & modulation (BICM) block 1010, a frame building block 1020, an orthogonal frequency division multiplexing (OFDM) generation block 1030, and a signaling generation block 1040. An operation of each block of the broadcast signal transmission device will be described.

According to an embodiment of the present invention, input data may use IP stream/packet and MPEG2-TS as main input format and other stream types may be handled as a general stream.

The input format block 1000 may demultiplex each input stream using one or more data pipes to which independent coding and modulation are applied. The data pipe may be a basic unit for robustness control and may affect quality of service (QoS). One or more services or service components may affect one data pipe. The data pipe may be a logical channel in a physical layer for delivering service data or metadata for delivering one or more services or service components.

Since QoS is dependent upon the characteristics of a service provided by the broadcast signal transmission device of the next-generation broadcast service according to an embodiment of the present invention, data corresponding to each service needs to be processed via different methods.

The BICM block 1010 may include a processing block applied to a profile (or system) to which MIMO is not applied and/or a processing block of a profile (or system) to which MIMO is applied and may include a plurality of processing blocks for processing each data pipe.

The processing block of the BICM block to which MIMO is not applied may include a data FEC encoder, a bit interleaver, a constellation mapper, a signal space diversity (SSD) encoding block, and a time interleaver. The processing block of the BICM block to which MIMO is applied is different from the processing block of the BICM to which MIMO is not applied in that a cell word demultiplexer and an MIMO encoding block are further included.

The data FEC encoder may perform FEC encoding on an input BBF to generate a FECBLOCK procedure using external coding (BCH) and internal coding (LDPC). The external coding (BCH) may be a selective coding method. The bit interleaver may interleave output of the data FEC encoder to achieve optimized performance using a combination of the LDPC code and a modulation method. The constellation mapper may modulate cell word from a bit interleaver or a cell word demultiplexer using QPSK, QAM-16, irregular QAM (NUQ-64, NUQ-256, NUQ-1024), or irregular constellation (NUC-16. NUC-64, NUC-256. NUC-1024) and provide a power-normalized constellation point. NUQ has an arbitrary type but QAM-16 and NUQ have a square shape. All of the NUQ and the NUC may be particularly defined with respect to each code rate and signaled by parameter DP_MOD of PLS2 data. The time interleaver may be operated at a data pipe level. A parameter of the time interleaving may be differently set with respect to each data pipe.

The time interleaver according to the present invention may be positioned between the BICM chain and the frame builder. In this case, the time interlever according to the present invention may selectively use a convolution interleaver (CI) and a block interleaver (BI) according to a physical layer pipe (PLP) mode or may use all. The PLP according to an embodiment of the present invention may be a physical path used using the same concept as the aforementioned DP and its term may be changed according to designer intention. The PLP mode according to an embodiment of the present invention may include a single PLP mode or a multiple PLP mode according to the number of PLPs processed by the broadcast signal transmitter or the broadcast signal transmission device. Time interleaving using different time interleaving methods according to a PLP mode may be referred to as hybrid time interleaving.

A hybrid time interleaver may include a block interleaver (BI) and a convolution interleaver (CI). In the case of PLP_NUM=1, the BI may not be applied (BI off) and only the CI may be applied. In the case of PLP_NUM>1, both the BI and the CI may be applied (BI on). The structure and operation of the CI applied in the case of PLP_NUM>1 may be different from those of the CI applied in the case of PLP_NUM=1. The hybrid time interleaver may perform an operation corresponding to a reverse operation of the aforementioned hybrid time interleaver.

The cell word demultiplexer may be used to divide a single cell word stream into a dual cell word stream for MIMO processing. The MIMO encoding block may process output of the cell word demultiplexer using a MIMO encoding method. The MIMO encoding method according to the present invention may be defined as full-rate spatial multiplexing (FR-SM) for providing increase in capacity via relatively low increase in complexity at a receiver side. MIMO processing may be applied at a data pipe level. When a pair of constellation mapper outputs, NUQ e_{1,1} and e_{2,1} is input to a MIMO encoder, a pair of MIMO encoder outputs, g1,1 and g2,1 may be transmitted by the same carrier k and OFDM symbol 1 of each transmission antenna.

The frame building block 1020 may map a data cell of an input data pipe in one frame to an OFDM symbol and perform frequency interleaving for frequency domain diversity.

According to an embodiment of the present invention, a frame may be divided into a preamble, one or more frame signaling symbols (FSS), and a normal data symbol. The preamble may be a special symbol for providing a combination of basic transmission parameters for effective transmission and reception of a signal. The preamble may signal a basic transmission parameter and a transmission type of a frame. In particular, the preamble may indicate whether an emergency alert service (EAS) is currently provided in a current frame. The objective of the FSS may be to transmit PLS data. For rapid synchronization and channel estimation and rapid decoding of PLS data, the FSS may have a pipe pattern with higher density than a normal data symbol.

The frame building block may include a delay compensation block for adjusting timing between a data pipe and corresponding PLS data to ensure co-time between a data pipe and corresponding PLS data at a transmitting side, a cell mapper for mapping a PLS, a data pipe, an auxiliary stream, a dummy stream, and so on to an active carrier of an OFDM symbol in a frame, and a frequency interleaver.

The frequency interleaver may randomly interleave a data cell received from the cell mapper to provide frequency diversity. The frequency interleaver may operate with respect to data corresponding to an OFDM symbol pair including two sequential OFDM symbols or data corresponding to one OFDM symbol using different interleaving seed orders in order to acquire maximum interleaving gain in a single frame.

The OFDM generation block 1030 may modulate an OFDM carrier by the cell generated by the frame building block, insert a pilot, and generate a time domain signal for transmission. The corresponding block may sequentially insert guard intervals and may apply PAPR reduction processing to generate a last RF signal.

The signaling generation block 1040 may generate physical layer signaling information used in an operation of each functional block. The signaling information according to an embodiment of the present invention may include PLS data. The PLS may provide an element for connecting a receiver to a physical layer data pipe. The PLS data may include PLS1 data and PLS2 data.

The PLS1 data may be a first combination of PLS data transmitted to FSS in a frame with fixed size, coding, and modulation for transmitting basic information on a system as well as a parameter required to data PLS2 data. The PLS1 data may provide a basic transmission parameter including a parameter required to receive and decode PLS2 data. The PLS2 data may be a second combination of PLP data transmitted to FSS for transmitting more detailed PLS data of a data pipe and a system. PLS2 signaling may further include two types of parameters of PLS2 static data (PLS2-STAT data) and PLS2 dynamic data (PLS2-DYN data). The PLS2 static data may be PLS2 data that is static during duration of a frame group and the PLS2 dynamic data may be PLS2 data that is dynamically changed every frame.

The PLS2 data may include FIC_FLAG information. A fast information channel (FIC) may be a dedicated channel for transmitting cross-layer information for enabling fast service acquisition and channel scanning. The FIC_FLAG information may indicate whether a fast information channel (FIC) is used in a current frame group via a 1-bit field. When a value of the corresponding field is set to 1, the FIC may be provided in the current frame. When a value of the corresponding field is set to 0, the FIC may not be transmitted in the current frame. The BICM block 1010 may include a BICM block for protecting PLS data. The BICM block for protecting the PLS data may include a PLS FEC encoder, a bit interleaver, and a constellation mapper.

The PLS FEC encoder may include a scrambler for scrambling PLS1 data and PLS2 data, a BCH encoding/zero inserting block for performing external encoding on the scrambled PLS1 and 2 data using a BCH code shortened for PLS protection and inserting a zero bit after BCH encoding, a LDPC encoding block for performing encoding using an LDPC code, and an LDPC parity puncturing block. Only the PLS1 data may be permutated before an output bit of zero insertion is LDPC-encoded. The bit interleaver may interleave each of the shortened and punctured PLS1 data and PLS2 data, and the constellation mapper may map the bit-interleaved PLS1 data and PLS2 data to constellation.

A broadcast signal reception device of a next-generation broadcast service according to an embodiment of the present invention may perform a reverse operation of the broadcast signal transmission device of the next-generation broadcast service that has been described with reference to FIG. 8.

The broadcast signal reception device of a next-generation broadcast service according to an embodiment of the present invention may include a synchronization & demodulation module for performing demodulation corresponding to a reverse operation performed by the broadcast signal transmission device, a frame parsing module for parsing an input signal frame to extract data transmitted by a service selected by a user, a demapping & decoding module for converting an input signal into bit region data, deinterleaving bit region data as necessary, performing demapping on mapping applied for transmission efficiency, and correcting error that occurs in a transmission channel for decoding, an output processor for performing a reverse operation of various compression/signal processing procedures applied by the broadcast signal transmission device, and a signaling decoding module for acquiring and processing PLS information from the signal demodulated by the synchronization & demodulation module. The frame parsing module, the demapping & decoding module, and the output processor may perform the functions using the PLS data output from the signaling decoding module.

Hereinafter, the timer interleaver will be described. A time interleaving group according to an embodiment of the present invention may be directly mapped to one frame or may be spread over P_{I} frames. In addition, each time interleaving group may be divided into one or more (N_{TI}) time interleaving blocks. Here, each time interleaving block may correspond to one use of a time interleaver memory. A time interleaving block in the time interleaving group may include different numbers of XFECBLOCK. In general, the time interleaver may also function as a buffer with respect to data pipe data prior to a frame generation procedure.

The time interleaver according to an embodiment of the present invention may be a twisted row-column block interleaver. The twisted row-column block interleaver according to an embodiment of the present invention may write a first XFECBLOCK in a first column of the time interleaving memory, write a second XFECBLOCK in a next column, and write the remaining XFECBLOCKs in the time interleaving block in the same manner. In an interleaving array, a cell may be read in a diagonal direction to a last row from a first row (a leftmost column as a start column is read along a row in a right direction). In this case, to achieve single memory deinterleaving at a receiver side irrespective of the number of XFECBLOCK in the time interleaving block, the interleaving array for the twisted row-column block interleaver may insert a virtual XFECBLOCK into the time interleaving memory. In this case, to achieve single memory deinterleaving at a receiver side, the virtual XFECBLOCK needs to be inserted into another frontmost XFECBLOCK.

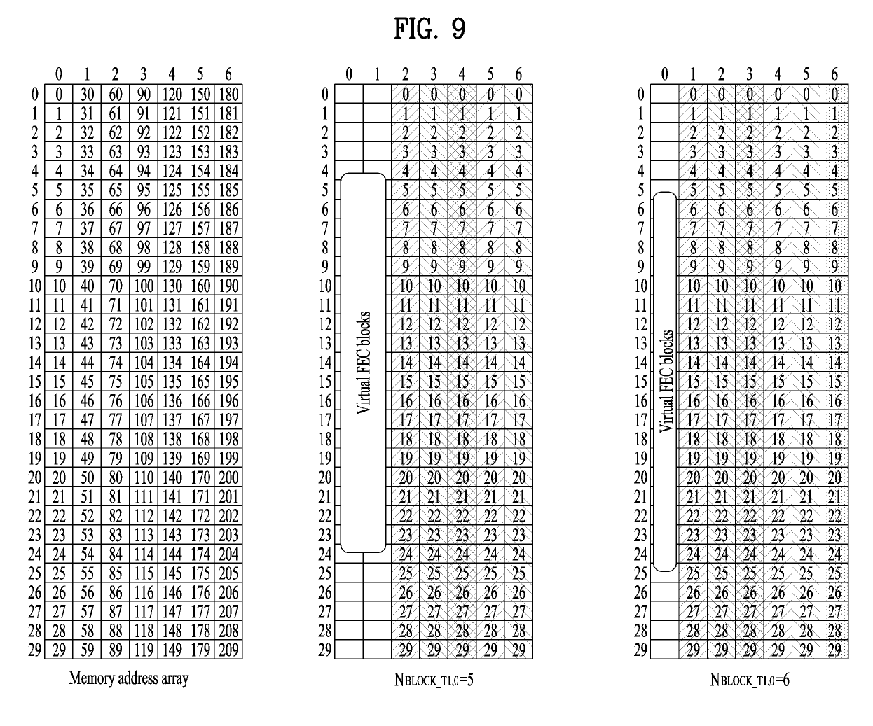

FIG. 9 is a writing operation of a time interleaver according to an embodiment of the present invention.

A block shown in a left portion of the drawing shows a TI memory address array and a block shown in a right portion of the drawing shows a writing operation when two or one virtual FEC blocks are inserted into a frontmost group of TI groups with respect to two consecutive TI groups.

The frequency interleaver according to an embodiment of the present invention may include an interleaving address generator for generating an interleaving address to be applied to data corresponding to a symbol pair.

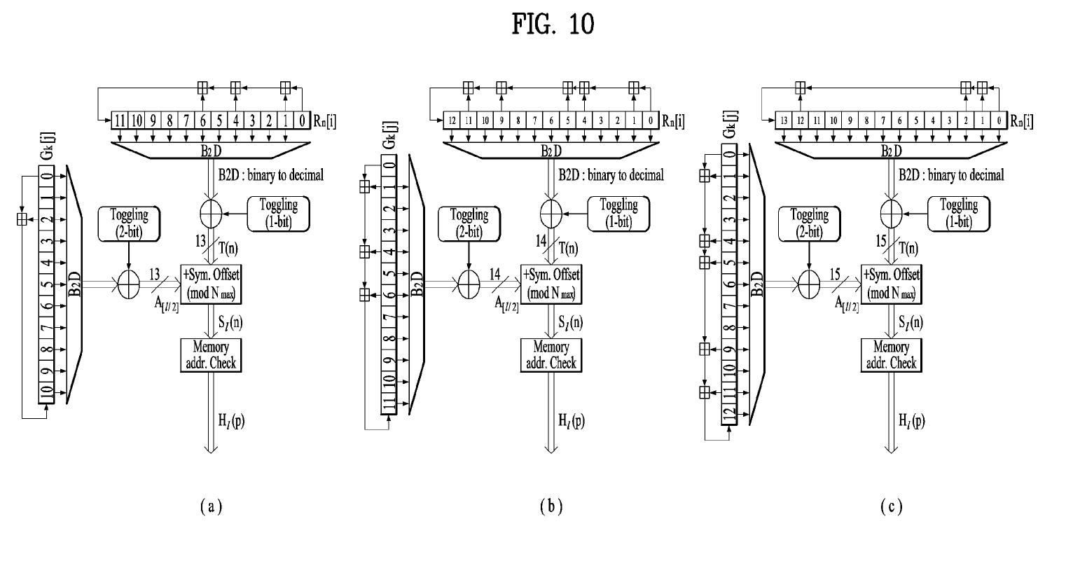

FIG. 10 is a block diagram of an interleaving address generator including a main-PRBS generator and a sub-PRBS generator according to each FFT mode, included in the frequency interleaver, according to an embodiment of the present invention.

(a) is a block diagram of an interleaving address generator with respect to a 8K FFT mode, (b) is a block diagram of an interleaving address generator with respect to a 16K FFT mode, and (c) is a block diagram of an interleaving address generator with respect to a 32K FFT mode.

An interleaving procedure with respect to an OFDM symbol pair may use one interleaving sequence and will be described below. First, an available data cell (output cell from a cell mapper) to be interleaved in one OFDM symbol O_{m,1} may be defined as O_{m,1}=[x_{m,1,0}, . . . , x_{m,1,p}, . . . , x_{m,1,Ndata-1}] with respect to l=0, . . . , N_{sym}−1. In this case, x_{m,1,p} may be a p^{th} cell of a l^{th} OFDM symbol in a m^{th} frame and N_{data} may be the number of data cells. In the case of a frame signaling symbol, N_{data}=C_{FSS}, in the case of normal data, N_{data}=C_{data}, and in the case of a frame edge symbol, N_{data}=C_{FES}. In addition, the interleaving data cell may be defined as P_{m,1} [v_{m,1,0}, . . . , v_{m,1,Ndata-1}] with respect to l=0, . . . , N_{sym}−1.

With respect to an OFDM symbol pair, an interleaved OFDM symbol pair may be given according to v_{m,1,Hi(p)}=x_{m,1,p}, p=0, . . . , N_{data}−1 for a first OFDM symbol of each pair and given according to v_{m,1,p}=x_{m,1,Hi(p)}, p=0, . . . , N_{data}−1 for a second OFDM symbol of each pair. In this case, Hi(p) may be an interleaving address generated based on a cyclic shift value (symbol offset) of a PRBS generator and a sub-PRBS generator.

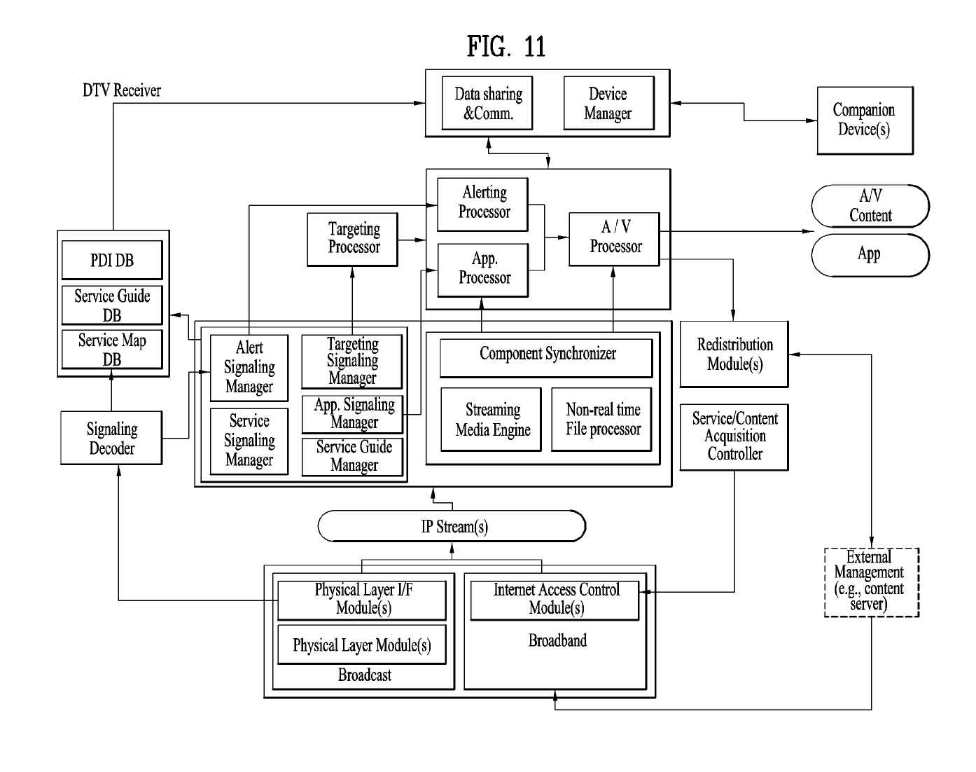

FIG. 11 illustrates a hybrid broadcast reception device according to an embodiment of the present invention. The hybrid broadcast system may transmit a broadcast signal in conjunction with a terrestrial broadcast network and an Internet network. The hybrid broadcast reception device may receive a broadcast signal through a terrestrial broadcast network (broadcast) and an Internet network (broadband). The hybrid broadcast reception device may include a physical layer module, a physical layer I/F module, a service/content acquisition controller, an Internet access control module, a signaling decoder, a service signaling manager, a service guide manager, an App signaling manager, an alert signal manager, an alert signal parser, a targeting signal parser, a streaming media engine, a non-real-time file processor, a component synchronizer, a targeting processor, an application processor, an A/V processor, a device manager, a data sharing and communication unit, a redistribution module, a companion device and/or an external module.

The physical layer module(s) may receive and process broadcast-related signals through a terrestrial broadcast channel, convert the same into appropriate forms, and transmit the converted signals to the physical layer I/F module.

The physical layer I/F module(s) may acquire IP datagrams from the information obtained from the physical layer module. In addition, the physical layer I/F module may convert the acquired IP datagram or the like into a specific frame (for example, RS frame, GSE).

The service/content acquisition controller may perform control operations for acquiring services, content and signaling data associated therewith over a broadcast and/or broadband channel.

The Internet access control module(s) may control receiver operations to acquire services, content, and the like over a broadband channel.

The signaling decoder may decode the signaling information acquired over a broadcast channel or the like.

The service signaling manager may extract, parse, and manage signaling information related to service scan and services/content from the IP datagram and the like.

The service guide manager may extract announcement information from IP datagrams, manage an SG (Service Guide) database, and provide a service guide.

The App signaling manager may extract, parse, and manage signaling information related to application acquisition and the like from IP datagrams and the like.

The alert signal parser may extract, parse, and manage alerting related signaling information from IP datagrams and the like.

The targeting signal parser may extract, parse, and manage signaling information related to service/content personalization or targeting from IP datagrams and the like. The targeting signal parser may also deliver the parsed signaling information to the targeting processor.

The streaming media engine may extract and decode audio/video data for A/V streaming from IP datagrams and the like.

The non-real time file processor may extract, decode, and manage NRT data and file type data such as applications from IP datagrams and the like.

The component synchronizer may synchronize services and content such as streaming audio/video data and NRT data.

The targeting processor may process operations related to personalization of the service/content based on the targeting signaling data received from the targeting signal parser.

The application processor (App processor) may process application-related information, the status of a downloaded application and display parameters.

The A/V processor may perform audio/video rendering related operations based on decoded audio and video data, application data, and the like.

The device manager may perform connection and data exchange with an external device. The device manager may also perform management of external devices such as addition/deletion/update of operatively connectable external devices.

The data sharing and communication unit (Data Sharing & Comm.) may process information related to data transmission and exchange between the hybrid broadcast receiver and an external device. Here, the data that may be transmitted and exchanged may be signaling, A/V data, and the like.

The redistribution module(s) may acquire related information about the next generation broadcast service and content when the broadcast receiver cannot directly receive the terrestrial broadcast signal. The redistribution module may also support acquisition of broadcast services and content by the next generation broadcast system when the broadcast receiver cannot directly receive the terrestrial broadcast signal.

The companion device(s) may be coupled to the broadcast receiver of the present invention to share audio, video, or signaling-containing data. The companion device may refer to an external device connected to the broadcast receiver.

An external management module (External Management) may refer to a module for providing broadcast service/content, for example, a next generation broadcast service/content server. The external module may refer to an external device connected to the broadcast receiver.

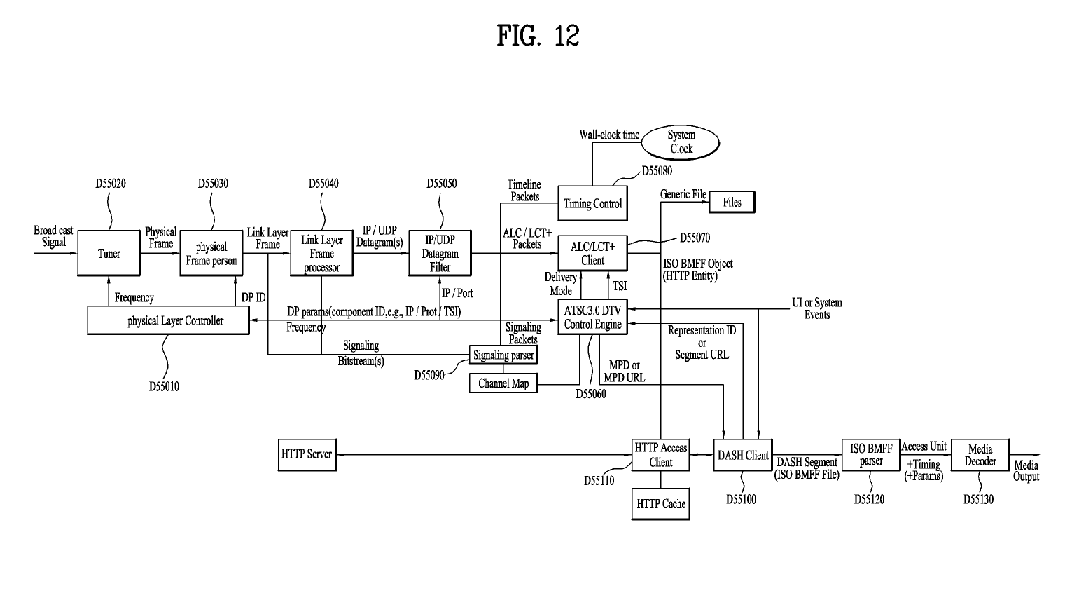

FIG. 12 is a block diagram illustrating a hybrid broadcast receiver according to an embodiment of the present invention.

The hybrid broadcast receiver may receive the hybrid broadcast service through operative connection of terrestrial broadcast and broadband in the DTV service of the next generation broadcast system. The hybrid broadcast receiver may receive broadcast audio/video (A/V) content transmitted through a terrestrial broadcast and receive part of enhancement data or broadcast A/V content associated therewith in real time through broadband. In this specification, the broadcast audio/video (A/V) content may be referred to as media content.

The hybrid broadcast receiver may include a physical layer controller D55010, a tuner D55020, a physical frame parser D55030, a link layer frame parser D55040, an IP/UDP datagram filter D55050, an ATSC 3.0 DTV (Digital Television) Control Engine D55060, an ALC/LCT+ Client D55070, a timing control D55080, a signaling parser D55090, a DASH (Dynamic Adaptive Streaming over HTTP) client D55100, an HTTP access client D55110, an ISO BMFF parser D55120, and/or a media decoder D55130.

The physical layer controller D55010 may control operations of the tuner D55020, the physical frame parser D55030, and the like using radio frequency (RF) information about a terrestrial broadcast channel to be received by the hybrid broadcast receiver.

The tuner D55020 may receive and process broadcast related signals through a terrestrial broadcast channel and convert the same into an appropriate form. For example, the tuner D55020 may convert a received terrestrial broadcast signal into a physical frame.

The physical frame parser D55030 may parse the received physical frame and acquire a link layer frame through related processing.

The link layer parser D55040 may acquire link layer signaling from the link layer frame or perform related operations to acquire an IP/UDP datagram or an MPEG-2 TS. The link layer parser D55040 may output at least one IP/UDP datagram or the like.

The IP/UDP datagram filter D55050 may filter a specific IP/UDP datagram from at least one received IP/UDP datagram or the like. That is, the IP/UDP datagram filter D55050 may selectively filter an IP/UDP datagram selected by the ATSC 3.0 DTV control engine D55060 among the at least one IP/UDP datagram output from the link layer parser D55040. The IP/UDP datagram filter D55050 may output an application layer transport protocol packet such as ALC/LCT+.

The ATSC 3.0 DTV control engine D55060 may serve as an interface between modules included in each hybrid broadcast receiver. The ATSC 3.0 DTV control engine D55060 may also provide necessary parameters for each module, thereby controlling the operation of each module. In the present invention, the ATSC 3.0 DTV control engine D55060 may deliver a media presentation description (MPD) and/or an MPD URL to the DASH client D55100. In the present invention, the ATSC 3.0 digital television control engine D55060 may also deliver a delivery mode and/or a transport session identifier (TSI) to the ALC/LCT+ client D55070. Here, TSI may represent the identifier of a session for transmitting a transport packet including a signaling message such as MPD or MPD URL related signaling, for example, the identifier of a FLUTE session or an ALC/LCT+ session, which is an application layer transmission protocol. The TSI may correspond to the Asset id of MMT.

The ALC/LCT+ client D55070 may process application layer transport protocol packets such as ALC/LCT+, and collect and process a plurality of packets to create one or more ISO Base Media File Format (ISOBMFF) objects. The application layer transport protocol packets may include ALC/LCT packets, ALC/LCT+ packets, ROUTE packets, and/or MMTP packets.

The timing control D55080 may process a packet including system time information to control the system clock.

The signaling parser D55090 may acquire and parse DTV broadcast service related signaling, and generate and manage a channel map and the like based on the parsed signaling. In the present invention, the signaling parser may parse the extended MPD or MPD related information from the signaling information.

The DASH client D55100 may perform operations related to real-time streaming or adaptive streaming. The DASH client D55100 may receive DASH content from the HTTP server through the HTTP access client D55110. The DASH client D55100 may process the received DASH segment and output an ISO Base Media File Format object. In the present invention, the DASH client D55100 may deliver a Fully Qualified Representation ID or a segment URL to the ATSC 3.0 DTV control engine D55060. Here, the Fully Qualified Representation ID may refer to an ID that combines, for example, the MPD URL, period@id, and representation@id. The DASH client D55100 may also receive the MPD or MPD URL from the ATSC 3.0 DTV control engine D55060. The DASH client D55100 may receive a desired media stream or DASH segment from the HTTP server using the received MPD or MPD URL. In this specification, the DASH client D55100 may be referred to as a processor.

The HTTP access client D55110 may make a request for specific information to the HTTP server, and may receive and process a response from the HTTP server. Here, the HTTP server may process the request received from the HTTP access client and provide a response thereto.

The ISO BMFF parser D55120 may extract audio/video data from the ISO Base Media File Format object.

The media decoder D55130 may decode the received audio and/or video data and perform processing to present the decoded audio/video data.

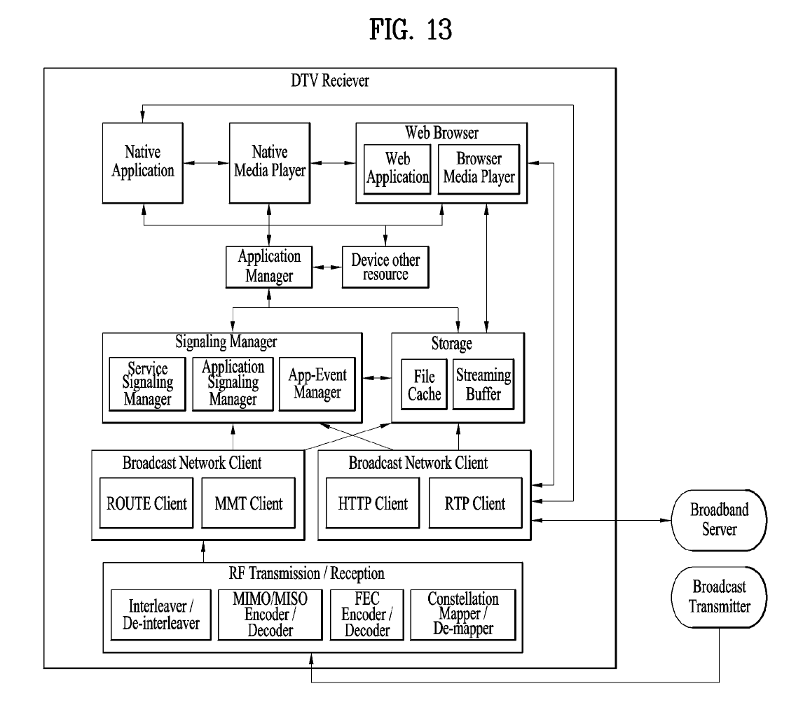

FIG. 13 illustrates a hybrid broadcast reception device according to a different embodiment of the present invention.

The hybrid broadcast reception device according to a different embodiment of the present invention can include an RF transmission/reception unit, a broadcast network client, a broadband network client, a signaling manager, a storage, a web browser, an application manager, a native application, and a native media player.

The RF transmission/reception unit can include an interleaver/de-interleaver, a mimo/miso encoder/decoder, a FEC encoder/decoder, and a constellation mapper/de-mapper. The RF transmission/reception unit receives a broadcast signal transmitted from a broadcast transmission device and can perform physical processing on the broadcast signal.

The broadcast network client can process the physically processed broadcast signal. The broadcast network client can include a ROUTE client and an MMT client. The ROUTE client can process data delivered through a ROUTE protocol. The MMT client can process data delivered through an MMT protocol.

The broadband network client can process data transmitted from a broadband server.

The signaling manager can process signaling information included in a broadcast signal or a broadband data transmitted via a broadcast network or a broadband network. The signaling manager can include a service signaling manage processing service signaling information, an application signaling manager processing application signaling information, and an application event manager processing application signaling information.

The storage can store data included in a broadcast signal, a broadband data, and/or signaling data. The storage can include a file cache and a streaming buffer.

The web browser can execute a web-based application transmitted through a broadband network. The web browser can include a web application processing a web-based application and a browser media player executing a file-based media data.

In case of a browser cache scheme provided within browser environment, an application can store and access a resource in a state of offline.

In case of using the browser cache scheme, it may have demerits in that a browser cache is unable to guarantee persistency, it is unable to access a resource except an application corresponding to an owner due to a sandbox policy, and it is unable to store a file in a browser cache except the application.

For example, when an EMP (embedded media player) of a receiver intends to play an MPEG DASH media file, the receiver can access a segment file related to the MPEG DASH media file via an address (e.g., URL) of the segment file provided by an MPD (Media Presentation Descriptor). However, since the EMP is unable to access a browser cache, if the segment file indicated by the MPD is stored in the browser cache, the EMP is unable to play the MPEG DASH media file. As a different example, when a segment file is stored in a ROUTE cache, since the MPD does not know an internal path of the receiver, the EMP is unable to access the ROUTE cache due to the same reason of the aforementioned example.

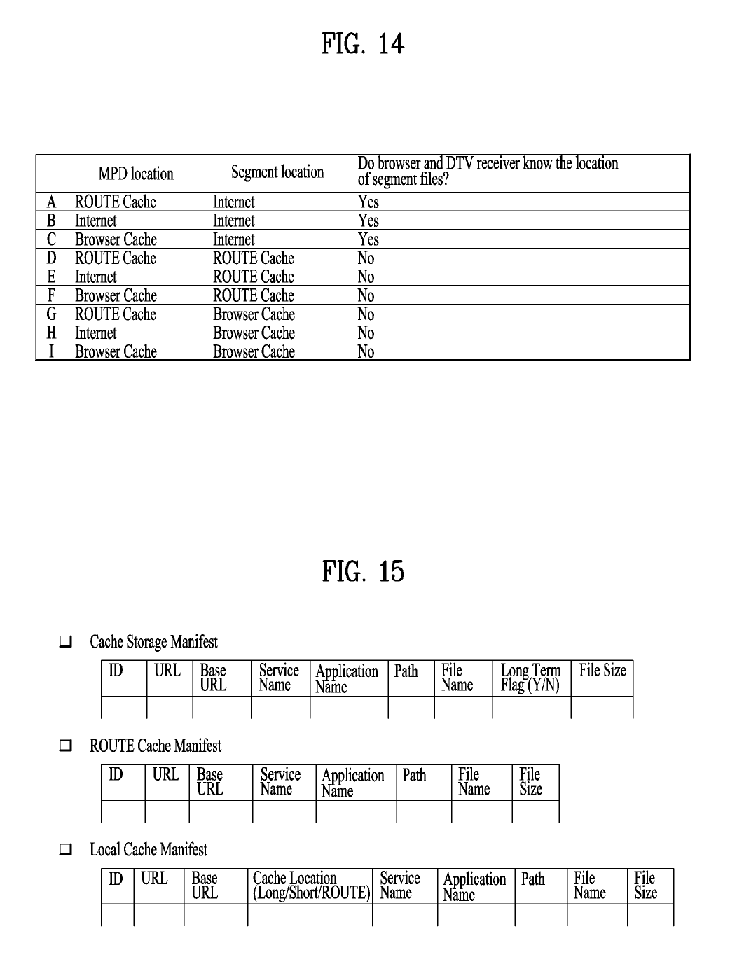

FIG. 14 is a table illustrating whether or not it is able to access a segment file using a combination of an MPD location and a segment file location indicated by MPD and an MPD location of each combination.

Referring to FIG. 14, an application (or a media player of the application) or an EMP of a receiver may or may not access a segment file depending on a location of the MPD or a location of the segment file.

First of all, when a segment file exists on the Internet (A, B, and C cases in FIG. 14), an application and/or an EMP can access the segment file using such a segment location as internet URL.

However, when a segment file exists in a cache rather than the Internet (D, E, F, G, H and I cases in FIG. 14), location information indicated by the MPD may fail to indicate an accurate location of the segment file. For example, when a segment file is stored in a browser cache, the EMP is unable to access the browser cache through information provided by the MPD. Similarly, when a segment file is stored in a ROUTE cache, an application is unable to access the ROUTE cache through information provided by the MPD.

The present specification proposes cache storage capable of being accessed by an application and the EMP, a method of using the cache storage, and a system. More specifically, the present specification proposes a method and a system that enable an application to access a broadcast network resource and enable EMP of a receiver to access a broadband resource.

Definition and types of a cache used in the present specification are described in the following.

Browser Cache

A browser cache may correspond to a file stored by an application using W3CAPI with a storing method supported by a browser. Permanency of the browser cache is determined based on a policy of a browser. In this case, the permanency may correspond to duration of a file stored in the browser cache.

ROUTE Cache

A ROUTE cache can store an NRT file delivered via a ROUTE session of a broadcast network. According to one embodiment, the ROUTE cache can be configured to allocate a certain space in a service unit. And, when files stored in the ROUTE cache arrive at a predetermined capacity or exceed the predetermined capacity, the ROUTE cache can be configured to automatically delete a file(s) stored in the ROUTE cache or can be configured not to store a new file(s) in the ROUTE cache. Although the present specification is explained centering on the ROUTE cache, if an MMT protocol is used, it may use an MMT cache. In this case, the MMT cache can be implemented in a manner of being similar to the ROUTE cache.

Cache Storage

Similar to the browser cache, cache storage can be configured to allocate a predetermined capacity in a unit of an application. And, the cache storage can be configured to access a cache allocated to a corresponding application only. According to one embodiment, the cache storage can be divided into a short term cache and a long term cache. In this case, the cache storage can include the short term cache and/or the long term cache.

Short Term Cache

The short term cache can include attributes described in the following.

The short term cache can be deleted by a user or a receiver without permission (agreement) of an application. In particular, file(s) or cache stored in the short term cache can be deleted by a user or a receiver without permission (agreement) of an application.

The short term cache can preferentially store a file requested by an application. A file moved from the ROUTE cache may have a second highest priority and the remaining files have a next priority.

When it is necessary to delete a file(s) stored in the short term cache due to a problem such as capacity or the like, the short term cache can delete the file based on a priority. In this case, the short term cache can delete a file having a lower priority first.

Long Term Cache

The long term cache can include attributes described in the following.

The long term cache guarantees persistency of a file(s) stored in the long term cache. Hence, the long term cache can allow repetitive access of the file(s) stored in the long term cache.

The long term cache is not deleted without agreement of an application. In particular, a user or a receiver is unable to delete a file(s) or a cache stored in the long term cache without permission (agreement) of an application.

When capacity assigned to the long term cache is full, the long term cache is unable to store an additional file(s) or cache.

Meanwhile, such a term as a cache is used as a term indicating a storing space such as ROUTE cache, cache storage, long term cache, or short term cache. In some cases, the cache can also be used as a term indicating a file or data stored in a storing space.

And, the storing space such as the ROUTE cache, the cache storage, the long term cache, and the short term cache can be physically divided or can be logically divided in one or more physical storing spaces.

FIG. 15 is a diagram illustrating a structure of a manifest according to one embodiment of the present invention.

Referring to FIG. 15, a cache storage manifest, a ROUTE storage manifest, and a local cache manifest are illustrated.

A manifest can provide information on a file(s) or a cache stored in a local cache. The information provided by the manifest can include a file name stored in the local cache, identification information of a file, URL, base URL, a service name related to a file, an application name related to a file, an access path, a file size, and the like.

In this case, the local cache can be used as a concept including a route cache and cache storage (when the cache storage includes a long term cache and a short term cache, the long term cache and the short term cache are included).

The cache storage manifest can be managed by a cache storage manager described later. The cache storage manifest can provide information on a file(s) or cache stored in the cache storage. According to one embodiment, the cache storage manifest can include information on an identifier (ID), URL, base URL, a service name, an application name, a path, a file name, a long term flag, and/or a file size.

In this case, the long term flag may correspond to a flag indicating whether a corresponding file or cache is stored in a short term cache or a long term cache, when the cache storage includes the short term cache and the long term cache.

Meanwhile, when the cache storage is divided into the long term cache and the short term cache, the cache storage manifest can be divided into a long term cache manifest and a short term cache manifest.

The ROUTE cache manifest can be managed by a ROUTE cache manager described later. The ROUTE cache manifest can provide information on a file(s) or cache stored in the ROUTE cache. According to one embodiment, the ROUTE cache manifest can include information on an identifier (ID), URL, base URL, a service name, an application name, a path, a file name, and/or a file size.

The local cache manifest can be managed by a local cache manager described later. The local cache manifest can provide information on a file(s) or cache stored in the local cache. In particular, the local cache manifest can provide information on a file(s) or cache stored in the ROUTE cache and/or the cache storage. According to one embodiment, the local cache manifest can include information on an identifier (ID), URL, base URL, a cache location, a service name, an application name, a path, a file name, and/or a file size.

In this case, the cache location information can indicate whether a file or cache stored in the local cache is stored in the ROUTE cache or the cache storage. According to one embodiment, the cache location information can further indicate whether a file or cache is stored in the short term cache or the long term cache.

In the following, an embodiment that a receiver does not include cache storage, an embodiment that the receiver includes the cache storage, and an embodiment that the receiver includes the cache storage and the cache storage includes a long term cache and a short term cache are sequentially explained.

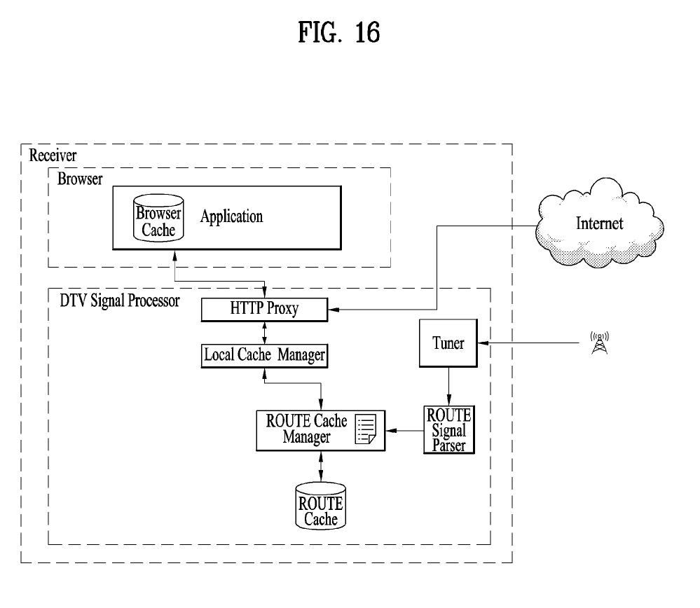

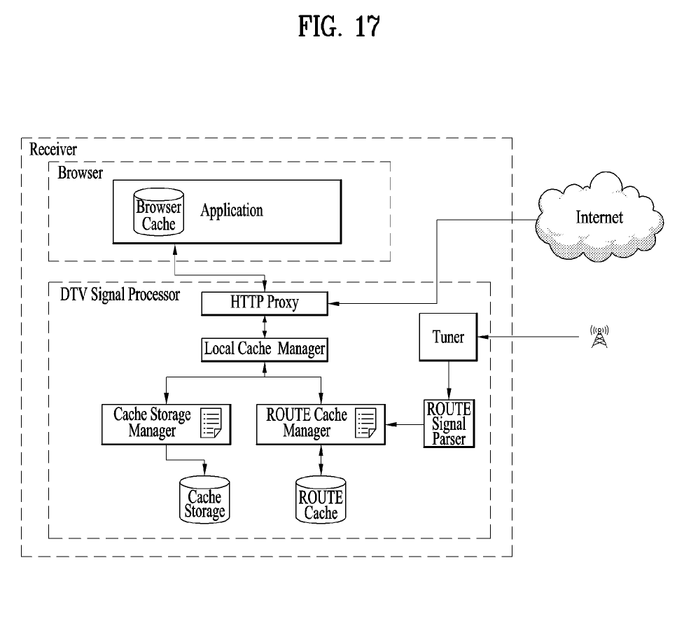

FIG. 16 is a diagram illustrating a configuration and an operation of a receiver according to one embodiment of the present invention.

FIG. 16 illustrates a configuration and an operation of a receiver when cache storage does not exist.

Referring to FIG. 16, a receiver includes a DTV processor and a browser.

In this case, the browser may correspond to an element storing and executing a general web application. In the illustrated embodiment, although the browser is represented as a configuration element of a reception device, the browser may correspond to a device distinguished from the reception device. For example, the DTV processor and the browser can be included in a primary device and a companion device, respectively.

The DTV processor (DTV signal processor) can include a tuner, a ROUTE signal parser, a ROUTE cache manager, a ROUTE cache, a local cache manager, and/or HTTP proxy.

The tuner receives and processes a broadcast signal and can convert the broadcast signal in an appropriate form. According to one embodiment, the broadcast signal can include a ROUTE signal (e.g., ROUTE packet) forwarded via a ROUTE session. The tuner can deliver the broadcast signal to the ROUTE signal parser.

The ROUTE signal parser can receive a broadcast signal from the tuner. The broadcast signal can include a ROUTE signal forwarded via a ROUTE session. And, the ROUTE signal can include service signaling information, real time data information, and/or non-real time data information. The ROUTE signal parser can forward the ROUTE signal to the ROUTE cache manager to store data.

The ROUTE cache manager can receive the ROUTE signal from the ROUTE signal parser.

The ROUTE cache manager can store data, a file, or a cache necessary to be stored in the ROUTE cache among the ROUTE signal. When a file or cache is stored in the ROUTE cache, the ROUTE cache manager can generate and/or update a manifest (route cache manifest) including information on the file or the cache stored in the ROUTE cache. And, the ROUTE cache manager can forward the information on the file or the cache stored in the ROUTE cache to the local cache manager. According to one embodiment, the ROUTE cache manager can forward the route cache manifest to the local cache manager.

The ROUTE cache manager can receive a request from the local cache manager. And, the ROUTE cache manager can forward a response to the local cache manager in response to the request. The request forwarded from the local cache manager may correspond to a request to be forwarded to the local cache manager from the HTTP proxy, which has received the request from an application. And, the response forwarded to the local cache manager is forwarded to the HTTP proxy and the response can be forwarded to an application from the HTTP proxy.

The local cache manager can manage information on a data, a file, or cache to be stored in a local area. In other word, the local cache manager can manage a locally-cached file. When the locally-caches file is stored in the local area, the local cache manager can generate and/or update a manifest (local cache manifest) including information on the stored file or cache.

The local cache manager can receive an input of information on a file or cache stored in the ROUTE cache from the ROUTE cache manager. According to one embodiment, the information inputted to the local cache manager from the ROUTE cache manager may correspond to route cache manifest.

The local cache manager can receive a request from the HTP proxy. The local cache manager can forward the request received from the HTTP proxy to the ROUTE cache manager. The local cache manager can receive a response from the ROUTE cache manager. The local cache manager can forward the response received from the ROUTE cache manager to the HTTP proxy.

The HTTP proxy can receive a broadband resource from a broadband network. The broadband resource can be stored in a browser cache included in a browser.

The HTTP proxy can communicate with an application. According to one embodiment, a web socket connection is established between the HTTP proxy and the application and a request and a response can be transmitted and received between the HTTP proxy and the application through JSON-RPC. The application can forward a request to the HTTP proxy and the HTTP proxy can forward a response (result) to the application in response to the request.

<Embodiment that Cache Storage does not Exist>

In the following, when cache storage does not exist, a procedure of storing data included in a broadcast signal in a ROUTE cache and a method for an application to access a resource are sequentially described with reference to FIG. 16.

When Cache Storage does not Exist, a Procedure for a Receiver to Store ROUTE Cache.

A tuner receives a broadcast signal transmitted through a broadcast network and forwards the broadcast signal to a ROUTE signal parser. In this case, when a ROUTE signal is included in the broadcast signal, the tuner can forward the ROUTE signal to the ROUTE signal parser.

Subsequently, the ROUTE signal parser receives the ROUTE signal and extracts an NRT file from the ROUTE signal. The ROUTE signal parser forwards the extracted NRT file to a ROUTE cache manager.

Subsequently, the ROUTE cache manager stores the received NRT file in a ROUTE cache and records file information in a manifest. In particular, the ROUTE cache manager can record information on a file or cache stored in the ROUTE cache in a route cache manifest.

When Cache Storage does not Exist, a Method for an Application to Access a Resource

First of all, an application can access a resource stored in a browser cache as follows. The application is performed in a manner of being embedded on a service page and can access a browser cache assigned to each service. In particular, the application can obtain a resource by accessing a browser cache assigned to each service.

Subsequently, the application can access a resource stored in a browser cache as follows.

The application can communicate with a HTTP proxy of a receiver via an API (Application Programming Interface) provided by a service page or a library provided in advance. Hence, the application can forward a request to the HTTP proxy to access a ROUTE cache assigned to each service. In this case, the request forwarded to the HTTP proxy can include a manifest request and a file request.

First of all, the application can forward a manifest request to the HTTP proxy. The HTTP proxy can transmit a response to the application in response to the manifest request of the application. In this case, the response of the HTTP proxy can include a manifest or path information on the manifest. When the application forwards the manifest request to the HTTP proxy, the application can designate a manifest. In this case, the HTTP proxy can forward a response including the designated manifest or path information on the designated manifest to the application. According to one embodiment, the application can request a ROUTE cache manifest.

Subsequently, the application selects a desired file or a cache based on the manifest and can forward a request for the selected cache to the HTTP proxy. The HTTP proxy can forward a file stored in the ROUTE cache or path information on the file to the application in response to the request.

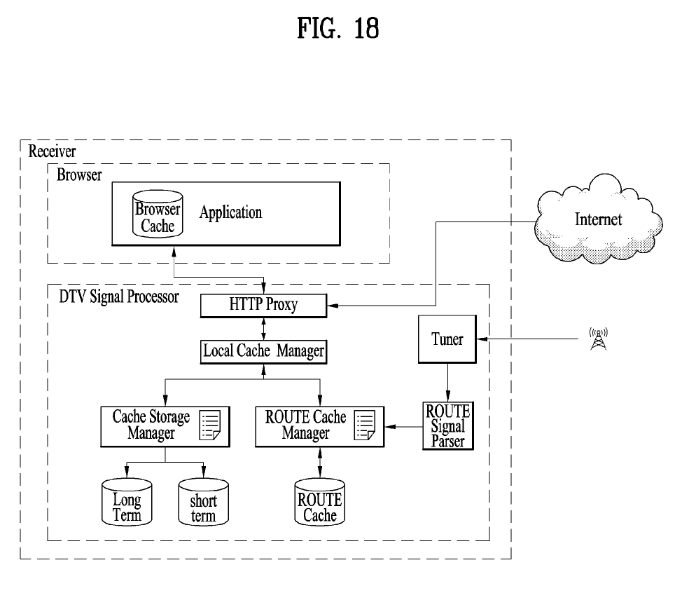

FIG. 17 is a diagram illustrating a configuration and an operation of a receiver according to a different embodiment of the present invention.

FIG. 17 illustrates a configuration and an operation of a receiver when cache storage exists.

Referring to FIG. 17, a receiver includes a DTV processor (DTV signal processor) and a browser.

When an embodiment of FIG. 17 is compared with the embodiment of FIG. 16, the embodiment of FIG. 17 further includes cache storage and a cache storage manager.

The DTV processor can include a tuner, a ROUTE signal parser, a ROUTE cache manager, a ROUTE cache, a local cache manager, cache storage, a cache storage manager, and/or HTTP proxy.

The tuner receives and processes a broadcast signal and can convert the broadcast signal in an appropriate form. According to one embodiment, the broadcast signal can include a ROUTE signal (e.g., ROUTE packet) forwarded via a ROUTE session. The tuner can deliver the broadcast signal to the ROUTE signal parser.

The ROUTE signal parser can receive a broadcast signal from the tuner. The broadcast signal can include a ROUTE signal forwarded via a ROUTE session. And, the ROUTE signal can include service signaling information, real time data information, and/or non-real time data information. The ROUTE signal parser can forward the ROUTE signal to the ROUTE cache manager to store data.

The ROUTE cache manager can receive the ROUTE signal from the ROUTE signal parser.

The ROUTE cache manager can store data, a file, or a cache necessary to be stored in the ROUTE cache among the ROUTE signal. When a file or cache is stored in the ROUTE cache, the ROUTE cache manager can generate and/or update a manifest (route cache manifest) including information on the file or the cache stored in the ROUTE cache. And, the ROUTE cache manager can forward the information on the file or the cache stored in the ROUTE cache to the local cache manager. According to one embodiment, the ROUTE cache manager can forward the route cache manifest to the local cache manager.

The ROUTE cache manager can receive a request from the local cache manager. And, the ROUTE cache manager can forward a response to the local cache manager in response to the request. The request forwarded from the local cache manager may correspond to a request to be forwarded to the local cache manager from the HTTP proxy, which has received the request from an application. And, the response forwarded from the local cache manager is forwarded to the HTTP proxy and the response can be forwarded to an application from the HTTP proxy.

The local cache manager can manage information on a data, a file, or cache to be stored in a local area. In other word, the local cache manager can manage a locally-cached file. When the locally-caches file is stored in the local area, the local cache manager can generate and/or update a manifest (local cache manifest) including information on the stored file or cache.

The local cache manager can receive an input of information on a file or cache stored in the ROUTE cache from the ROUTE cache manager. According to one embodiment, the information inputted to the local cache manager from the ROUTE cache manager may correspond to route cache manifest.

The local cache manager can receive an input of information on a file or cache stored in the cache storage from the cache storage manager. According to one embodiment, the information inputted to the local cache manager from the cache storage manager may correspond to a cache storage manifest.

The local cache manager can receive a request from the HTP proxy. The local cache manager can forward the request received from the HTTP proxy to the ROUTE cache manager. The local cache manager can receive a response from the ROUTE cache manager. The local cache manager can forward the response received from the ROUTE cache manager to the HTTP proxy.

And, the local cache manager can forward the request received from the HTTP proxy to the cache storage manager. The local cache manager can receive a response from the cache storage manager. The local cache manager can forward the response received from the cache storage manager to the HTTP proxy.

The HTTP proxy can receive a broadband resource from a broadband network. The broadband resource can be stored in a browser cache included in a browser.

The HTTP proxy can communicate with an application. According to one embodiment, a web socket connection is established between the HTTP proxy and the application and a request and a response can be transmitted and received between the HTTP proxy and the application through JSON-RPC. The application can forward a request to the HTTP proxy and the HTTP proxy can forward a response (result) to the application in response to the request.

<Embodiment that Cache Storage Exists>

In the following, when cache storage exists, a procedure of storing a file stored in a ROUTE cache in the cache storage, a procedure of storing a broadband resource in the cache storage, and a method of accessing a resource are sequentially described with reference to FIG. 17.

A Procedure of Storing a File Stored in the ROUTE Cache in the Cache Storage Upon the Request of an Application

Assume that a file or a cache is stored in the ROUTE cache in advance.

The application can forward a request (manifest request) to the HTTP proxy.

Having received the request (manifest request) from the application, the HTTP proxy can forward a manifest to the application in response to the request.

When the application receives the manifest from the HTTP proxy, the application selects a necessary file or cache from among files or caches recorded on the manifest and can forward a request for the selected cache to the HTTP proxy.

The HTTP proxy forwards the request for the selected cache to the local cache manager. The local cache manager forwards the request to the ROUTE cache manager. The ROUTE cache manager receives the request through the application, the HTTP proxy, and the local cache manager. The ROUTE cache manager extracts the selected cache from ROUTE cache and forwards the cache to the local cache manager. The ROUTE cache manager deletes information on the selected cache, which is forwarded to the local cache manager, from the ROUTE cache manifest. The ROUTE cache manager deletes the cache forwarded to the local cache manager from the ROUTE cache.

The local cache manager forwards the cache received from the ROUTE cache manager to the cache storage manager.

When the cache storage manager receives the cache from the local cache manager, the cache storage manager stores the cache in the cache storage and records information on the cache in a manifest (cache storage manifest).

After the abovementioned procedures are performed, the selected cache stored in the ROUTE cache is stored in the cache storage, the information on the cache is deleted from the ROUTE cache manifest, and the information is recorded on the cache storage manifest.

A Procedure for an Application to Store a Broadband Resource in Cache Storage

A resource transmitted on a broadband can be stored in a browser cache or can be received via the Internet. In this case, the resource stored in the browser cache or the resource received via the Internet may correspond to a resource file or a URL of the resource.

The resource stored in the browser cache is forwarded to the HTTP proxy by an application and the resource received via the Internet is forwarded to the HTTP proxy.

The HTTP proxy forwards the resource to the local cache manager.

The local cache manager forwards the resource to the cache storage manager.

The cache storage manager receives the resource from the local cache manager, records information on the resource on a manifest (cache storage manifest), and stores the resource in the cache storage.

After the abovementioned procedures are performed, the resource transmitted on the broadband is stored in the cache storage and information indicating that the resource is included in the cache storage is recorded on the cache storage manifest.

A Procedure for an Application to Access a Resource

An application selects a resource to be accessed by the application and forwards a request for the selected resource to the HTTP proxy. When a path of the requested resource corresponds to the Internet, the HTTP proxy receives the resource through the Internet and forwards the received resource to the application.

When the path of the requested resource is not the Internet, the HTTP proxy forwards the request for the selected resource to the local cache manager. In this case, the request, which is forwarded to the local cache manager by the HTTP proxy, can include a manifest request.

The local cache manager respectively requests a manifest to the cache storage manager and the ROUTE cache manager and can receive a cache storage manifest and a ROUTE cache manifest. The local cache manager can configure a local cache manifest using the cache storage manifest and the ROUTE cache manifest received from the cache storage manager and the ROUTE cache manager, respectively.

The local cache manager searches for the local cache manifest to determine whether or not there is a resource requested by the HTTP proxy. If there is resource requested by the HTTP proxy, the local cache manager checks a location of the resource. When the resource corresponds to a locally-cached resource, in particular, when the requested resource is stored in the local cache, the local cache manifest indicates a location at which the resource is located among the ROUTE cache and the cache storage. Specifically, the local cache manifest can indicate information on whether or not the resource is located at the ROUTE cache through cache location information (refer to the aforementioned manifest structure).

When the resource is located at the ROUTE cache, the local cache manager forwards a request for the resource to the ROUTE cache manager. When the resource is located at the cache storage, the local cache manager forwards a request for the resource to the cache storage manager.

First of all, when the resource is located at the ROUTE cache, the ROUTE cache manager extracts the requested resource from the ROUTE cache and forwards the requested resource to the local cache manager. And, the route cache manager deletes information on the resource forwarded to the local cache manager from the ROUTE cache manifest. The ROUTE cache manager deletes the resource forwarded to the local cache manager from the ROUTE cache.

When the local cache manager receives the resource from the ROUTE cache manager, the local cache manager forwards the resource to the cache storage manager and the HTTP proxy, respectively.

When the cache storage manager receives the resource from the local cache manager, the cache storage manager stores the resource in the cache storage and records information on the resource in a manifest (cache storage manifest).

When the HTTP proxy receives the resource from the local cache manager, the HTTP proxy forwards the resource to the application.

After the aforementioned procedures are performed, the resource stored in the ROUTE cache is stored in the cache storage, information on the resource is deleted from the ROUTE cache manifest, and the information is recorded on the cache storage manifest.

Meanwhile, when the resource is located at the cache storage, the cache storage manager extracts the requested resource from the cache storage and forwards the requested resource to the local cache manager. Subsequently, the local cache manager forwards the resource to the HTTP proxy. Subsequently, the HTTP proxy forwards the resource to the application.

FIG. 18 is a diagram illustrating a configuration and an operation of a receiver according to a further different embodiment of the present invention.

FIG. 18 illustrates a configuration and an operation of a receiver when cache storage includes a long term cache and a short term cache.

Referring to FIG. 18, a receiver includes a DTV processor (DTV signal processor) and a browser.

When an embodiment of FIG. 18 is compared with the embodiment of FIG. 17, the embodiment of FIG. 18 has a difference in that the cache storage includes a long term cache and a short term cache.

The DTV processor can include a tuner, a ROUTE signal parser, a ROUTE cache manager, a ROUTE cache, a local cache manager, cache storage (long term cache, short term cache), a cache storage manager, and/or HTTP proxy.

The tuner receives and processes a broadcast signal and can convert the broadcast signal in an appropriate form. According to one embodiment, the broadcast signal can include a ROUTE signal (e.g., ROUTE packet) forwarded via a ROUTE session. The tuner can deliver the broadcast signal to the ROUTE signal parser.

The ROUTE signal parser can receive a broadcast signal from the tuner. The broadcast signal can include a ROUTE signal forwarded via a ROUTE session. And, the ROUTE signal can include service signaling information, real time data information, and/or non-real time data information. The ROUTE signal parser can forward the ROUTE signal to the ROUTE cache manager to store data.

The ROUTE cache manager can receive the ROUTE signal from the ROUTE signal parser.

The ROUTE cache manager can store data, a file, or a cache necessary to be stored in the ROUTE cache among the ROUTE signal. When a file or cache is stored in the ROUTE cache, the ROUTE cache manager can generate and/or update a manifest (route cache manifest) including information on the file or the cache stored in the ROUTE cache. And, the ROUTE cache manager can forward the information on the file or the cache stored in the ROUTE cache to the local cache manager. According to one embodiment, the ROUTE cache manager can forward the route cache manifest to the local cache manager.

The ROUTE cache manager can receive a request from the local cache manager. And, the ROUTE cache manager can forward a response to the local cache manager in response to the request. The request forwarded from the local cache manager may correspond to a request to be forwarded to the local cache manager from the HTTP proxy, which has received the request from an application. And, the response forwarded to the local cache manager is forwarded to the HTTP proxy and the response can be forwarded to an application from the HTTP proxy.

The local cache manager can manage information on a data, a file, or cache to be stored in a local area. In other word, the local cache manager can manage a locally-cached file. When the locally-caches file is stored in the local area, the local cache manager can generate and/or update a manifest (local cache manifest) including information on the stored file or cache.

The local cache manager can receive an input of information on a file or cache stored in the ROUTE cache from the ROUTE cache manager. According to one embodiment, the information inputted to the local cache manager from the ROUTE cache manager may correspond to route cache manifest.

The local cache manager can receive an input of information on a file or cache stored in the cache storage from the cache storage manager. According to one embodiment, the information inputted to the local cache manager from the cache storage manager may correspond to a cache storage manifest.

The local cache manager can receive a request from the HTP proxy. The local cache manager can forward the request received from the HTTP proxy to the ROUTE cache manager. The local cache manager can receive a response from the ROUTE cache manager. The local cache manager can forward the response received form the ROUTE cache manager to the HTTP proxy.

And, the local cache manager can forward the request received from the HTTP proxy to the cache storage manager. The local cache manager can receive a response from the cache storage manager. The local cache manager can forward the response received from the cache storage manager to the HTTP proxy.

The HTTP proxy can receive a broadband resource from a broadband network. The broadband resource can be stored in a browser cache included in a browser.

The HTTP proxy can communicate with an application. According to one embodiment, a web socket connection is established between the HTTP proxy and the application and a request and a response can be transmitted and received between the HTTP proxy and the application through JSON-RPC. The application can forward a request to the HTTP proxy and the HTTP proxy can forward a response (result) to the application in response to the request.

<Embodiment that Long Term Cache and Short Term Cache Exist>

In the following, an embodiment that there is cache storage and the cache storage is divided into a long term cache and a short term cache is explained with reference to FIG. 18. More specifically, a procedure of storing a file stored in a ROUTE cache in cache storage, a procedure of storing a broadband resource in the cache storage, and a method of accessing a resource are sequentially described with reference to FIG. 18.

A Procedure of Storing Contents Stored in the ROUTE Cache in the Cache Storage Upon the Request of an Application

Assume that a file or a cache is stored in the ROUTE cache in advance.

When the HTTP proxy receives a request (manifest request) from an application, the HTTP proxy can forward a manifest to the application in response to the request.

When the application receives the manifest from the HTTP proxy, the application selects a necessary file or cache from among files or caches recorded on the manifest and can forward a request for the selected cache to the HTTP proxy.

When the application receives the manifest from the HTTP proxy, the application selects a necessary file of cache from among files or caches recorded on the manifest and can forward a request for the selected cache to the HTTP proxy.

The HTTP proxy forwards a request for the selected cache to the local cache manager. The local cache manager requests the selected cache to the ROUTE cache manager. The ROUTE cache manager receives the request through the application, the HTTP proxy, and the local cache manager. The ROUTE cache manager extracts the selected cache from the ROUTE cache and forwards the cache to the local cache manager. The ROUTE cache manager deletes information on the selected cache forwarded to the local cache manager from the ROUTE cache manifest. The ROUTE cache manager deletes the cache forwarded to the local cache manager from the ROUTE cache.

The local cache manager forwards the cache received from the ROUTE cache manager to the cache storage manager.

When the cache storage manager receives the cache from the local cache manager, the cache storage manager stores the cache in the short term cache or the long term cache and records information on the cache in a manifest (cache storage manifest). According to one embodiment, when the cache storage manager does not receive a request for storing the cache in the long term cache, the cache storage manager can be configured to store the cache in the short term cache.

After the abovementioned procedures are performed, the selected cache stored in the ROUTE cache is stored in the long term cache or the short term cache, the information on the cache is deleted from the ROUTE cache manifest, and the information is recorded on the cache storage manifest.

A Procedure for an Application to Store a Broadband Resource in Long Term Cache or Short Term Cache

A resource transmitted on a broadband can be stored in a browser cache or can be received via the Internet. In this case, the resource stored in the browser cache or the resource received via the Internet may correspond to a resource file or a URL (Uniform Resource Locator) of the resource.

The resource stored in the browser cache is forwarded to the HTTP proxy by an application and the resource received via the Internet is forwarded to the HTTP proxy.

In this case, the application can output control information to indicate a cache at which the resource is to be stored among the long term cache and the short term cache. According to one embodiment, the application can output control information indicating that the resource is to be stored in the long term cache. The control information can be forwarded to the local cache manager and the cache storage manager via the HTTP proxy.

The HTTP proxy forwards the resource to the local cache manager.

The local cache manager forwards the resource to the cache storage manager.

The cache storage manager receives the resource from the local cache manager, records information on the resource (information indicating a cache at which the resource is to be stored among the long term cache and the short term cache) on a manifest (cache storage manifest), and stores the resource in the long term cache or the short term cache.

After the abovementioned procedures are performed, the resource transmitted on the broadband can be stored in the long term cache or the short term cache and information indicating that the resource is included in the long term cache or the short term cache can be recorded on the cache storage manifest.

A Procedure for an Application to Access a Resource

An application selects a resource to be accessed by the application and forwards a request for the selected resource to the HTTP proxy. When a path of the requested resource corresponds to the Internet, the HTTP proxy receives the resource through the Internet and forwards the received resource to the application.

When the path of the requested resource is not the Internet, the HTTP proxy forwards the request for the selected resource to the local cache manager. In this case, the request, which is forwarded to the local cache manager by the HTTP proxy, can include a manifest request.

The local cache manager respectively requests a manifest to the cache storage manager and the ROUTE cache manager and can receive a cache storage manifest and a ROUTE cache manifest. The local cache manager can configure a local cache manifest using the cache storage manifest and the ROUTE cache manifest received from the cache storage manager and the ROUTE cache manager, respectively.

The local cache manager searches for the local cache manifest to determine whether or not there is a resource requested by the HTTP proxy. If there is a resource requested by the HTTP proxy, the local cache manager checks a location of the resource. When the resource corresponds to a locally-cached resource, in particular, when the requested resource is stored in the local cache, the local cache manifest indicates a location at which the resource is located among the ROUTE cache and the cache storage. Specifically, the local cache manifest can indicate information on whether or not the resource is located at the ROUTE cache through cache location information (refer to the aforementioned manifest structure).

When the resource is located at the ROUTE cache, the local cache manager forwards a request for the resource to the ROUTE cache manager. When the resource is located at the cache storage (long term cache or short term cache), the local cache manager forwards a request for the resource to the cache storage manager.

First of all, when the resource is located at the ROUTE cache, the ROUTE cache manager extracts the requested resource from the ROUTE cache and forwards the requested resource to the local cache manager. And, the ROUTE cache manager deletes information on the resource forwarded to the local cache manager from the ROUTE cache manifest. The ROUTE cache manager may or may not delete the resource forwarded to the local cache manager from the ROUTE cache.

When the local cache manager receives the resource from the ROUTE cache manager, the local cache manager forwards the resource to the cache storage manager and the HTTP proxy, respectively.

When the cache storage manager receives the resource from the local cache manager, the cache storage manager stores the resource in the cache storage and records information on the resource in a manifest (cache storage manifest). In this case, the cache storage manager stores corresponding cache in the long term cache or the short term cache and records in formation on a location at which the cache is stored in a manifest (cache storage manifest). According to one embodiment, when the cache storage manager does not receive a request for storing the cache in the long term cache, the cache storage manager can be configured to store the cache in the short term cache.

When the HTTP proxy receives the resource from the local cache manager, the HTTP proxy forwards the resource to the application.

After the aforementioned procedures are performed, the resource stored in the ROUTE cache is stored in the long term cache or the short term cache, information on the resource is deleted from the ROUTE cache manifest, and the information is recorded on the cache storage manifest.

Meanwhile, when the resource is located at the cache storage (long term cache or short term cache), the cache storage manager extracts the requested resource from the cache storage (long term cache or short term cache) and forwards the requested resource to the local cache manager. Subsequently, the local cache manager forwards the resource to the HTTP proxy. Subsequently, the HTTP proxy forwards the resource to the application.

After the abovementioned procedures are performed, the application can access the resource stored in the long term cache or the short term cache.

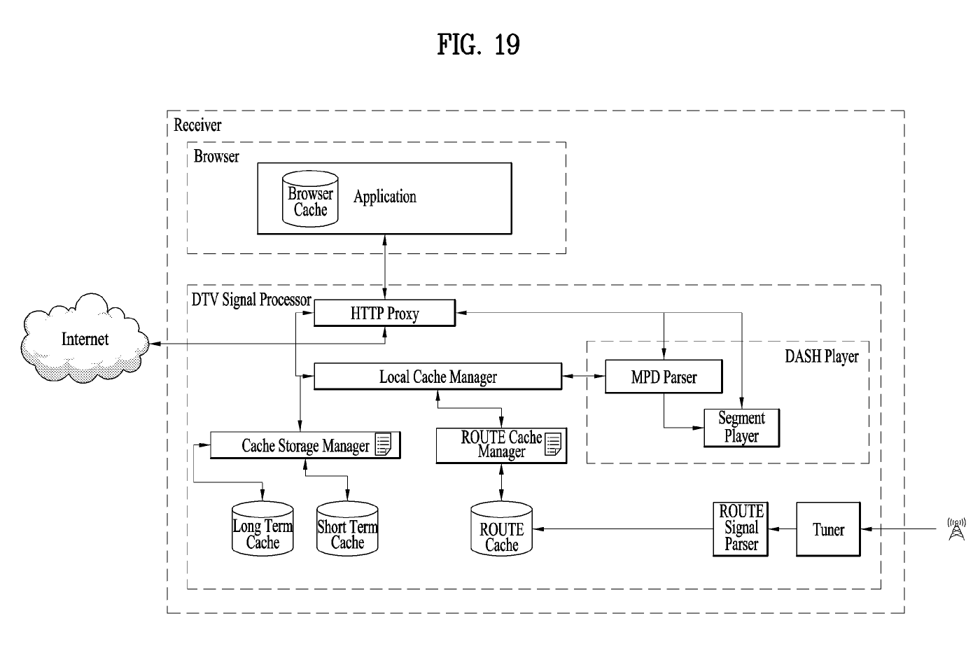

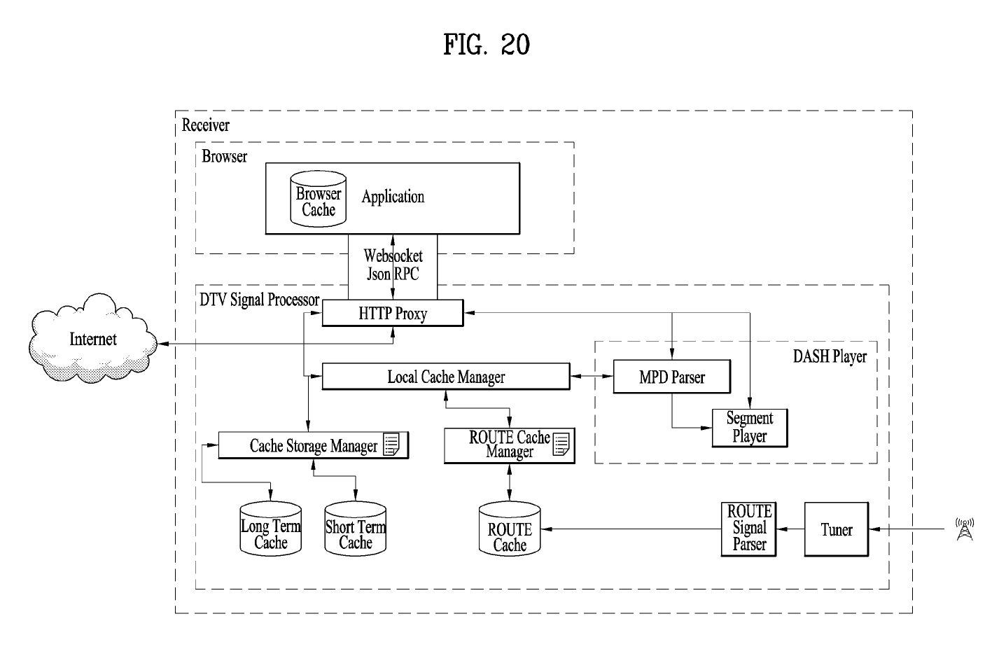

FIG. 19 is a diagram illustrating a configuration and an operation of a receiver according to a further different embodiment of the present invention.

The embodiment illustrated in FIG. 19 corresponds to an embodiment further including an embedded DASH player in addition to the embodiment of FIG. 18.

Since it is able to apply the function and the operation of the configuration elements mentioned earlier with reference to the embodiment of FIG. 18 to the present explanation, added parts are mainly explained.

According to one embodiment of the present invention, a receiver can further include a DASH player.

The DASH player can include an MPD parser and a segment play.

The MPD parser can communicate with a HTTP proxy and/or a local cache manager.

The MPD parser can receive MPD forwarded via the Internet through the HTTP proxy.

And, the MPD parser can receive MPD transmitted via a broadcast network through the local cache manager. According to one embodiment, the MPD forwarded via the broadcast network can be transmitted via a ROUTE session.

The MPD parser parses the MPD received through the HTTP proxy and/or the local cache manager and can request a segment file for a media presentation described by the MPD. According to one embodiment, the MPD parser can forward a segment URL included in the MPD to the HTTP proxy and/or the local cache manager. The MPD parser transmits the request for the segment file in accordance with a timeline and can enable a segment player to receive and play the segment file.

According to one embodiment, when the HTTP proxy and/or the local cache manager receive the request for the segment file, the HTTP proxy and/or the local cache manager search for a local cache manifest. If the segment file corresponds to a locally-cached file, the segment file can be received from a ROUTE cache or cache storage (long term cache or short term cache).

The segment player can receive segment files from the HTTP proxy. The segment player can play a segment file corresponding to a media segment among the received segment files.

The segment player can play the media segment received from the HTTP proxy based on the explanation on the media presentation described in the MPD.

In the following, an embodiment of playing a segment file in a DASH player is explained in detail with reference to FIG. 19. The present example corresponds to an embodiment for a case that a segment file is stored in a long term cache.

An MPD parser receives MPD. In the present embodiment, the MPD parser can receive the MPD through the HTTP proxy.

The MPD parser can extract a URL of a segment file to be played at the present time from the MPD.

The MPD parser forwards the extracted URL of the segment file to the HTTP proxy. The HTTP proxy receives the URL of the segment file. The HTTP proxy checks a path of the segment file through the URL of the segment file and determines whether or not the segment file belongs to a local cache. According to one embodiment, when a URL of a segment file starts with http://<LocalGatewayAddress>, the URL of the segment file can indicate that the segment file belongs to the local cache.

The HTTP proxy searches for information recorded on a manifest and requests a locally-cached segment file. In the present embodiment, since the segment file is stored in the long term cache, the local cache manager can receive the segment file stored in the long term cache through the cache storage manager. The local cache manager forwards the segment file stored in the long term cache to the HTTP proxy in response to the request of the HTTP proxy. The segment player accesses the segment file through the HTTP proxy and plays the segment file.

FIG. 20 is a diagram illustrating an embodiment of implementing API provided by HTTP proxy using JSON RPC.

Referring to FIG. 20, it is able to see that a web socket connection is established between a HTTP proxy and an application and bidirectional communication is performed between the HTTP proxy and the application via JSON RPC. The HTTP proxy and the application on a browser establish a connection via Websocket included in HTML5 and can perform bidirectional communication via a JSON RPC scheme. In particular, since the JSON RPC scheme is able to perform data transmission using a single serialized object, the JSON RPC scheme is appropriate for communication that performs light notification, a command, and the like. Moreover, since Runtime environment of ASTC 3.0 uses the Websocket and the JSON RPC as the same environment, the present embodiment may be suitable for a hybrid broadcast system.

In the following, a scheme of transmitting and receiving a request and a response related to a cache using the JSON RPC and an example of the scheme are explained in detail. The request and the response transmitted and received using the JSON RPC scheme can be performed through a web socket between an application and a HTTP proxy.

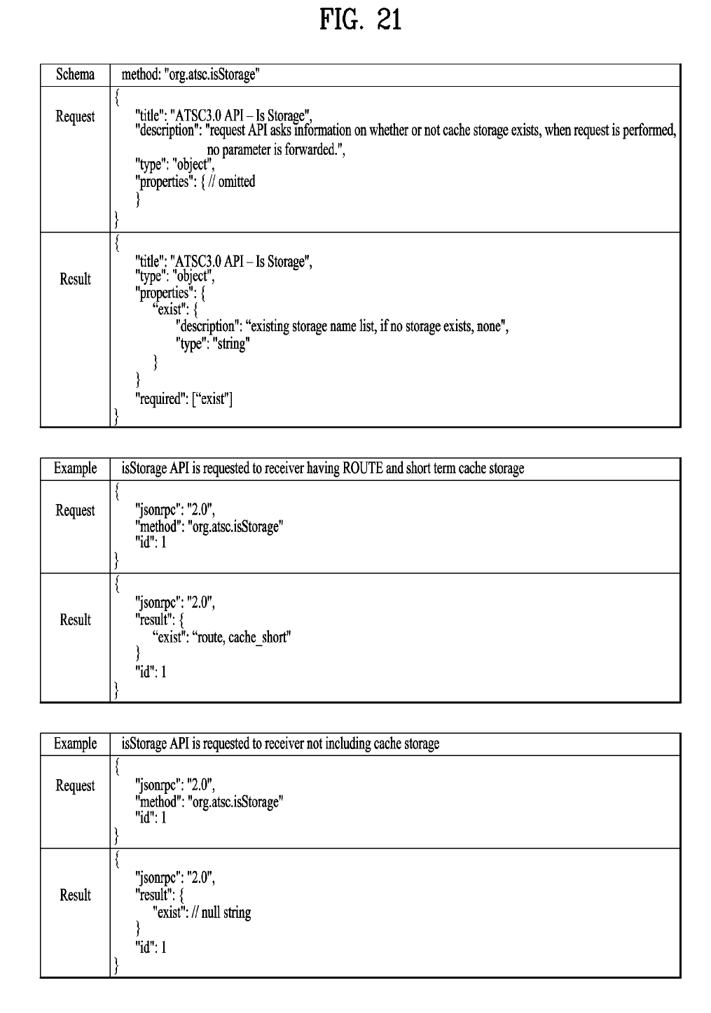

FIG. 21 is a diagram illustrating IsStorgae scheme and an example.

Referring to FIG. 21, IsStorage scheme is illustrated on an upper part and detail examples of using the IsStorage are illustrated in a middle part and a bottom part.

First of all, referring to the upper part of FIG. 21, information indicating that a scheme corresponds to IsStorage and explanation on an operation of the IsStorage scheme are illustrated. The IsStorage can be configured by a request and a result. For the request, the application asks the HTTP proxy to provide information on whether or not cache storage exists. For the result, the HTTP proxy can provide the application with the information on whether or not the cache storage exists. When the cache storage exists, the result may correspond to a name or an attribute of the cache storage. When the cache storage does not exist, the result may correspond to a result indicating that the cache storage does not exist. In this case, the name or the attribute of the storage may correspond to a ROUTE cache, cache storage, a long term cache, or a short term cache.

Referring to the middle part of FIG. 21, a specific example for a request and a result is illustrated when a receiver includes a ROUTE cache and a short term cache.

The request includes information indicating that a scheme corresponds to IsStorage and information on an identifier of the request.

The result includes “route, cache_short” information indicating that a ROUTE cache and a short term cache exist in a receiver.

Referring to the bottom part of FIG. 21, a request and a result are illustrated when a receiver does not include cache storage.

The request includes information indicating that a scheme corresponds to IsStorage and information on an identifier of the request.

The result includes (null) information indicating that cache storage does not exist in a receiver.

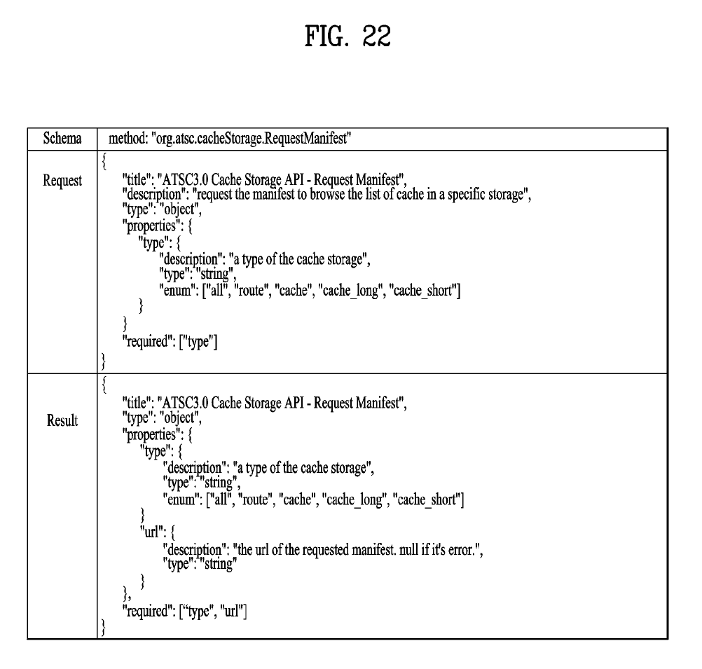

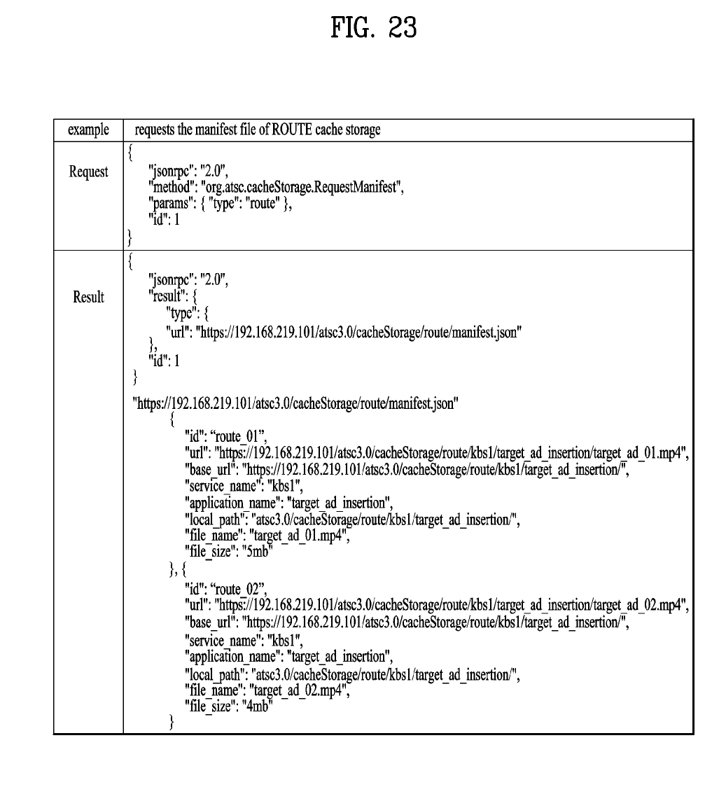

FIG. 22 is a diagram illustrating a RequestManifest scheme and FIG. 23 is a diagram illustrating an example of the RequestManifest scheme.

Referring to FIGS. 22 and 23, a RequestManifest scheme is illustrated in FIG. 22 and a specific example of using the RequestManifest scheme is illustrated in FIG. 23.

First of all, referring to FIG. 22, information indicating that a scheme corresponds to RequestManifest and explanation on an operation of the RequestManifest scheme are illustrated. The RequestManifest can be configured by a request and a result. For the request, an application asks a HTTP proxy to forward a manifest. For the result, the HTTP proxy can provide the application with manifest information. The RequestManifest request corresponds to a parameter and can include type information of a manifest. According to one embodiment, a type of a manifest can include “all”, “route”, “cache”, “cache_long”, and “cache_short”. In this case, “route” corresponds to a request for a ROUTE cache manifest, “cache” corresponds to a request for cache storage, and “cache_long” and “cache_short” may correspond to a request for a long term cache and a request for a short term cache, respectively. And, “all” may correspond to a request for all local caches included in a receiver.

The RequestManifest result can include manifest information corresponding to a parameter included in the request.

Referring to FIG. 23, an example that an application requests a route cache manifest to a HTTP proxy and the HTTP proxy forwards route cache manifest information to the application in response to the request is illustrated in detail.

A request includes information indicating that a scheme corresponds to RequestManifest, information indicating that a requested manifest corresponds to a route cache manifest, and information on an identifier of the request.

A result includes route cache manifest information. In the present embodiment, a route cache includes two files or two caches. The route cache manifest includes information on an ID, a URL, a base URL, a service name, an application name, a local path, a file name, and a file size of each of the files or caches.

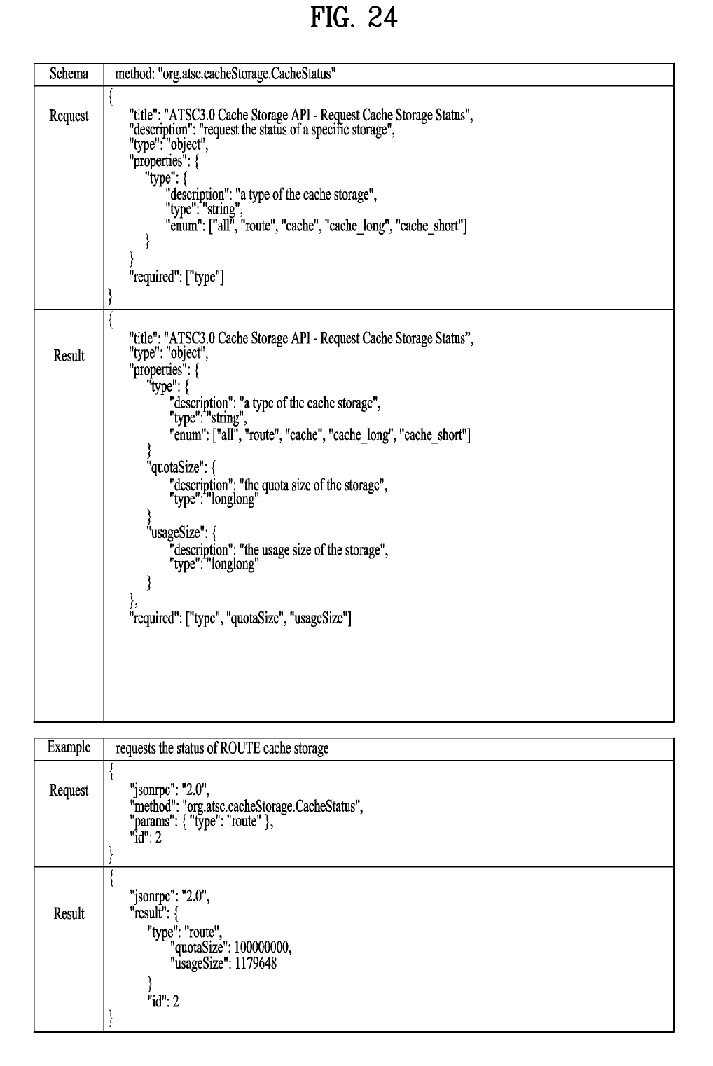

FIG. 24 is a diagram illustrating a Request Cache Storage Status scheme and an example.

Referring to FIG. 24, Request Cache Storage Status scheme is illustrated on an upper part and detail examples of using the Request Cache Storage Status scheme are illustrated on a bottom part.

First of all, referring to the upper part of FIG. 24, information indicating that a scheme corresponds to Request Cache Storage Status scheme and explanation on an operation of the Request Cache Storage Status scheme are illustrated. The Request Cache Storage Status scheme can be configured by a request and a result. For the request, the application asks the HTTP proxy to provide status information of certain storage. For the result, the HTTP proxy can provide the application with the status information of the storage. The Request Cache Storage Status request corresponds to a parameter and can include type information of storage. According to one embodiment, a type of storage can include “all”, “route”, “cache”, “cache_long”, and “cache_short”. In this case, “route” corresponds to a request for a status of a ROUTE cache, “cache” corresponds to a request for a status of cache storage, and “cache_long” and “cache_short” may correspond to a request for a status of a long term cache and a request for a status of a short term cache, respectively. And, “all” may correspond to a request for a status of all local caches included in a receiver.

The Request Cache Storage Status result can include status information of storage corresponding to a parameter included in the request. Specifically, the status information of the storage can include total capacity, used capacity, and the residual capacity of the storage.

Referring to the bottom part of FIG. 24, a specific example that an application requests a status of a route cache to a HTTP proxy and the HTTP proxy forwards status information of the route cache to the application in response to the request is illustrated.

A request includes information indicating that a scheme corresponds to Request Cache Storage Status, information indicating that status requested storage corresponds to a route cache, and information on an identifier of the request.

A result includes status information of a route cache. In the present embodiment, assume that total capacity (quotaSize) of the route cache corresponds to 100000000 (unit is omitted) and used capacity (usageSize) corresponds to 1179648 (unit is omitted).

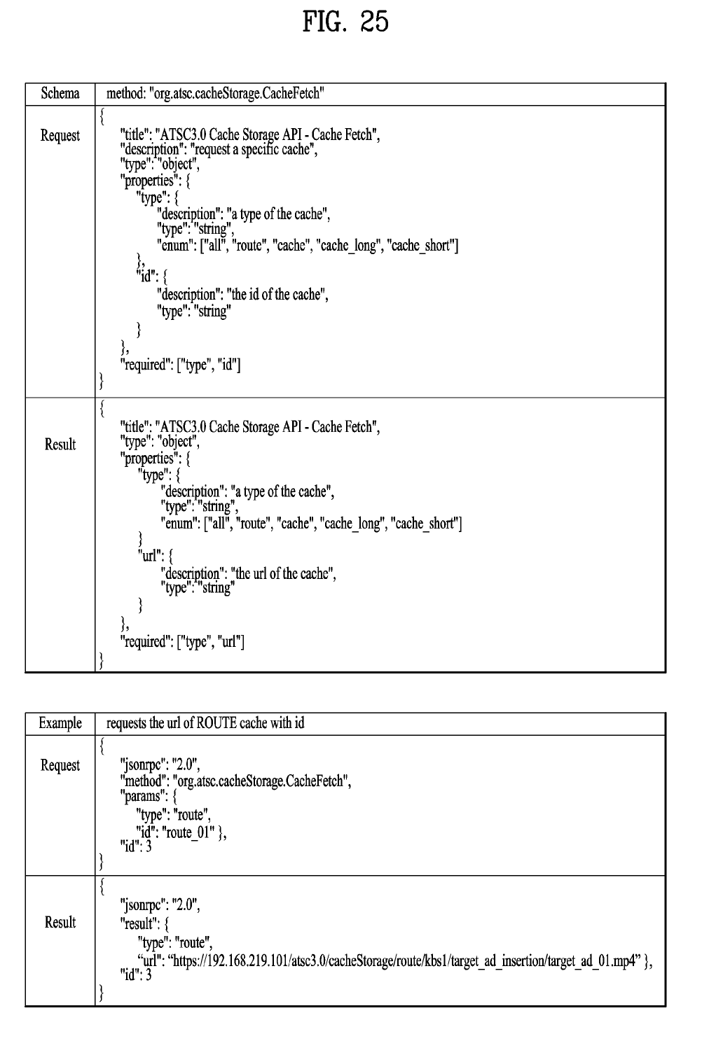

FIG. 25 is a diagram illustrating a Cache Fetch scheme and an example.

Referring to FIG. 25, Cache Fetch scheme is illustrated on an upper part and detail examples of using the Cache Fetch scheme are illustrated on a bottom part.

First of all, referring to the upper part of FIG. 25, information indicating that a scheme corresponds to a Cache Fetch scheme and explanation on an operation of the Cache Fetch scheme are illustrated. The Cache Fetch scheme can be configured by a request and a result. For the request, the application asks the HTTP proxy to forward a predetermined cache or a file. For the result, the HTTP proxy can forward the cache or the file to the application. The Cache Fetch request corresponds to a parameter and can include type information of storage and identification information of a cache or a file included in the storage. According to one embodiment, a type of storage can include “all”, “route”, “cache”, “cache_long”, and “cache_short”. In this case, “route” corresponds to a request for a file or a cache included in a ROUTE cache, “cache” corresponds to a request for a file or a cache included in cache storage, and “cache_long” and “cache_short” may correspond to a request for a file or a cache included in a long term cache and a request for a file or a cache included in a short term cache, respectively. And, “all” may correspond to a request for a file or a cache included in all local caches included in a receiver.

The Cache Fetch result can include location information (e.g., URL) of a file or a cache specified by a parameter included in the request. Specifically, the location information of the file or the cache can include a type (route cache, cache storage, long term cache, or short term cache) of storage to which the file or the cache belongs thereto and URL information indicating a location of the file. According to a different embodiment, the Cache Fetch result can include a file or a cache specified by a parameter included in the request.

Referring to the bottom part of FIG. 25, a specific example that an application requests a route_01 file (cache) included in a route cache to a HTTP proxy and the HTTP proxy forwards location information of the route_01 file (cache) to the application in response to the request is illustrated.

A request includes information indicating that a scheme corresponds to Cache Fetch, information indicating that fetch targeting storage corresponds to a route cache, and information on an identifier of the request.

A result includes information indicating that a fetch targeting file (cache) belongs to a route cache and location (URL) information of the fetch targeting file (cache).

Meanwhile, in case of the Cache Fetch scheme, when a fetch targeting file (cache) belongs to storage, the fetch targeting file (cache) may or may not be deleted from the storage or a manifest corresponding to the storage depending on a type of the storage.

For example, when a type of storage to which a fetch targeting file (cache) belongs corresponds to a route cache, if a file (cache) is fetched from the route cache, the fetched file (cache) is stored in cache storage (short term cache or long term cache) (together with manifest recording) and the file (cache) belonging to the route cache is deleted (together with manifest recording)

As a different example, when a type of storage to which a fetch targeting file (cache) belongs corresponds to cache storage (short term cache or long term cache), if a file (cache) is fetched from the cache storage, the fetched file (cache) is maintained in the cache storage (short term cache or long term cache).

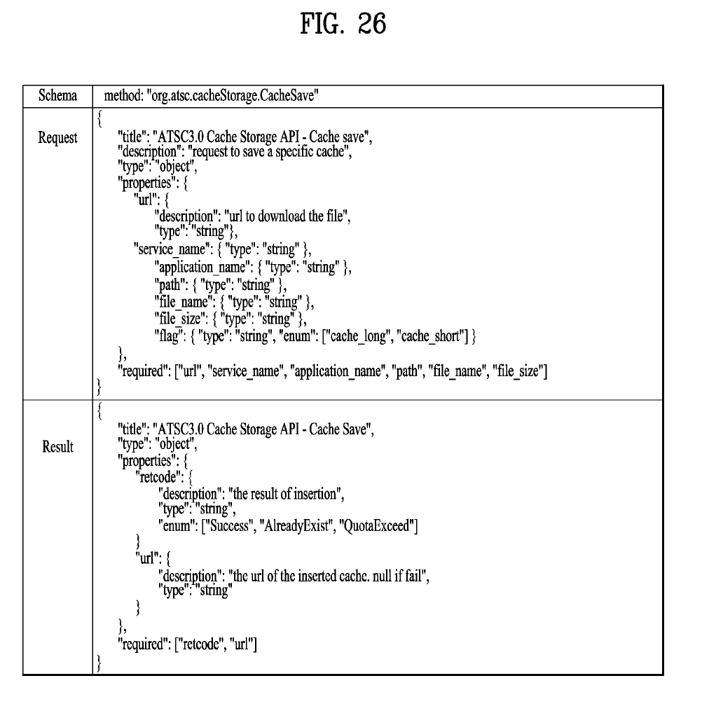

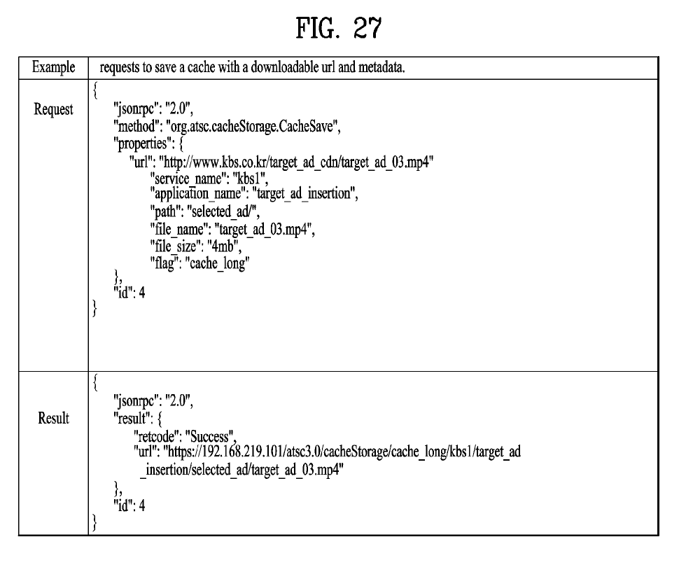

FIG. 26 is a diagram illustrating a Cache Save scheme and FIG. 27 is a diagram illustrating an example of the Cache Save scheme.

Referring to FIGS. 26 and 27, a Cache Save scheme is illustrated in FIG. 26 and a specific example of using the Cache Save scheme is illustrated in FIG. 27.

First of all, referring to FIG. 26, information indicating that a scheme corresponds to Cache Save and explanation on an operation of the Cache Save scheme are illustrated. The Cache Save can be configured by a request and a result. For the request, an application asks a HTTP proxy to store a predetermined cache or file in predetermined storage. For the result, the HTTP proxy can forward information on a location at which the cache or file is stored to the application. The Cache Save request corresponds to a parameter and can include location information (e.g., URL) of a file or cache to be stored, a service name, an application name, a path, a file name, a file size, and information on local storage in which the file or cache is to be stored.

The Cache Save result can include information (e.g., URL) on a location at which a file or cache specified by a parameter included in the request is stored. Specifically, the location information of the file or cache can include URL information indicating a location at which the file or cache is stored. And, the Cache Save result can further include information indicating whether or not the file or cache is successfully stored. According to one embodiment, the information indicating whether or not the file or cache is successfully stored can include “success”, “alreadyexist”, and “QuotaExceed”. In this case, the “success” indicates that the file or the cache has been successfully stored. The “alreadyexist” indicates that the file or the cache has already existed in local storage in which the file or cache is to be stored. The “QuotaExceed” can indicate that it has failed to store the file or the cache due to the excess of capacity.

Referring to FIG. 27, information indicating that an application asks a HTTP proxy to store a target_ad_03.mp3 file (cache) in a long term cache and the HTTP proxy successfully stores the file in the long term cache in response to the request of the application and a specific example of forwarding information on a location at which the target_ad_03.mp3 file (cache) is stored are illustrated.

A request includes information indicating that a scheme corresponds to Cache Save, information on a file to be stored, information on a type of local storage in which the file is to be stored, and information on an identifier of the request.

A result includes information indicating that a file (cache) has been successfully stored and location (URL) information of the stored file (cache).

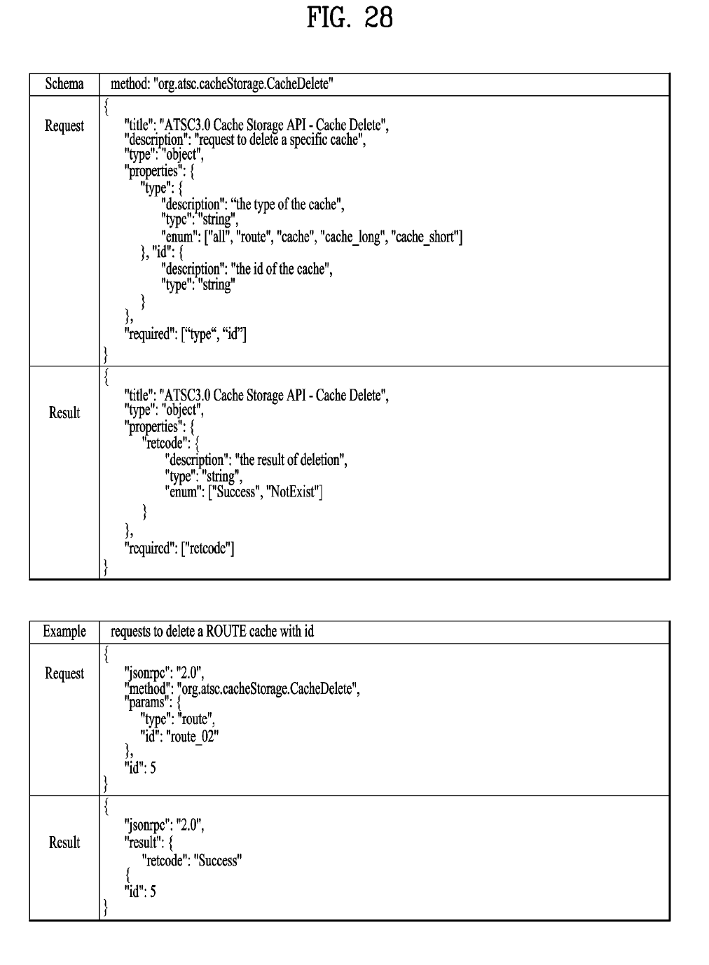

FIG. 28 is a diagram illustrating a Cache Delete scheme and an example.

Referring to FIG. 28, Cache Delete scheme is illustrated on an upper part and detail examples of using the Cache Delete scheme are illustrated on a bottom part.

First of all, referring to the upper part of FIG. 28, information indicating that a scheme corresponds to a Cache Delete scheme and explanation on an operation of the Cache Delete scheme are illustrated. The Cache Delete scheme can be configured by a request and a result. For the request, the application asks the HTTP proxy to delete a predetermined cache or a file from predetermined storage. For the result, the HTTP proxy can forward information on whether or not the cache or the file is deleted to the application. The Cache Delete request corresponds to a parameter and can include information on a type of local storage to which a file or cache to be deleted belongs and identification information of a cache or a file to be deleted. According to one embodiment, a type of a local storage to which a file or a cache to be deleted belongs can include “all”, “route”, “cache”, “cache_long”, and “cache_short”. In this case, “route” corresponds to a ROUTE cache, “cache” corresponds to cache storage, and “cache_long” and “cache_short” may correspond to a long term cache and a short term cache, respectively. And, “all” may correspond to all local caches included in a receiver.

The Cache Delete result can include information indicating whether or not a file or a cache specified by a parameter included in the request is successfully deleted. According to one embodiment, the information indicating whether or not a file of a cache is successfully deleted can include “success” and “NotExist”. In this case, “success” indicates that a file or a cache is successfully deleted and “NotExist” indicates that a file or a cache is not deleted because the file or the cache does not exist in the local storage.

Referring to the bottom part of FIG. 28, a specific example that an application asks a HTTP proxy to delete a route_02 corresponding to a file (cache) included in a route cache and the HTTP proxy forwards information indicating that the file (cache) is successfully deleted to the application in response to the request is illustrated.

A request includes information indicating that a scheme corresponds to Cache Delete, information on a type of local storage including a file to be deleted, identification information identifying a file to be deleted, and information on an identifier of the request.

A result includes information indicating that a file (cache) to be deleted is successfully deleted.

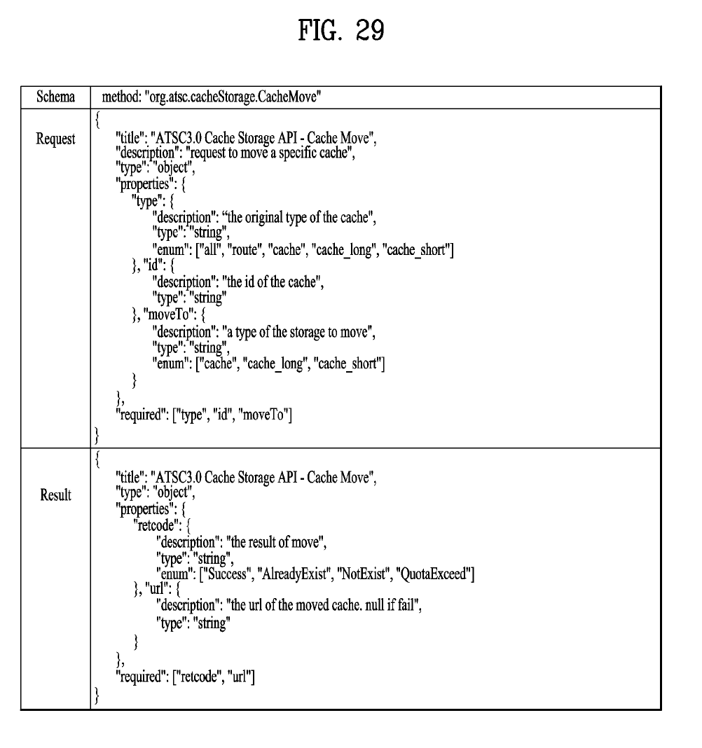

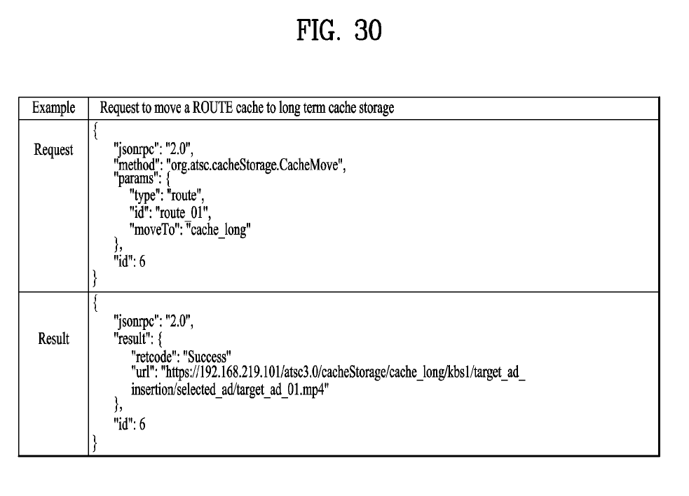

FIG. 29 is a diagram illustrating a Cache Move scheme and FIG. 30 is a diagram illustrating an example of the Cache Move scheme.

Referring to FIGS. 29 and 30, a Cache Move scheme is illustrated in FIG. 29 and a specific example of using the Cache Move scheme is illustrated in FIG. 30.

First of all, referring to FIG. 29, information indicating that a scheme corresponds to Cache Move and explanation on an operation of the Cache Move scheme are illustrated. The Cache Move can be configured by a request and a result. For the request, an application asks a HTTP proxy to move a predetermined cache or file. For the result, the HTTP proxy can forward information indicating that the cache or the file is successfully moved and information on a location of the moved cache or file to the application. The Cache move request corresponds to a parameter and can include type information of storage (original storage) to which a file or cache to be moved belongs, identification information of the cache or the file belonging to the storage, and type information of a target storage to move. According to one embodiment, a type of storage to which a file or a cache to be moved belongs can include “all”, “route”, “cache”, “cache_long”, and “cache_short”. In this case, “route” means that a file or a cache to be moved belongs to a ROUTE cache, “cache” means that a file or a cache to be moved belongs to cache storage, and “cache_long” and “cache_short” may mean that a file or a cache to be moved belongs to a long term cache and a short term cache, respectively. And, “all” may mean that a file or a cache to be moved belongs to a local cache included in a receiver. Meanwhile, according to one embodiment, the type information of the target storage can include “cache”, “cache_long”, and “cache_short”. In this case, “cache” means that a file or a cache to be moved is going to be moved to cache storage. “cache_long” and “cache_short” mean that a file or a cache to be moved is going to be moved to a long term cache and a short term cache, respectively.

The Cache Move result can include information (e.g., URL) on a location at which a file or cache specified by a parameter included in the request is stored. Specifically, the location information of the file or cache can include URL information indicating a location at which the file or cache is stored. And, the Cache Move result can further include information indicating whether or not the file or cache is successfully moved. According to one embodiment, the information indicating whether or not the file or cache is successfully moved can include “success”, “alreadyexist”, and “QuotaExceed”. In this case, the “success” indicates that the file or the cache has been successfully moved. The “alreadyexist” indicates that the file or the cache has already existed in local storage to which the file or cache is going to be moved. The “QuotaExceed” can indicate that it has failed to move the file or the cache due to the excess of capacity of the target storage.

Referring to FIG. 30, information indicating that an application asks a HTTP proxy to move a route_01 file (cache) included in a route cache to a long term cache and the HTTP proxy successfully moves the file to the long term cache in response to the request of the application and a specific example of forwarding information on a location at which the route_01 file (cache) is stored are illustrated.

A request includes information indicating that a scheme corresponds to Cache move, information indicating that original storage corresponds to a route cache, information indicating that a file (cache) to be moved corresponds to route_01, information indicating that target storage corresponds to a long term cache, and information on an identifier of the request.

A result includes information indicating that a file (cache) has been successfully moved and location (URL) information of the moved file (cache).

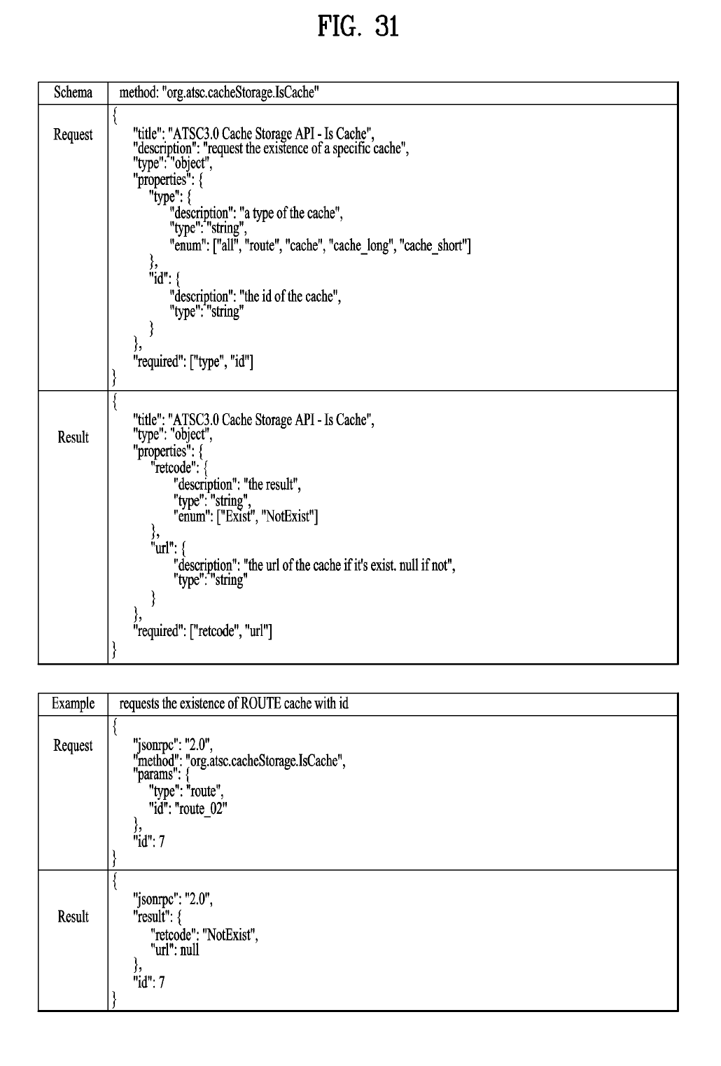

FIG. 31 is a diagram illustrating an Is Cache scheme and an example.

Referring to FIG. 31, Is Cache scheme is illustrated on an upper part and a detail example of using the Is Cache is illustrated in a bottom part.

First of all, referring to the upper part of FIG. 31, information indicating that a scheme corresponds to Is Cache and explanation on an operation of the Is Cache scheme are illustrated. The Is Cache can be configured by a request and a result. For the request, the application asks the HTTP proxy to provide information on whether or not a file (cache) exists. For the result, the HTTP proxy can provide the application with the information on whether or not the file (cache) exists. The Is Cache request corresponds to a parameter and can include type information of storage and identification information for identifying a file or a cache. According to one embodiment, a type of storage can include “all”, “route”, “cache”, “cache_long”, and “cache_short”. In this case, “route” corresponds to a ROUTE cache, “cache” corresponds to cache storage, and “cache_long” and “cache_short” may correspond to a long term cache and a short term cache, respectively. And, “all” may correspond to all local caches included in a receiver.

The Is Cache result corresponds to a parameter and can include information indicating whether or not a cache or a file exists. According to one embodiment, the information indicating whether or not the file or the cache exists can include “Exist” and “NotExist”. In this case, “Exist” indicates that a file or a cache exists in corresponding storage and “NotExist” can indicate that a file or a cache does not exist in the storage.

When a corresponding cache or a file exists, the Is Cache result can include information (e.g., URL) on a location at which the cache or the file is stored. Specifically, the location information of the file or the cache can include URL information indicating the location at which the file or the cache is stored.

Referring to the bottom part of FIG. 31, a specific example that an application requests information on whether or not a route_02 file (cache) belonging to a route cache exists to a HTTP proxy and the HTTP proxy forwards information indicating that the route_02 file (cache) does not exist in the route cache to the application in response to the request is illustrated.

A request includes information indicating that a scheme corresponds to Is Cache, a parameter indicating whether or not a route_02 file (cache) exists in a route cache, and information on an identifier of the request.

A result includes information indicating that a route_02 file (cache) does not exist in a route cache of a receiver.

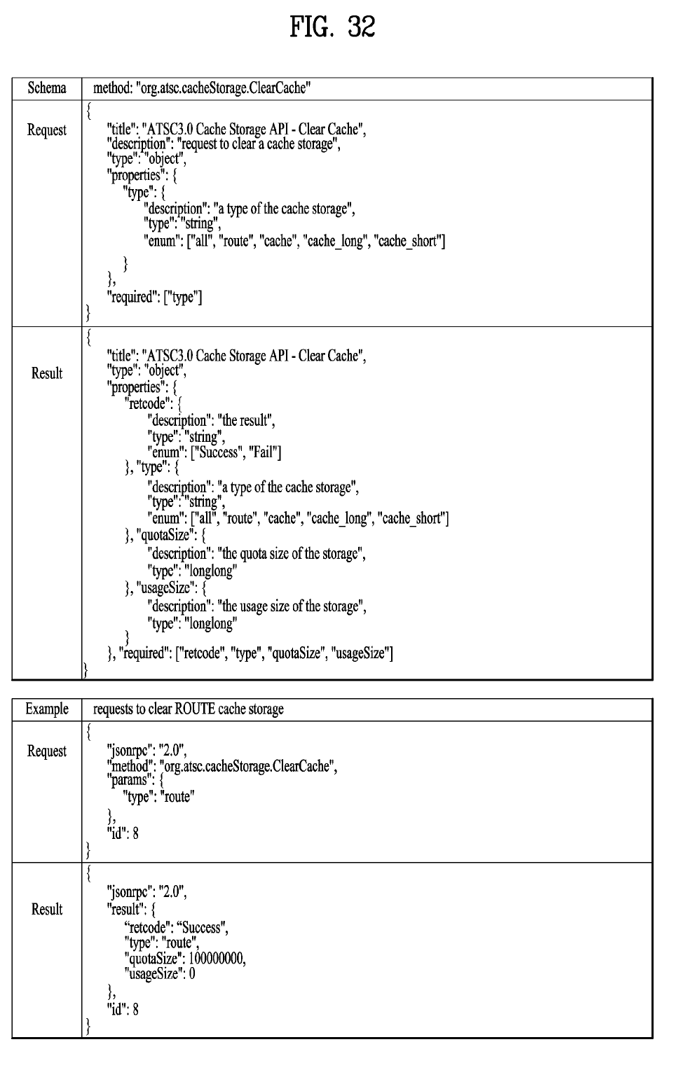

FIG. 32 is a diagram illustrating a Cache clear scheme and an example.

Referring to FIG. 32, Cache Clear scheme is illustrated on an upper part and a detail example of using the Cache Clear is illustrated in a bottom part.

First of all, referring to the upper part of FIG. 32, information indicating that a scheme corresponds to Cache Clear and explanation on an operation of the Cache Clear scheme are illustrated. The Cache Clear can be configured by a request and a result. For the request, an application asks a HTTP proxy to clear predetermined storage. For the result, the HTTP proxy can provide the application with information on whether or not the storage is cleared. In this case, clearing storage may correspond to deleting all files or caches included in the storage.

The Cache Clear request corresponds to a parameter and can include type information of storage to be cleared. According to one embodiment, a type of storage to be cleared can include “all”, “route”, “cache”, “cache_long”, and “cache_short”. In this case, “route” corresponds to a case of clearing a ROUTE cache, “cache” corresponds to a case of clearing cache storage, and “cache_long” and “cache_short” may correspond to a case of clearing a long term cache and a case of clearing a short term cache, respectively. And, “all” may correspond to a case of clearing all local caches included in a receiver.

The Cache clear result can include information indicating that storage specified by a parameter included in the request is successfully cleared. According to one embodiment, information indicating whether or not a file or a cache is successfully deleted can include “success” and “fail”. In this case, “success” indicates that the storage has been successfully cleared and “fail” can indicate that the storage is not cleared.

The Cache clear result can include type information and status information of storage specified by a parameter included in the request. Specifically, the status information of the storage can include total capacity, used capacity, and the residual capacity of the storage. When a clear operation is successfully performed on the storage (“success”), the used capacity may become 0 and the residual capacity may become identical to the total capacity. On the other hand, when it fails to perform a clear operation on the storage (“fail”), the status information can indicate the used capacity or the residual capacity of the storage only.

Referring to the bottom part of FIG. 32, a specific example that an application indicates a HTTP proxy to clear a route cache and the HTTP proxy forwards information indicating that the route cache is successfully deleted to the application in response to the request is illustrated.

A request includes information indicating that a scheme corresponds to Cache Clear, information on a type of storage to be cleared, and information on an identifier of the request.

A result includes information indicating that a route cache corresponding to the storage to be cleared has been successfully cleared and status information (total capacity and used capacity) of the route storage.

In the following, a scenario using the aforementioned API scheme is explained in detail.

First of all, a scenario of storing a file transmitted via a broadcast network in a route cache and configuring a route cache manifest is explained.

Storing a File Transmitted Via a Broadcast Network in a Route Cache and Configuring a Route Cache Manifest

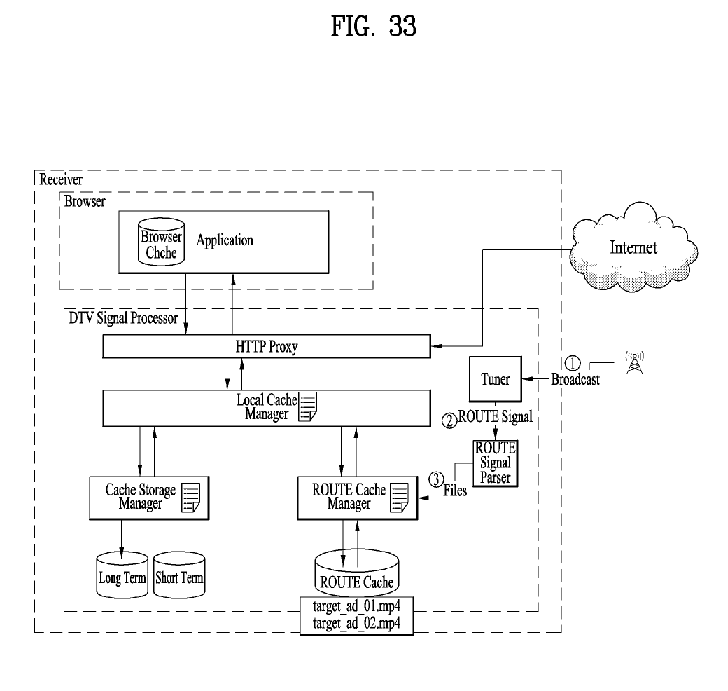

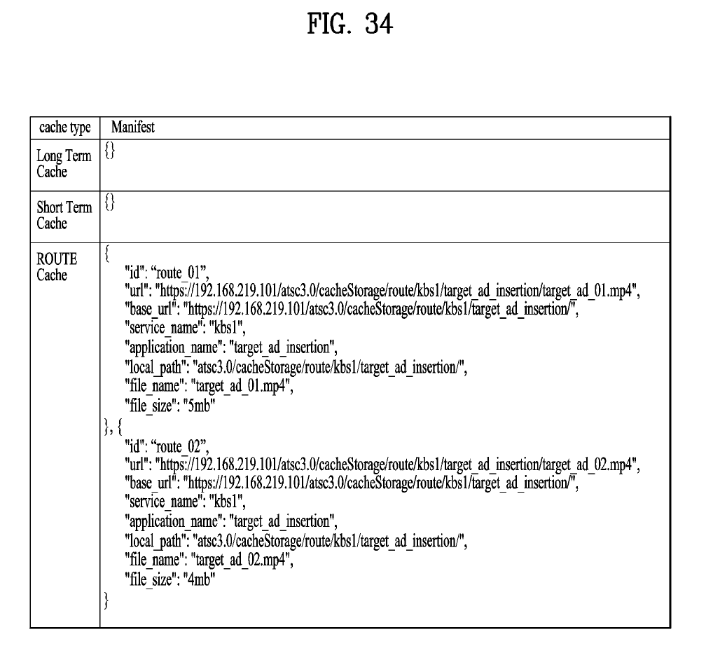

FIG. 33 is a diagram illustrating an operation of a receiver according to one embodiment of the present invention and FIG. 34 is a diagram illustrating a manifest configured according to the operation of the receiver illustrated in FIG. 33.

In FIG. 33, a procedure of storing a file transmitted via a broadcast network and a procedure of configuring a route cache manifest are sequentially illustrated.

First of all, a tuner receives a broadcast signal transmitted via a broadcast network (step 1). The tuner forwards the broadcast signal to a ROUTE signal parser. In this case, the broadcast signal includes a ROUTE signal.

Subsequently, the ROUTE signal parser receives a ROUTE signal (step 2). The ROUTE signal parser extracts files from the ROUTE signal.

The ROUTE signal parser forwards the extracted files to a ROUTE cache manager (step 3).

Subsequently, the ROUTE cache manager stores the files received from the ROUTE signal parser in a ROUTE cache and records information on the files on a manifest. In the embodiment illustrated in FIG. 33, the files stored in the ROUTE cache correspond to target_ad01.mp4 and target_ad_02.mp4.

The ROUTE cache manager records the information on the files stored in the ROUTE cache on a route cache manifest. The information recorded on the route cache manifest corresponds to information on the target_ad01.mp4 file and information on the target_ad_02.mp4 file. The ROUTE cache manager records identification information on each file, URL information, Base URL information, a service name, an application name, local path information, a file name, and file size information on the route cache manifest.

FIG. 34 illustrates the route cache manifest on which the information on the target_ad01.mp4 file and the information on the target_ad_02.mp4 file are recorded.

The information on the target_ad01.mp4 file recorded on the route cache manifest includes identification information (route_01) on the file, URL information of the file, Base URL information of the file, a service name (kbs1) related to the file, an application name (target_ad_insertion) related to the file, a local path (atsc3.0/cacheStorage/route/kbs1/target_ad_insertion/) of the file, a name of the file (target_ad_01.mp4), and a size (5 mb) of the file.

Similarly, the information on the target_ad02.mp4 file recorded on the route cache manifest includes identification information (route_02) on the file, URL information of the file, Base URL information of the file, a service name (kbs1) related to the file, an application name (target_ad_insertion) related to the file, a local path (atsc3.0/cacheStorage/route/kbs1/target_ad_insertion/) of the file, a name of the file (target_ad_02.mp4), and a size (4 mb) of the file.

Subsequently, a scenario of storing a file stored in the route cache in cache storage and configuring a relevant manifest is explained.

Storing a File Stored in a Route Cache in Cache Storage and Configuring a Relevant Manifest

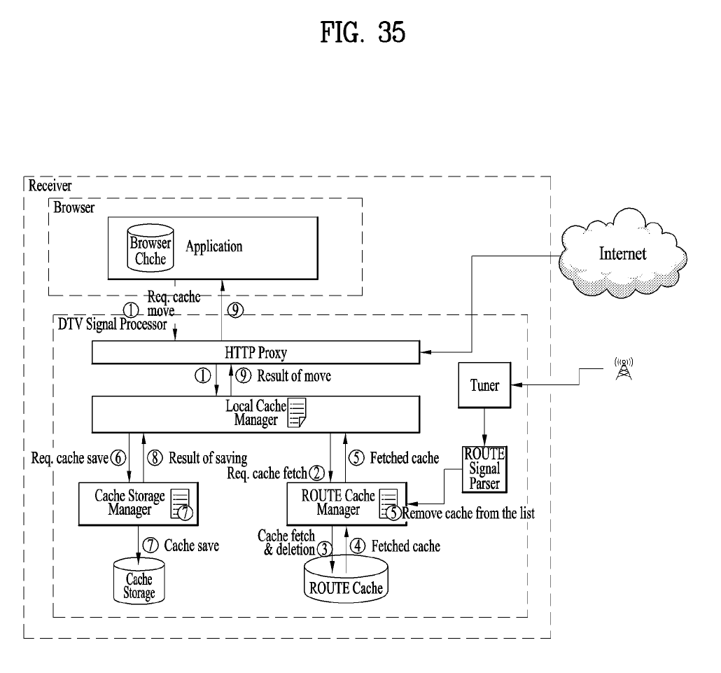

FIG. 35 is a diagram illustrating an operation of a receiver according to a different embodiment of the present invention.

The operation illustrated in FIG. 35 may correspond to an operation to be performed after the operation of the receiver illustrated in FIG. 33. Meanwhile, the cache storage of the receiver shown in FIG. 33 is divided into a long term cache and a short term cache, whereas the cache storage of the receiver shown in FIG. 35 is not divided into the long term cache and the short term cache.

In FIG. 35, a procedure of storing a file stored in a route cache in cache storage and a procedure of configuring a manifest are sequentially illustrated.

A connection is established between an application and a HTTP proxy via a websocket. The application can move a file stored in a route cache to cache storage using the aforementioned API scheme. In order to move the file stored in the route cache to the cache storage, the application can use the aforementioned Cache Move scheme.

When the application forwards a request to the HTTP proxy, the request can be represented as follows.

{
“jsonrpc”: “2.0”,
“method”: “org.atsc.cacheStorage.CacheMove”,
“params”: {
“type”: “route”,
“id”: “route_01”,
“moveTo”: “cache”
},
“id”: 6
}

The request corresponds to a request (“moveTo”: “cache”) for moving a file (“id”: “route_01”) having identification information of (“type”: “route”), route_01 stored in the route cache to the cache storage.

The application forwards the request to the HTTP proxy (step 1) and the HTTP proxy forwards the request to the local cache manager (step 1).

Subsequently, the local cache manager asks the route cache manager to extract “route_01” (step 2).

Subsequently, the route cache manager extracts the “route_01” from the route cache storage and deletes the “route_01” stored in the route cache storage (step 3, step 4).

Subsequently, the route cache manager forwards the “route_01” extracted from the route cache storage to the local cache manager and deletes information related to the “route_01” from a route cache manifest (step 5).

Subsequently, the local cache manager forwards the “route_01” received from the route cache manager to the cache storage manager (step 6).

Subsequently, the cache storage manager stores the “route_01” received from the route cache manager in the cache storage and records information related to the “route_01” on the cache storage manifest (step 7).

Subsequently, the cache storage manager forwards information indicating that the “route_01” has been successfully stored in the cache storage to the local cache manager (step 8).

Subsequently, the local cache manager forwards the information indicating that the “route_01” has been successfully stored in the cache storage to the HTTP proxy (step 9) and the HTTP proxy forwards a result for the Cache Move to the application.

The result forwarded to the application by the HTTP proxy can be represented as follows.

{
“jsonrpc”: “2.0”,
“result”: {
“retcode”: “Success”,
“url”:
https://192.168.219.101/atsc3.0/cacheStorage/cache/kbs1/target_ad_ins

ertion/selected_ad/target_ad_01. mp4”

},
“id”: 6
}

The result can indicate that the movement has been successfully performed and location information (URL) of the moved file (route_01, target_ad_01.mp4) corresponds to https://192.168.219.101/atsc3.0/cacheStorage/cache/kbs1/target_ad_insertion/selected_a d/target_ad_01.mp4.

The operations described in FIG. 35 correspond to a series of procedures that move a file (cache) stored in the ROUTE cache to the cache storage. Since a file transmitted via a broadcast network is stored in the ROUTE cache, in order for the application to access the file, it is necessary to move the file to storage capable of being accessed by the application. Since the application is able to access the cache storage, the application may move a file stored in the ROUTE cache to the cache storage in advance.

In the following, a scenario of storing a file stored in a route cache in a short term cache and configuring a relevant manifest is explained.

Storing a File Stored in a Route Cache in a Short Term Cache and Configuring a Relevant Manifest

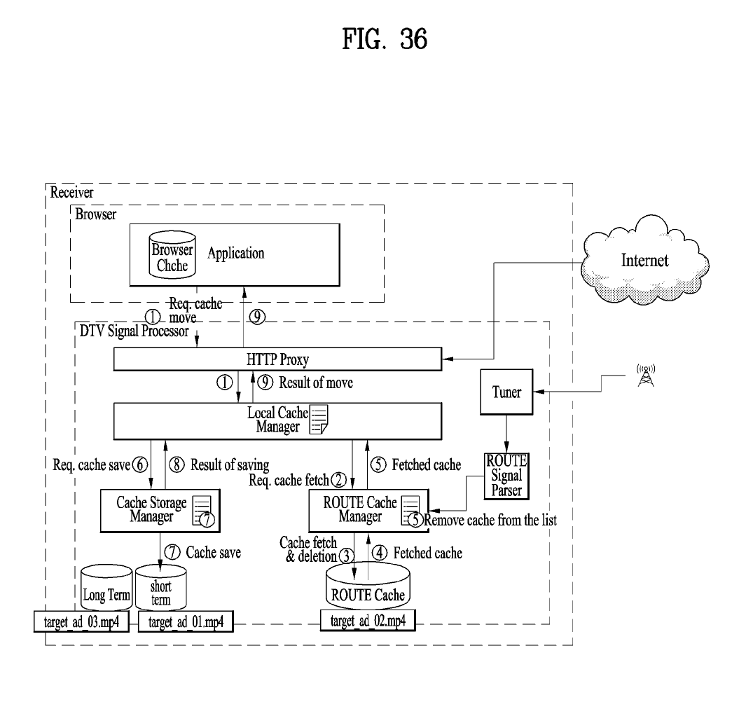

FIG. 36 is a diagram illustrating an operation of a receiver according to a further different embodiment of the present invention.

The operation illustrated in FIG. 36 may correspond to an operation to be performed after the operation of the receiver illustrated in FIG. 33 and may correspond to an operation corresponding to the operation of the receiver shown in FIG. 35. Meanwhile, the cache storage of the receiver shown in FIG. 36 is divided into a long term cache and a short term cache, whereas the cache storage of the receiver shown in FIG. 35 is not divided into the long term cache and the short term cache.

As mentioned in the foregoing description, a connection is established between an application and a HTTP proxy via a websocket. The application can move a file stored in a route cache to a short term cache using the aforementioned API scheme. In order to move the file stored in the route cache to the short term cache, the application can use the aforementioned Cache Move scheme.

When the application forwards a request to the HTTP proxy, the request can be represented as follows.

{
“jsonrpc”: “2.0”,
“method”: “org.atsc.cacheStorage.CacheMove”,
“params”: {
“type”: “route”,
“id”: “route_01”,
“moveTo”: “cache_short”
},
“id”: 6
}

The request corresponds to a request (“moveTo”: “cache_short”) for moving a file (“id”: “route_01”) having identification information of (“type”: “route”), route_01 stored in the route cache to the short term cache.

The application forwards the request to the HTTP proxy (step 1) and the HTTP proxy forwards the request to the local cache manager (step 1).

Subsequently, the local cache manager asks the route cache manager to extract “route_01” (step 2).

Subsequently, the route cache manager extracts the “route_01” from the route cache storage and deletes the “route_01” stored in the route cache storage (step 3, step 4).

Subsequently, the route cache manager forwards the “route_01” extracted from the route cache storage to the local cache manager and deletes information related to the “route_01” from a route cache manifest (step 5).

Subsequently, the local cache manager forwards the “route_01” received from the route cache manager to the cache storage manager (step 6).

Subsequently, the cache storage manager stores the “route_01” received from the route cache manager in the short term cache and records information related to the “route_01” on the cache storage manifest (step 7).

Subsequently, the cache storage manager forwards information indicating that the “route_01” has been successfully stored in the short term cache to the local cache manager (step 8).

Subsequently, the local cache manager forwards the information indicating that the “route_01” has been successfully stored in the short term cache to the HTTP proxy (step 9) and the HTTP proxy forwards a result for the Cache Move to the application.

The result forwarded to the application by the HTTP proxy can be represented as follows.

{
“jsonrpc”: “2.0”,
“result”: {
“retcode”: “Success”,
“url”:
“https://192.168.219.101/atsc3.0/cacheStorage/cache_short/kbs1/target

_ad_insertion/selected_ad/target_ad_01.mp4”

},
“id”: 6
}

The result can indicate that the movement has been successfully performed and location information (URL) of the moved file (route_01, target_ad_01.mp4) corresponds to “https://192.168.219.101/atsc3.0/cacheStorage/cache_short/kbs1/target_ad_insertion/sel ected_ad/target_ad_01.mp4”.

The operations described in FIG. 36 correspond to a series of procedures that move a file (cache) stored in the ROUTE cache to the short term cache. Since a file transmitted via a broadcast network is stored in the ROUTE cache, in order for the application to access the file, it is necessary to move the file to storage capable of being accessed by the application. Since the application is able to access the cache storage, the application may move a file stored in the ROUTE cache to the cache storage in advance. In this case, the application can determine whether the file is to be stored in short term or long term based on usage of the file.

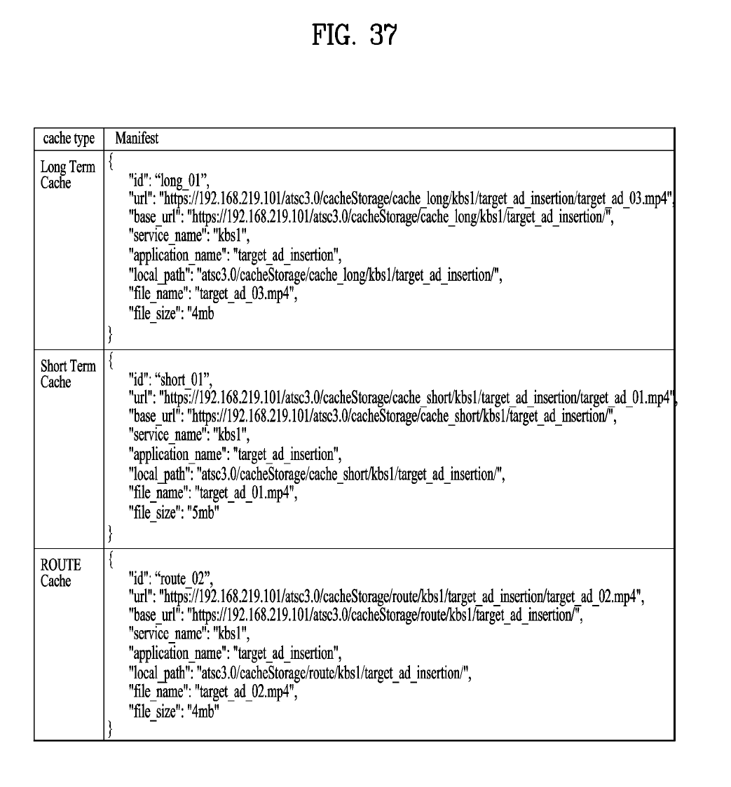

FIG. 37 is a diagram illustrating a manifest configured according to an operation of a receiver illustrated in FIG. 36.

FIG. 37 illustrates a configuration of a manifest after a “target_ad_01.mp4” file is moved to a short term cache by completing an operation of FIG. 36 in a state that a “target_ad_02.mp4” file is stored in a ROUTE cache and a “target_ad_03.mp4” file is stored in a long term cache.

First of all, a manifest for the long term cache includes information on the “target_ad_03.mp4” file stored in the long term cache.

Specifically, the information on the “target_ad_03.mp4” file recorded on the long term cache manifest includes identification information (long_01) on the file, URL information of the file, Base URL information of the file, a service name (kbs1) related to the file, an application name (target_ad_insertion) related to the file, a local path (atsc3.0/cacheStorage/cache_long/kbs1/target_ad_insertion/) of the file, a name (target_ad_03.mp4) of the file, and a size (4 mb) of the file.

Subsequently, a manifest for the short term cache includes information on the “target_ad_01.mp4” file stored in the short term cache.

Specifically, the information on the “target_ad_01.mp4” file recorded on the short term cache manifest includes identification information (short_01) on the file, URL information of the file, Base URL information of the file, a service name (kbs1) related to the file, an application name (target_ad_insertion) related to the file, a local path (atsc3.0/cacheStorage/cache_short/kbs1/target_ad_insertion/) of the file, a name (target_ad_01.mp4) of the file, and a size (5 mb) of the file.

Subsequently, a manifest for the ROUTE cache includes information on the “target_ad_02.mp4” file stored in the ROUTE cache.

Specifically, the information on the “target_ad_02.mp4” file recorded on the ROUTE cache manifest includes identification information (route_02) on the file, URL information of the file, Base URL information of the file, a service name (kbs1) related to the file, an application name (target_ad_insertion) related to the file, a local path (atsc3.0/cacheStorage/route/kbs1/target_ad_insertion/) of the file, a name (target_ad_02.mp4) of the file, and a size (4 mb) of the file.

In the following, a scenario of storing a file stored in the route cache in the long term cache and configuring a relevant manifest is explained.

Storing a File Stored in the Route Cache in the Long Term Cache and Configuring a Relevant Manifest

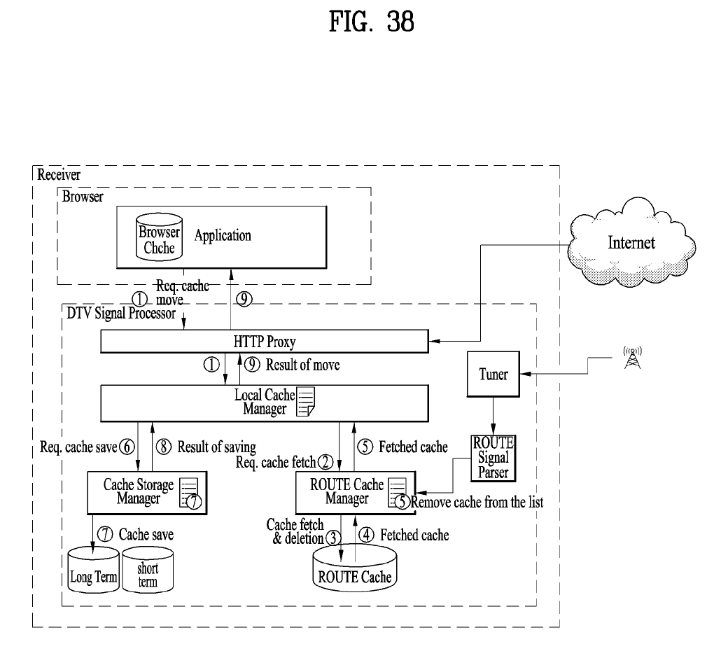

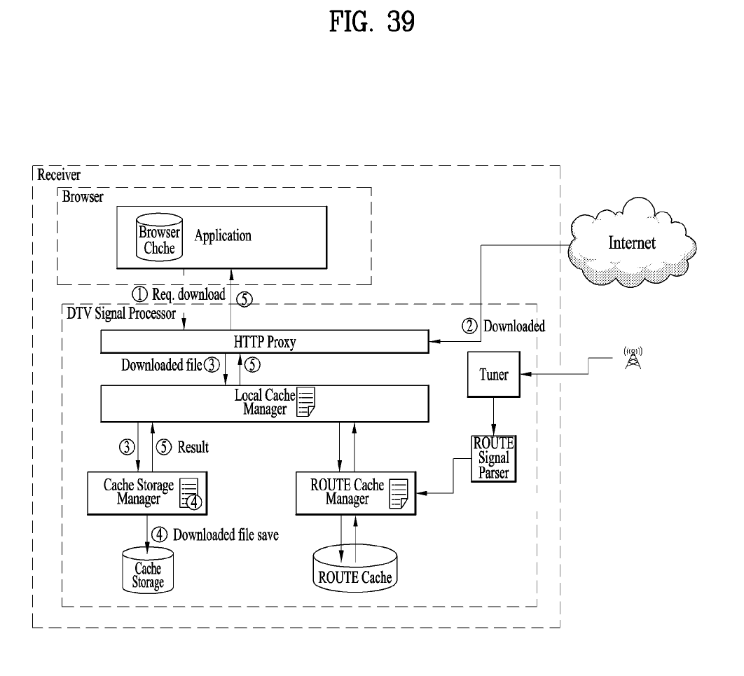

FIG. 38 is a diagram illustrating an operation of a receiver according to a further different embodiment of the present invention.

The operation illustrated in FIG. 38 may correspond to an operation to be performed after the operation of the receiver illustrated in FIG. 33 and may correspond to an operation corresponding to the operation of the receiver shown in FIG. 35. Meanwhile, the cache storage of the receiver shown in FIG. 38 is divided into a long term cache and a short term cache, whereas the cache storage of the receiver shown in FIG. 35 is not divided into the long term cache and the short term cache.

As mentioned in the foregoing description, a connection is established between an application and a HTTP proxy via a websocket. The application can move a file stored in a route cache to a long term cache using the aforementioned API scheme. In order to move the file stored in the route cache to the long term cache, the application can use the aforementioned Cache Move scheme.

When the application forwards a request to the HTTP proxy, the request can be represented as follows.

{
“jsonrpc”: “2.0”,
“method”: “org.atsc.cacheStorage.CacheMove”,
“params”: {
“type”: “route”,
“id”: “route_01”,
“moveTo”: “cache_long”
},
“id”: 6
}

The request corresponds to a request (“moveTo”: “cache_long”) for moving a file (“id”: “route_01”) having identification information of (“type”: “route”), route_01 stored in the route cache to the long term cache.

The application forwards the request to the HTTP proxy (step 1) and the HTTP proxy forwards the request to the local cache manager (step 1).

Subsequently, the local cache manager asks the route cache manager to extract “route_01” (step 2).

Subsequently, the route cache manager extracts the “route_01” from the route cache storage and deletes the “route_01” stored in the route cache storage (step 3, step 4).

Subsequently, the route cache manager forwards the “route_01” extracted from the route cache storage to the local cache manager and deletes information related to the “route_01” from a route cache manifest (step 5).

Subsequently, the local cache manager forwards the “route_01” received from the route cache manager to the cache storage manager (step 6).

Subsequently, the cache storage manager stores the “route_01” received from the route cache manager in the long term cache and records information related to the “route_01” on the cache storage manifest (step 7).

Subsequently, the cache storage manager forwards information indicating that the “route_01” has been successfully stored in the long term cache to the local cache manager (step 8).

Subsequently, the local cache manager forwards the information indicating that the “route_01” has been successfully stored in the long term cache to the HTTP proxy (step 9) and the HTTP proxy forwards a result for the Cache Move to the application.

The result forwarded to the application by the HTTP proxy can be represented as follows.

{
“jsonrpc”: “2.0”,
“result”: {
“retcode”: “Success”,
“url”:
“https://192.168.219.101/atsc3.0/cacheStorage/cache_long/kbs1/target_

ad_insertion/selected_ad/target_ad_01.mp4”

},
“id”: 6
}

The result can indicate that the movement has been successfully performed and location information (URL) of the moved file (route_01, target_ad_01.mp4) corresponds to “https://192.168.219.101/atsc3.0/cacheStorage/cache_long/kbs1/target_ad_insertion/sele cted_ad/target_ad_01.mp4”.

The operations described in FIG. 38 correspond to a series of procedures that move a file (cache) stored in the ROUTE cache to the long term cache. Since a file transmitted via a broadcast network is stored in the ROUTE cache, in order for the application to access the file, it is necessary to move the file to storage capable of being accessed by the application. Since the application is able to access the cache storage, the application may move a file stored in the ROUTE cache to the cache storage in advance. In this case, the application can determine whether the file is to be stored in short term or long term based on usage of the file.

In the following, a scenario for storing a broadband resource in a local cache is explained.

First of all, a scenario of storing a broadband resource in cache storage upon the request of an application and configuring a relevant manifest is explained.

Storing a Broadband Resource in Cache Storage and Configuring a Relevant Manifest

FIG. 39 is a diagram illustrating an operation of a receiver according to a further different embodiment of the present invention.

Referring to FIG. 39, a series of procedures for downloading a desired file and storing the file in the cache storage upon the request of an application are illustrated.

As mentioned in the foregoing description, a connection is established between an application and a HTTP proxy via a websocket. The application can store a broadband resource in the cache storage using the aforementioned API scheme. The application can directly store a downloaded broadband resource in the cache storage without passing through a browser cache. By doing so, it is able to omit a procedure of storing a resource in the browser cache and comprehensively manage the broadband resource via the local cache.

When the application forwards a request to the HTTP proxy, the request can be represented as follows.

{
“jsonrpc”: “2.0”,
“method”: “org.atsc.cacheStorage.CacheSave”,
“params”: {
“url”:“http://www.kbs.co.kr/target_ad_cdn/target_ad_03.mp4”,
“service_name”: “kbs1”,
“application_name”: “target_ad_insertion”,
“path”: “selected_ad/”,
“file_name”: “target_ad_03.mp4”,
“file_size”: “4mb”,
“flag”: “cache”
},
“id”: 4
}

The request corresponds to a request for storing a file (target_ad_03.mp4) corresponding to a broadband resource in the cache storage.

The application forwards the request to the HTTP proxy (step 1).

Subsequently, the HTTP proxy downloads the file using a URL (Internet URL) included in the request (step 2).

Subsequently, the HTTP proxy forwards the downloaded file to the local cache manager and the local cache manager forwards the downloaded file to the cache storage manager (step 3).

Subsequently, the cache storage manager stores the file in the cache storage and records information related to the file on the cache storage manifest (step 4).

Subsequently, the cache storage manager forwards information indicating that the file has been successfully stored in the cache storage to the local cache manager (step 5), the local cache manager forwards the information to the HTTP proxy, and the HTTP proxy forwards a result for the Cache Save to the application (step 5).

The result forwarded to the application by the HTTP proxy can be represented as follows.

{
“jsonrpc”: “2.0”,
“result”: {
“retcode”: “Success”,
“url”:
“https://192.168.219.101/atsc3.0/cacheStorage/cache_long/kbs1/target_

ad_insertion/selected_ad/target_ad_03.mp4”

},
“id”: 4
}

In the following, a scenario of storing a broadband resource in a short term cache upon the request of an application and configuring a relevant manifest is explained.

Storing a Broadband Resource in a Short Term Cache and Configuring a Relevant Manifest

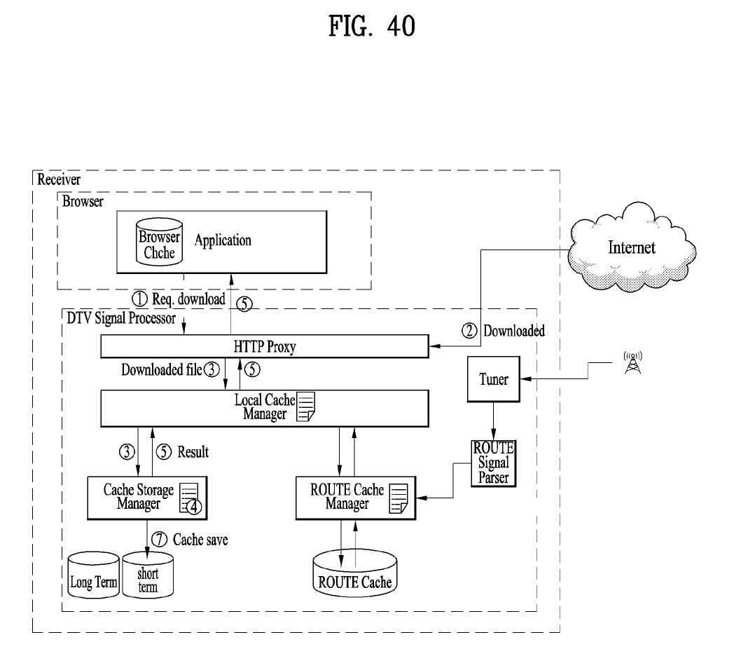

FIG. 40 is a diagram illustrating an operation of a receiver according to a further different embodiment of the present invention.

Referring to FIG. 40, a series of procedures for downloading a desired file and storing the file in the short term cache upon the request of an application are illustrated. Meanwhile, cache storage of a receiver shown in FIG. 40 is divided into a long term cache and a short term cache, whereas cache storage of a receiver shown in FIG. 39 is not divided into the long term cache and the short term cache.

As mentioned in the foregoing description, a connection is established between an application and a HTTP proxy via a websocket. The application can store a broadband resource in the short term cache using the aforementioned API scheme. The application can directly store a downloaded broadband resource in the short term cache without passing through a browser cache. By doing so, it is able to omit a procedure of storing a resource in the browser cache and comprehensively manage the broadband resource via the local cache.

When the application forwards a request to the HTTP proxy, the request can be represented as follows.

{
“jsonrpc”: “2.0”,
“method”: “org.atsc.cacheStorage.CacheSave”,
“params”: {
“url”:“http://www.kbs.co.kr/target_ad_cdn/target_ad_03.mp4”,
“service_name”: “kbs1”,
“application_name”: “target_ad_insertion”,
“path”: “selected_ad/”,
“file_name”: “target_ad_03.mp4”,
“file_size”: “4mb”,
“flag”: “cache_short”
},
“id”: 4
}

The request corresponds to a request for storing a file (target_ad_03.mp4) corresponding to a broadband resource in the short term cache.

The application forwards the request to the HTTP proxy (step 1).

Subsequently, the HTTP proxy downloads the file using a URL (Internet URL) included in the request (step 2).

Subsequently, the HTTP proxy forwards the downloaded file to the local cache manager and the local cache manager forwards the downloaded file to the cache storage manager (step 3).

Subsequently, the cache storage manager stores the file in the short term cache and records information related to the file on the cache storage manifest (step 4).

Subsequently, the cache storage manager forwards information indicating that the file has been successfully stored in the short term cache to the local cache manager (step 5), the local cache manager forwards the information to the HTTP proxy, and the HTTP proxy forwards a result for the Cache Save to the application (step 5).

The result forwarded to the application by the HTTP proxy can be represented as follows.

{
“jsonrpc”: “2.0”,
“result”: {
“retcode”: “Success”,
“url”:
“https://192.168.219.101/atsc3.0/cacheStorage/cache_short/kbs1/target

_ad_insertion/selected_ad/target_ad_03.mp4”

},
“id”: 4
}

In the following, a scenario of storing a broadband resource in a long term cache upon the request of an application and configuring a relevant manifest is explained.

Storing a Broadband Resource in a Long Term Cache and Configuring a Relevant Manifest

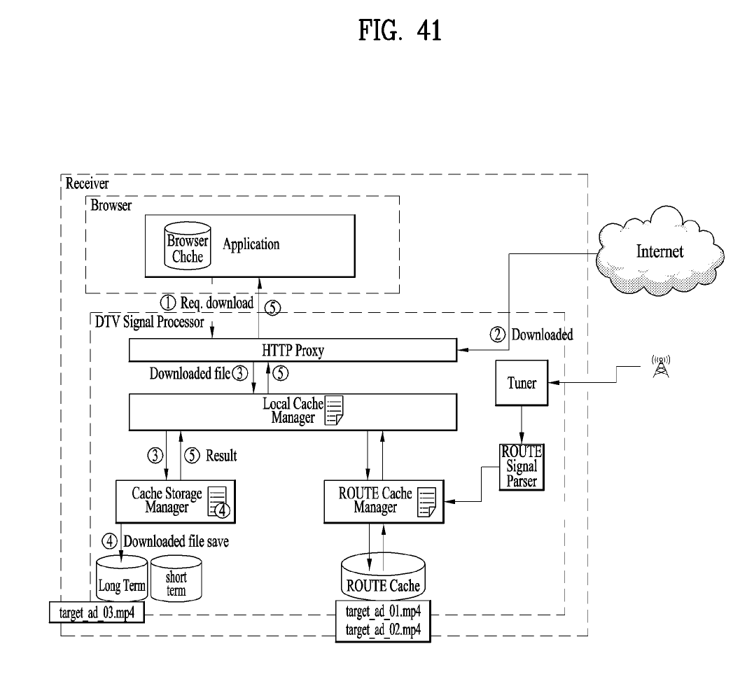

FIG. 41 is a diagram illustrating an operation of a receiver according to a further different embodiment of the present invention.

Referring to FIG. 41, a series of procedures for downloading a desired file and storing the file in the long term cache upon the request of an application are illustrated. Meanwhile, cache storage of a receiver shown in FIG. 41 is divided into a long term cache and a short term cache, whereas cache storage of a receiver shown in FIG. 39 is not divided into the long term cache and the short term cache.

As mentioned in the foregoing description, a connection is established between an application and a HTTP proxy via a websocket. The application can store a broadband resource in the long term cache using the aforementioned API scheme. The application can directly store a downloaded broadband resource in the long term cache without passing through a browser cache. By doing so, it is able to omit a procedure of storing a resource in the browser cache and comprehensively manage the broadband resource via the local cache.

When the application forwards a request to the HTTP proxy, the request can be represented as follows.

{
“jsonrpc”: “2.0”,
“method”: “org.atsc.cacheStorage.CacheSave”,
“params”: {
“url”:“http://www.kbs.co.kr/target_ad_cdn/target_ad_03.mp4”,
“service_name”: “kbs1”,
“application_name”: “target_ad_insertion”,
“path”: “selected_ad/”,
“file_name”: “target_ad_03.mp4”,
“file_size”: “4mb”,
“flag”: “cache_long”
},
“id”: 1
}

The request corresponds to a request for storing a file (target_ad_03.mp4) corresponding to a broadband resource (http://www.kbs.co.kr/target_ad_cdn/target_ad_03.mp4) in the long term cache.

The application forwards the request to the HTTP proxy (step 1).

Subsequently, the HTTP proxy downloads the file using a URL (Internet URL) included in the request (step 2).

Subsequently, the HTTP proxy forwards the downloaded file to the local cache manager and the local cache manager forwards the downloaded file to the cache storage manager (step 3).

Subsequently, the cache storage manager stores the file in the long term cache and records information related to the file on the cache storage manifest (step 4).

Subsequently, the cache storage manager forwards information indicating that the file has been successfully stored in the long term cache to the local cache manager (step 5), the local cache manager forwards the information to the HTTP proxy, and the HTTP proxy forwards a result for the Cache Save to the application (step 5).

The result forwarded to the application by the HTTP proxy can be represented as follows.

{
“jsonrpc”: “2.0”,
“result”: {
“retcode”: “Success”,
“url”:
“https://192.168.219.101/atsc3.0/cacheStorage/

cache_long/kbs1/target_ad_insertion/selected_ad/target_ad_03.mp4”

},
“id”: 1
}

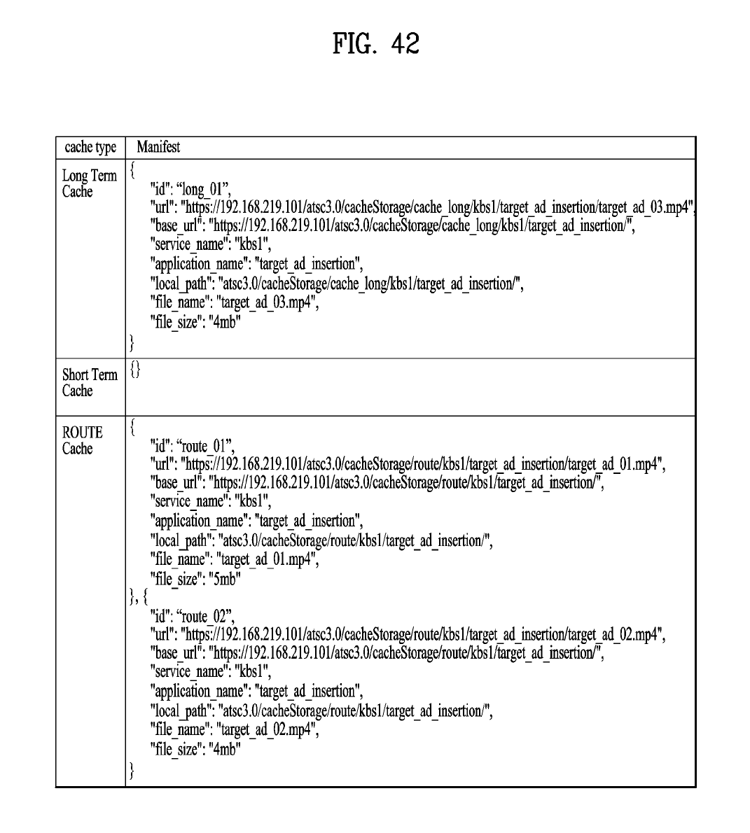

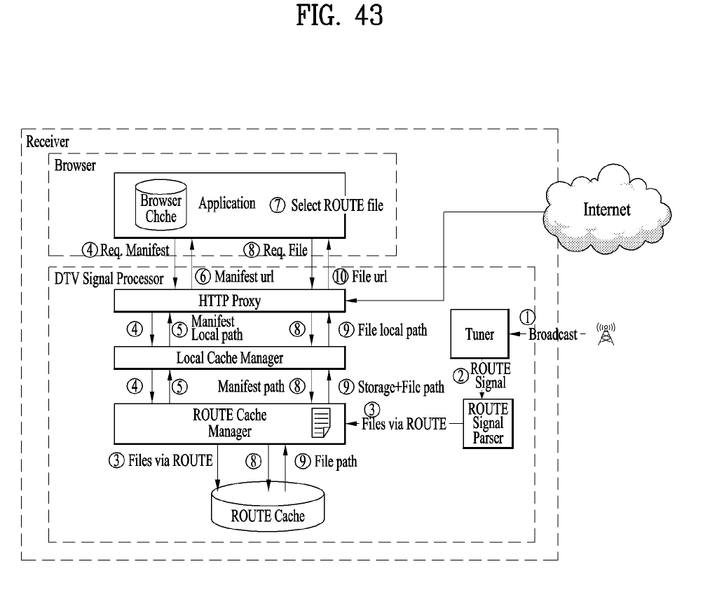

FIG. 42 is a diagram illustrating a manifest configured according to an operation of a receiver illustrated in FIG. 41.

FIG. 42 illustrates a configuration of a manifest after a “target_ad_03.mp4” file is moved to a long term cache by completing an operation of FIG. 41 in a state that a “target_ad_01.mp4” file and a “target_ad_02.mp4” file are stored in a ROUTE cache.

First of all, a manifest for the long term cache includes information on the “target_ad_03.mp4” file stored in the long term cache.

Specifically, the information on the “target_ad_03.mp4” file recorded on the long term cache manifest includes identification information (long_01) on the file, URL information of the file, Base URL information of the file, a service name (kbs1) related to the file, an application name (target_ad_insertion) related to the file, a local path (atsc3.0/cacheStorage/cache_long/kbs1/target_ad_insertion/) of the file, a name (target_ad_03.mp4) of the file, and a size (4 mb) of the file.

In the present embodiment, since a file is not stored in the short term cache, a manifest for the short term cache does not include information on the file.

Subsequently, a manifest for the ROUTE cache includes information on the “target_ad_01.mp4” file and the “target_ad_02.mp4” file stored in the ROUTE cache.

Specifically, the information on the “target_ad_01.mp4” file recorded on the ROUTE cache manifest includes identification information (route_01) on the file, URL information of the file, Base URL information of the file, a service name (kbs1) related to the file, an application name (target_ad_insertion) related to the file, a local path of the file, a name (target_ad_01.mp4) of the file, and a size (5 mb) of the file.

Specifically, the information on the “target_ad_02.mp4” file recorded on the ROUTE cache manifest includes identification information (route_02) on the file, URL information of the file, Base URL information of the file, a service name (kbs1) related to the file, an application name (target_ad_insertion) related to the file, a local path of the file, a name (target_ad_02.mp4) of the file, and a size (4 mb) of the file.

In the following, a scenario for an application to access a file stored in the local cache is explained.

First of all, a scenario for an application to access a file stored in the ROUTE cache and configure a relevant manifest is explained. More specifically, according to procedures of the present scenario, a receiver stores a file included in a broadcast signal in the ROUTE cache, an application requests a manifest, and the application accesses the file stored in the ROUTE cache based on information recorded on the manifest.

Accessing a File Stored in ROUTE Cache and Configuring a Relevant Manifest

FIG. 43 is a diagram illustrating an operation of a receiver according to a further different embodiment of the present invention.

In an embodiment of FIG. 43, a receiver includes a ROUTE cache.

FIG. 43 illustrates steps (step 1, step 2, and step 3) for a receiver to store a file included in a broadcast signal in the ROUTE cache, steps (step 4, step 5, and step 6) for an application to request and obtain a manifest, and steps (step 8, step 9, and step 10) for the application to request and obtain a file based on the obtained manifest. When the application requests and obtains a file, the manifest can be updated.

First of all, a tuner of a DTV signal processor receives a broadcast signal from a broadcast network (step 1).

The tuner forwards a ROUTE signal included in the broadcast signal to a route signal parser (step 2).

The route signal parser extracts an NRT file from the ROUTE signal and forwards the NRT file to a ROUTE cache manager (step 3). The ROUTE cache manager stores the received file in a ROUTE cache and records information related to the file on a route cache manifest (step 3).

In this case, an example of the route cache manifest may correspond to https://192.168.219.101/atsc3.0/cacheStorage/route/manifest.json. Specifically, the route cache manifest can be represented as follows.

{
″id″: “route_01”,
″url″:
″https://192.168.219.101/atsc3.0/cacheStorage/route/kbs1/target_ad_ins

ertion/target_ad_01.mp4″,

″base_url″:
″https://192.168.219.101/atsc3.0/cacheStorage/route/kbs1/target_ad_ins

ertion/″,

″service_name″: ″kbs1″,
″application_name″: ″target_ad_insertion″,
″local_path″:
″atsc3.0/cacheStorage/route/kbs1/target_ad_insertion/″,
″file_name″: ″target_ad_01.mp4″,
″file_size″: ″5mb″
}, {
″id″: “route_02”,
″url″:
″https://192.168.219.101/atsc3.0/cacheStorage/route/kbs1/target_ad_ins

ertion/target_ad_02. mp4″,

″base_url″:
″https://192.168.219.101/atsc3.0/cacheStorage/route/kbs1/target_ad_ins

ertion/″,

″service_name″: ″kbs1″,
″application_name″: ″target_ad_insertion″,
″local_path″:
″atsc3.0/cacheStorage/route/kbs1/target_ad_insertion/″,
″file_name″: ″target_ad_02.mp4″,
″file size″: ″4mb″
}

In the present embodiment, the NRT file, which is received in a manner of being included in the broadcast signal, corresponds to a target_ad_01.mp4 file and a target_ad_01.mp4 file. The files are stored in the ROUTE cache.

Subsequently, the application requests a manifest to the HTTP proxy (step 4). According to one embodiment, the application can request a specific ROUTE cache manifest to the HTTP proxy. The HTTP proxy forwards the request received from the application to the local cache manager and the local cache manager can forward the request to the route cache manager. In particular, the manifest request of the application can be forwarded to the HTTP proxy, the local cache manager, and the route cache manager, sequentially.

In this case, the application can request the manifest to the HTTP proxy using the RequestManifest scheme. The request forwarded to the HTTP proxy by the application can be represented as follows.

{
“jsonrpc”: “2.0”,
“method”:“org.atsc.cacheStorage.RequestManifest”,
“params”: {“type”: “route”},
“id”: 1
}

Having received the manifest request, the route cache manager can forward a manifest to the local cache manager. In the present embodiment, the route cache manager can forward path information (route/manifest.json) capable of obtaining a manifest to the local cache manager.

More specifically, when the route cache manager forwards ROUTE Cache Manifest path (route/manifest.json) to the local cache manager, the local cache manager coverts the ROUTE Cache Manifest path into a local path and can forwards the local path to the HTTP proxy (step 5).

The HTTP proxy converts the received local path of the manifest into http url (https://192.168.219.101/atsc3.0/cacheStorage/route/manifest.json) and can forward the http url to the application (step 6).

In this case, a result forwarded to the application by the HTTP proxy can be represented as follows.

{
″jsonrpc″: ″2.0″,
″result″: {
″type″: ″route″,
“url″:
“https://192.168.219.101/atsc3.0/cacheStorage/route/manifest.json”},
″id″: 1
}

Subsequently, the application can select a file to be accessed by the application based on the forwarded manifest. The application can select a file (“id”: “route_01”) (step 7).

Subsequently, the application can request the selected file (“id”: “route_01”) to the HTTP proxy (step 8). The HTTP proxy forwards the request to the local cache manager and the local cache manager can forward the request to the ROUTE cache manager (step 8). In particular, the request can be forwarded to the HTTP proxy, the local cache manager, and the route cache manager, sequentially. The route cache manager can extract a corresponding file from the route cache.

In this case, the application can request the selected file (“id”: “route_01”) to the HTTP proxy using the CacheFetch scheme. The request forwarded to the HTTP proxy by the application can be represented as follows.

{
“jsonrpc”: “2.0”,
“method”: “org.atsc.cacheStorage.CacheFetch”,
“params”: {
“type”: “route”,
“id”: “route_01”},
“id”: 3
}

When the requested file (“id”: “route_01”) is stored in the route cache, the ROUTE cache manager extracts the file from the route cache and forwards the file to the local cache manager. The local cache manager can forward the file to the HTTP proxy (step 9).

In the present embodiment, the route cache manager coverts file path information (kbs1/target_ad_insertion/target_ad_01.mp4) capable of obtaining the file into storage path information and can forward the storage path information to the local cache manager (step 10). The local cache manager coverts the storage path information (route/kbs1/target_ad_insertion/target_ad_01.mp4) into local path information and can forward the local path information to the HTTP proxy (step 10).

Subsequently, the HTTP proxy converts the local file path into http url and can forward the http url to the application (step 10).

In this case, a result forwarded to the application by the HTTP proxy can be represented as follows.

{
″jsonrpc″: ″2.0″,
″result″: {
″type″: ″route″,
“url″:
“https://192.168.219.101/atsc3.0/cacheStorage/route/kbs1/target_ad_in
sertion/target_ad_01.mp4”},
″id″: 3
}

In the following, a scenario for the application to access a file stored in the cache storage and configure a relevant manifest is explained. More specifically, when a file is stored in the cache storage, the present scenario can include procedures for the application to request a manifest and access the file stored in the cache storage based on information recorded on the manifest.

Accessing a File Stored in the Cache Storage and Configuring a Relevant Manifest

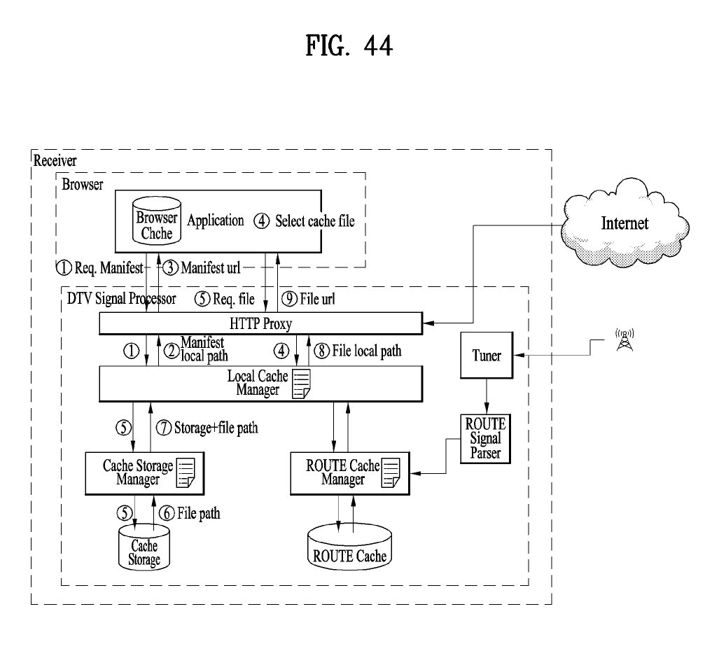

FIG. 44 is a diagram illustrating an operation of a receiver according to a further different embodiment of the present invention.

In an embodiment of FIG. 44, a receiver includes a ROUTE cache and cache storage.

FIG. 44 illustrates steps (step 1, step 2, and step 3) for an application to request and obtain a manifest and steps (step 4, step 5, step 6, step 7, step 8, and step 9) for the application to request and obtain a file based on the obtained manifest. When the application requests and obtains a file, the manifest can be updated.

First of all, the application requests a manifest to the HTTP proxy (step 1). According to one embodiment, the application can request all manifests to the HTTP proxy. The HTTP proxy forwards the request received from the application to the local cache manager (step 1).

In this case, the application can request the manifests to the HTTP proxy using RequestManifest scheme. The request forwarded to the HTTP proxy by the application can be represented as follows.

{
“jsonrpc”: “2.0”,
“method”:“org.atsc.cacheStorage.RequestManifest”,
“params”: {“type”: “all”},
“id”: 1
}

Having received the manifest request, the local cache manager can forward a manifest to the HTTP proxy. In the present embodiment, the local cache manager can forward local path information (atsc3.0/cacheStorage/manifest.json) capable of obtaining a manifest to the HTTP proxy (step 2).

The HTTP proxy converts the local path of the manifest into http url (https://192.168.219.101/atsc3.0/cacheStorage/manifest.json) and can forward the http url to the application (step 3).

In this case, a result forwarded to the application by the HTTP proxy can be represented as follows.

{
″jsonrpc″: ″2.0″,
″result″: {
″type″: ″all″,
“url″:
https://192.168.219.101/atsc3.0/cacheStorage/manifest.json
}
″id″: 1
}

Subsequently, the application can select a file to be accessed by the application based on the forwarded manifest. The application can select a file (“id”: “cache_01”) (step 4).

Subsequently, the application can request the selected file (“id”: “cache_01”) to the HTTP proxy (step 5). The HTTP proxy forwards the request to the local cache manager and the local cache manager can forward the request to the ROUTE cache manager (step 5). In particular, the request can be forwarded to the HTTP proxy, the local cache manager, and the cache storage manager, sequentially. The cache storage manager can extract a corresponding file from the cache storage.

In this case, the application can request the selected file (“id”: “cache_01”) to the HTTP proxy using the CacheFetch scheme. The request forwarded to the HTTP proxy by the application can be represented as follows.

{
“jsonrpc”: “2.0”,
“method”: “org.atsc.cacheStorage.CacheFetch”,
“params”: {
“type”: “cache”,
“id”: “route_01”},
“id”: 3
}

When the requested file (“id”: “cache_01”) is stored in the cache storage, the cache storage manager extracts the file from the cache storage and forwards the file to the local cache manager. The local cache manager can forward the file to the HTTP proxy (step 6).

In the present embodiment, the cache storage manager coverts file path information (kbs1/target_ad_insertion/target_ad_01.mp4) capable of obtaining the file

into storage path information (cache/kbs1/target_ad_insertion/target_ad_01.mp4) and can forward the storage path information to the local cache manager (step 7).

The local cache manager coverts the storage path information (cache/kbs1/target_ad_insertion/target_ad_01.mp4) into local path information (atsc3.0/cacheStorage/cache/kbs1/target_ad_insertion/target_ad_01.mp4) and

can forward the local path information to the HTTP proxy (step 8).

Subsequently, the HTTP proxy converts the local file path into http url (https://192.168.219.101/atsc3.0/cacheStorage/cache/kbs1/target_ad_insertion/target_ad_01. mp4) and can forward the http url to the application (step 9).

In this case, a result forwarded to the application by the HTTP proxy can be represented as follows.

{
″jsonrpc″: ″2.0″,
″result″: {
″type″: ″cache″,
“url″:
https://192.168.219.101/atsc3.0/cacheStorage/cache/kbs1/target_ad_ins
ertion/target_ad01.mp4”
}
″id″: 3
}

In the following, a scenario for the application to access a file stored in a long term cache and configure a relevant manifest is explained. More specifically, when a file is stored in the long term cache, the present scenario can include procedures for the application to request a manifest and access the file stored in the long term cache based on information recorded on the manifest.

Accessing a File Stored in the Long Term Cache and Configuring a Relevant Manifest

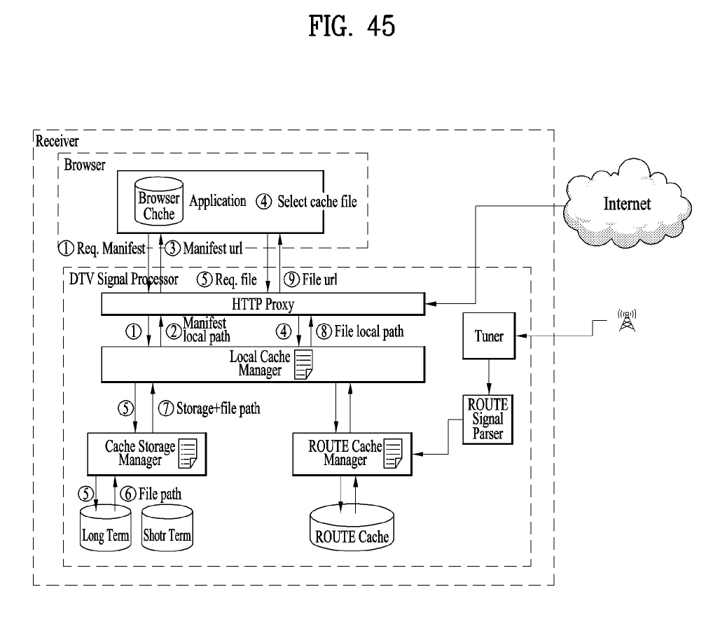

FIG. 45 is a diagram illustrating an operation of a receiver according to a further different embodiment of the present invention.

In an embodiment of FIG. 45, a receiver includes a ROUTE cache and cache storage. The cache storage includes a long term cache and a short term cache.

FIG. 45 illustrates steps (step 1, step 2, and step 3) for an application to request and obtain a manifest and steps (step 4, step 5, step 6, step 7, step 8, and step 9) for the application to request and obtain a file based on the obtained manifest. When the application requests and obtains a file, the manifest can be updated.

First of all, the application requests a manifest to the HTTP proxy (step 1). According to one embodiment, the application can request all manifests to the HTTP proxy. The HTTP proxy forwards the request received from the application to the local cache manager (step 1).

In this case, the application can request the manifests to the HTTP proxy using RequestManifest scheme. The request forwarded to the HTTP proxy by the application can be represented as follows.

{
″jsonrpc″: ″2.0″,
″method″:″org.atsc.cacheStorage.RequestManifest″,
″params″: {″type″: “all″ },
″id″: 1
}

Having received the manifest request, the local cache manager can forward a manifest to the HTTP proxy. In the present embodiment, the local cache manager can forward local path information (atsc3.0/cacheStorage/manifest.json) capable of obtaining a manifest to the HTTP proxy (step 2).

The HTTP proxy converts the local path of the manifest into http url (https://192.168.219.101/atsc3.0/cacheStorage/manifest.json) and can forward the http url to the application (step 3).

In this case, a result forwarded to the application by the HTTP proxy can be represented as follows.

{
″jsonrpc″: ″2.0″,
″result″: {
″type″: “all″,
″url″:
″https://192.168.219.101/atsc3.0/cacheStorage/manifest.json″
},
″id″: 1
}

Subsequently, the application can select a file to be accessed by the application based on the forwarded manifest. The application can select a file (“id”: “long_01”) (step 4).

Subsequently, the application can request the selected file (“id”: “long_01”) to the HTTP proxy (step 5). The HTTP proxy forwards the request to the local cache manager and the local cache manager can forward the request to the ROUTE cache manager (step 5). In particular, the request can be forwarded to the HTTP proxy, the local cache manager, and the cache storage manager, sequentially. The cache storage manager can extract a corresponding file from the long term cache.

In this case, the application can request the selected file (“id”: “long_01”) to the HTTP proxy using the CacheFetch scheme. The request forwarded to the HTTP proxy by the application can be represented as follows.

{
″jsonrpc″: ″2.0″,
″method″: ″org.atsc.cacheStorage.CacheFetch″,
″params″: {
″type″: “cache_long″,
″id″: “long_01″},
″id″: 3
}

When the requested file (“id”: “long_01”) is stored in the long term cache, the cache storage manager extracts the file from the long term cache and forwards the file to the local cache manager. The local cache manager can forward the file to the HTTP proxy (step 6).

In the present embodiment, the cache storage manager coverts file path information (kbs1/target_ad_insertion/target_ad_01.mp4) capable of obtaining the file into storage path information and can forward the storage path information to the local cache manager (step 7). The local cache manager coverts the storage path information into local path information (atsc3.0/cacheStorage/cache_long/kbs1/target_ad_insertion/target_ad_01. mp4) and can forward the local path information to the HTTP proxy (step 8).

Subsequently, the HTTP proxy converts the local file path into http url and can forward the http url to the application (step 9).

In this case, a result forwarded to the application by the HTTP proxy can be represented as follows.

{
″jsonrpc″: ″2.0″,
″result″: {
″type″: “cache_long″,
“url″:https://192.168.219.101/atsc3.0/cacheStorage
/cache_long/kbs1/target_ad_insertion
/target_ad_01. mp4”
},
″id″: 3
}

In the foregoing description, a procedure for accessing the long term cache has been explained. A procedure for accessing a short term cache may correspond to the procedure for accessing the long term cache.

In the following, a scenario for deleting a file stored in the local cache is explained.

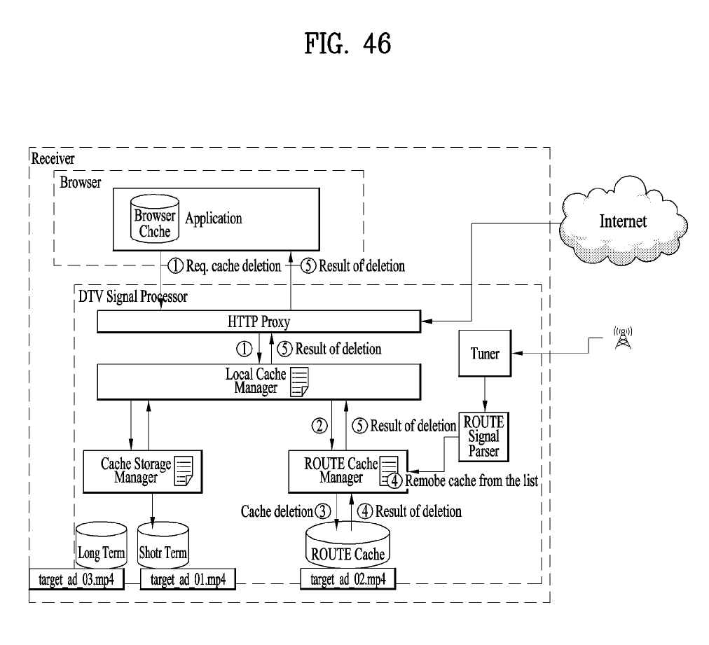

An embodiment explained through FIG. 46 corresponds to an embodiment of deleting a file stored in the ROUTE cache.

Deleting a File Stored in the ROUTE Cache and Configuring a Relevant Manifest

FIG. 46 is a diagram illustrating an operation of a receiver according to a further different embodiment of the present invention.

In an embodiment of FIG. 46, a receiver includes a ROUTE cache and cache storage. The cache storage includes a long term cache and a short term cache.

FIG. 46 illustrates steps (step 1, step 2, step 3, step 4 and step 5) for an application to delete a file (target_ad_02.mp4) stored in the ROUTE cache. When the file is deleted upon the request of the application, the manifest can be updated.

First of all, the application can select a file to be deleted.

Subsequently, the application asks (requests) the HTTP proxy to delete the selected file (target_ad_02.mp4, “id”: “route_02”) (step 1). The HTTP proxy can forward the request received from the application to the local cache manager (step 1).

In this case, the application can ask the HTTP proxy to delete the selected file using the cache delete scheme. The request forwarded to the HTTP proxy by the application can be represented as follows.

{
“jsonrpc”: “2.0”,
“method”: “org.atsc.cacheStorage.CacheDelete”,
“params”: {
“type”: “route”,
“id”: “route_02”
},
“id”: 3
}

Subsequently, the local cache manager can forward the request for deleting the selected file (target_ad_02.mp4, “id”: “route_02”) to the ROUTE cache manager.

Subsequently, the ROUTE cache manager can delete the file included in the ROUTE cache according to the request for deleting the selected file (step 3).

If the selected file is successfully deleted from the ROUTE cache, the ROUTE cache manager records information indicating that the file has been deleted from the ROUTE cache on a route cache manifest (step 4). In other word, the ROUTE cache manager can delete information on the file from the route cache manifest.

Subsequently, the ROUTE cache manager forwards the information indicating that the selected file has been successfully deleted to the local cache manager. The local cache manager forwards the information to the HTTP proxy (step 5). The HTTP proxy forwards the information indicating that the selected file has been successfully deleted to the application in a form of a result (step 5).

In this case, the result forwarded to the application by the HTTP proxy can be represented as follows.

{
“jsonrpc”: “2.0”,
“result”: {
“retcode”: “Success”
},
“id”: 3
}

In the foregoing description, an embodiment of deleting a file stored in the ROUTE cache has been explained with reference to FIG. 46. An embodiment of deleting a file included in the cache storage corresponds to the deleting procedure mentioned earlier in FIG. 46. Hence, repetitive explanation is omitted at this time.

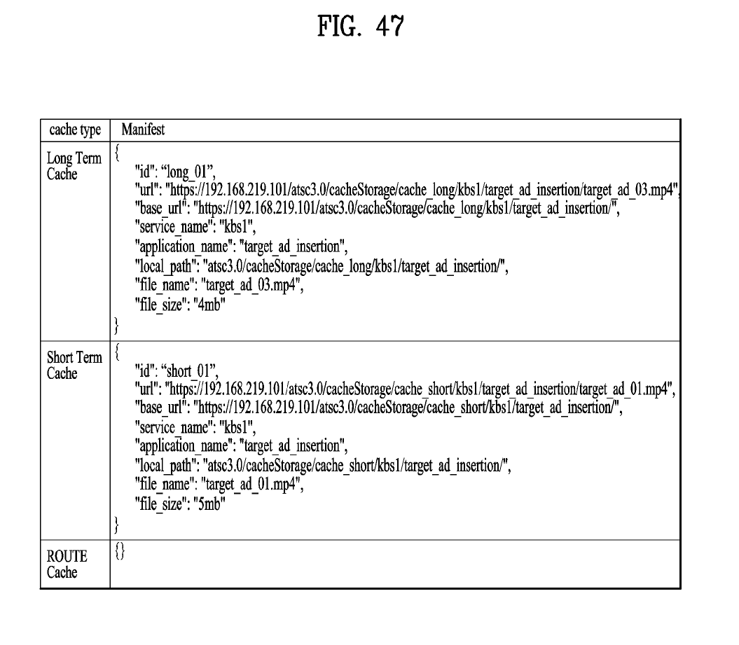

FIG. 47 is a diagram illustrating a manifest configured after an operation of FIG. 46 is completed.

FIG. 47 illustrates a configuration of a manifest after a “target_ad_02.mp4” file stored in a ROTE cache is deleted by completing the operation of FIG. H in a state that a “target_ad_03.mp4” file is stored in a long term cache, a “target_ad_01.mp4” is stored in a short term cache, and the “target_ad_02.mp4” is stored in the ROUTE cache.

First of all, a manifest for the long term cache includes information on the “target_ad_03.mp4” file stored in the long term cache.

Specifically, information on the target_ad_03.mp4″ file recorded on a long term cache manifest includes identification information (long_01) on the file, URL information of the file, Base URL information of the file, a service name (kbs1) related to the file, an application name (target_ad_insertion) related to the file, a local path (atsc3.0/cacheStorage/cache_long/kbs1/target_ad_insertion/) of the file, a name (target_ad_03.mp4) of the file, and a size (4 mb) of the file.

And, information on the target_ad_01.mp4″ file recorded on a short term cache manifest includes identification information (short_01) on the file, URL information of the file, Base URL information of the file, a service name (kbs1) related to the file, an application name (target_ad_insertion) related to the file, a local path of the file, a name (target_ad_01.mp4) of the file, and a size (5 mb) of the file.

In the present embodiment, since the “target_ad_02.mp4” file stored in the ROUTE cache is deleted, a manifest for the ROUTE cache does not include information on the file.

In the following, a scenario for clearing local cache is explained.

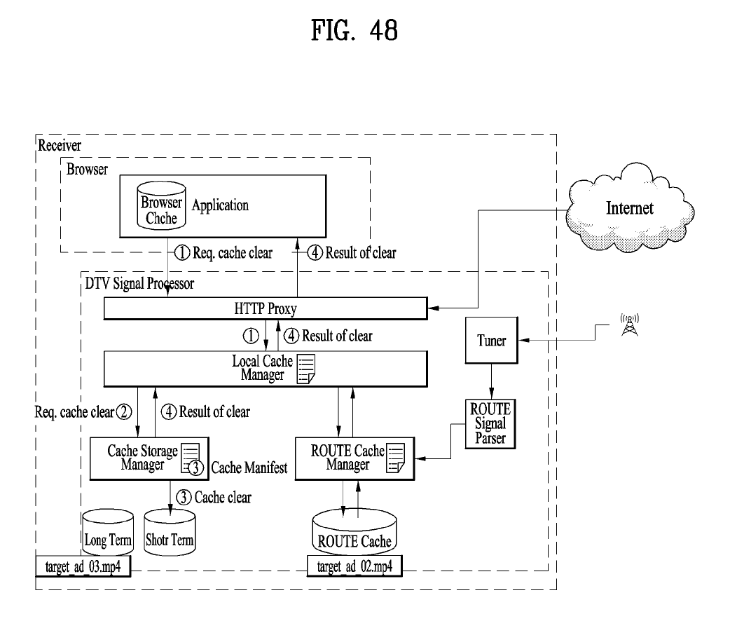

An embodiment explained through FIG. 48 corresponds to an embodiment of clearing local cache. In particular, FIG. 48 illustrates an embodiment of deleting all files stored in a specific cache upon the request of an application.

Clear Request of Application and Relevant Manifest Configuration

FIG. 48 is a diagram illustrating an operation of a receiver according to a further different embodiment of the present invention.

In an embodiment of FIG. 48, a receiver includes a ROUTE cache and cache storage. The cache storage includes a long term cache and a short term cache.

FIG. 48 illustrates steps (step 1, step 2, step 3, and step 4) for an application to request clearing of the short term cache. When the short term cache is cleared upon the request of the application, a manifest can be updated.

First of all, the application asks (requests) the HTTP proxy to clear the short term cache (step 1). The HTTP proxy can forward the request received from the application to the local cache manager (step 1).

In this case, the application can ask the HTTP proxy to clear the short term cache using the cache clear scheme. The request forwarded to the HTTP proxy by the application can be represented as follows.

{
″jsonrpc″: ″2.0″,
″method″: ″org.atsc.cacheStorage.ClearCache″,
″params″: {
″type″: “short″
},
″id″: 5
}

Subsequently, the local cache manager can forward the clear request to the cache storage manager (step 2).

Subsequently, the local cache manager can delete all files included in the short term cache according to the clear request (step 3). If a selected file is successfully deleted from the short term cache, the cache storage manager records information indicating that the file has been deleted from the short term cache on a cache storage manifest (step 3).

Subsequently, the cache storage manager forwards information indicating that the short term cache has been successfully cleared to the local cache manager and the local cache manager forwards the information to the HTTP proxy (step 4). The HTTP proxy forwards the information indicating that the short term cache has been successfully cleared to the application in a form of a result (step 4).

In this case, the result forwarded to the application by the HTTP proxy can be represented as follows.

{
″jsonrpc″: ″2.0″,
″result″: {
“retcode″: “Success″,
″type″: “short″,
″queatSize″: 100000000,
″usageSize″: 0
},
″id″: 5
}

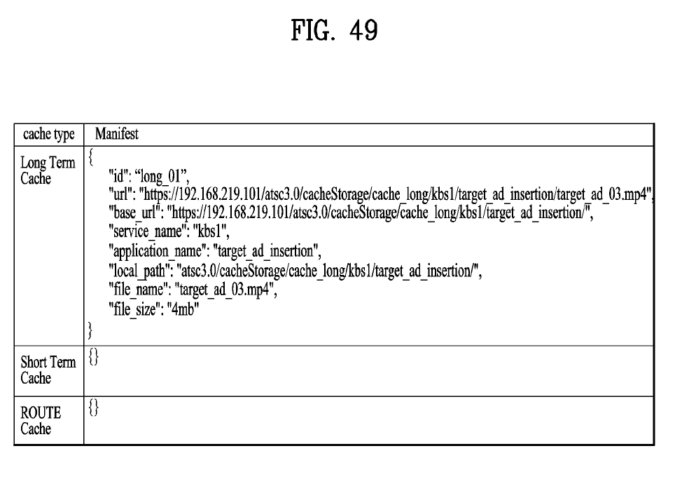

FIG. 49 is a diagram illustrating a manifest configured according to an operation of a receiver illustrated in FIG. 48.

FIG. 49 illustrates a configuration of a manifest after a short term cache is cleared by completing the operation of FIG. 48 in a state that a “target_ad_03.mp4” file is stored in a long term cache, a “target_ad_01.mp4” is stored in the short term cache, and the ROUTE cache is empty.

First of all, a manifest for the long term cache includes information on the “target_ad_03.mp4” file stored in the long term cache.

Specifically, information on the target_ad_03.mp4″ file recorded on a long term cache manifest includes identification information (long_01) on the file, URL information of the file, Base URL information of the file, a service name (kbs1) related to the file, an application name (target_ad_insertion) related to the file, a local path of the file, a name (target_ad_03.mp4) of the file, and a size (4 mb) of the file.

In the present embodiment, since the short term cache is cleared, all files stored in the short term cache are deleted. Hence, a manifest for the short term cache does not include information on a file.

In the present embodiment, since the ROUTE cache is empty, a manifest for the ROUTE cache does not include information on a file.

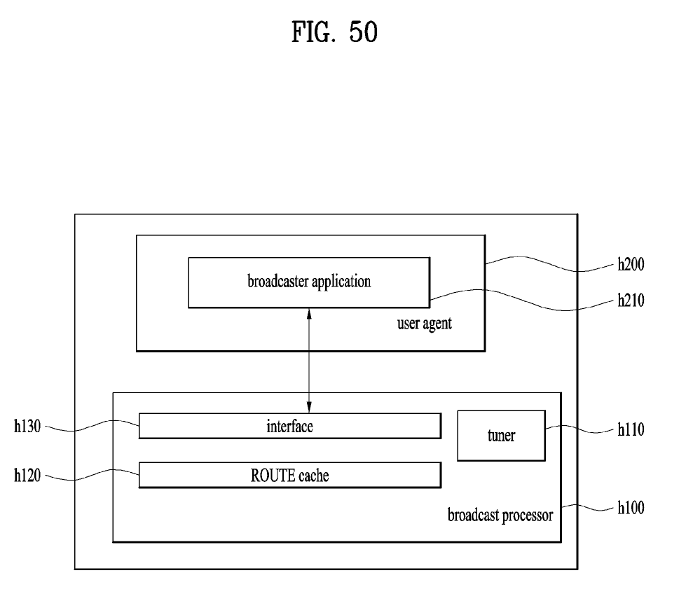

FIG. 50 is a block diagram illustrating a broadcast signal reception device according to one embodiment of the present invention.

According to one embodiment of the present invention, a broadcast signal reception device includes a broadcast processor h100 and a user agent h200.

The broadcast processor h100 includes a tuner h210, a ROUTE cache h120, and an interface h130.

In various embodiments, the broadcast processor h100 may correspond to the DTV processor (DTV signal processor) mentioned earlier in FIGS. 16, 17, 18, 19, 20, 33, 35, 36, 38, 39, 40, 41, 43, 45, 46, and 48 and explanation on the DTV processor can be applied to the broadcast processor h100.

The tuner h210 can receive a broadcast signal through a broadcast network. The broadcast signal can include a ROUTE file according to a ROUTE (Real-Time Object Delivery over Unidirectional Transport) protocol. In various embodiments, the tuner h210 may correspond to the tuner mentioned earlier in FIGS. 12, 16, 17, 18, 19, 20, 33, 35, 36, 38, 39, 40, 41, 43, 45, 46, and 48 and explanation on the tuner can be applied to the tuner h210.

The ROUTE cache h120 corresponds to storage in which a ROUTE file is stored. The ROUTE cache h120 can store a ROUTE file included in a broadcast signal. In various embodiments, the ROUTE cache h120 may correspond to the ROUE cache mentioned earlier in FIGS. 16, 17, 18, 19, 20, 33, 35, 36, 38, 39, 40, 41, 43, 45, 46, and 48 and explanation on the ROUTE cache can be applied to the ROUTE cache h120.

The interface h130 can establish a connection between the broadcast processor h100 and the broadcaster application h210. It is able to perform communication between the broadcast processor h100 and the broadcaster application h210 trough the interface h130. In various embodiments, the interface h130 may correspond to the HTTP proxy mentioned earlier in FIGS. 16, 17, 18, 19, 20, 33, 35, 36, 38, 39, 40, 41, 43, 44, 45, 46, and 48 and explanation on the HTTP proxy can be applied to the interface h130.

In this case, a connection between the interface h130 and the broadcaster application h210 can be established via a websocket protocol. The connection between the interface h130 and the broadcaster application h210 can be established as shown in FIG. 20. And, a request message and a result (response) message can be transmitted and received between the interface h130 and the broadcaster application h210. Specifically, a message transmitted and received between the interface h130 and the broadcaster application h210 may correspond to a JSON-RPC message. A specific embodiment for the JSON-RPC message has been explained with reference to FIGS. 21 to 32 and a process of comprehensively managing cache using the JSON-RPC message has been explained with reference to FIGS. 33 to 49.

The user agent h200 can execute the broadcaster application h210. The user agent h200 may correspond to the browser mentioned earlier in FIGS. 16, 17, 18, 19, 20, 33, 35, 36, 38, 39, 40, 41, 43, 44, 45, 46, and 48.

The broadcaster application h210 may correspond to an application provided by a broadcasting service of a broadcasting company. The broadcaster application may correspond to a collection of files consisting of HTML5 document, images, and/or multimedia resources. In various embodiments, the broadcaster application h210 may correspond to the application mentioned earlier in FIGS. 16, 17, 18, 19, 20, 33, 35, 36, 38, 39, 40, 41, 43, 44, 45, 46, and 48.

According to a different embodiment of the present invention, the broadcast processor h100 is included in a primary device and the user agent h210 can be included in a companion device.

According to a further different embodiment, the broadcast signal reception device can further include a ROUTE cache manager (not depicted). The ROUTE cache manager (not depicted) may correspond to the ROUTE cache manager mentioned earlier in FIGS. 16, 17, 18, 19, 20, 33, 35, 36, 38, 39, 40, 41, 43, 44, 45, 46, and 48.

According to a further different embodiment, the broadcast signal reception device can further include a local cache manager (not depicted). The local cache manager (not depicted) may correspond to the local cache manager mentioned earlier in FIGS. 16, 17, 18, 19, 20, 33, 35, 36, 38, 39, 40, 41, 43, 44, 45, 46, and 48.

An embodiment that the broadcast processor includes a tuner, a ROUTE cache, a ROUTE cache manager, and a local cache manager is illustrated in FIGS. 16 and 43. When the local cache manager and the ROUTE cache manager exist, a request forwarded to the interface h130 from the broadcaster application h210 can be forwarded to the ROUTE cache manager via the local cache manager. Similarly, when the local cache manager and the ROUTE cache manager exist, a response forwarded to the broadcaster application h210 from the interface h130 is forwarded to the interface h130 via the ROUTE cache manager and the local cache manager and the response can be forwarded to the broadcaster application h210.

According to a further different embodiment, the broadcast signal reception device can further include a cache storage (not depicted) and a cache storage manager (not depicted). The cache storage and the cache storage manager may respectively correspond to the cache storage and the cache storage manager mentioned earlier in FIGS. 16, 17, 18, 19, 20, 33, 35, 36, 38, 39, 40, 41, 43, 44, 45, 46, and 48.

An embodiment that the broadcast processor includes a tuner, a ROUTE cache, a ROUTE cache manager, a local cache manager, a cache storage manager, and cache storage is illustrated in FIGS. 17, 35, 39, and 44. When the local cache manager, the ROUTE cache manager, and the cache storage manager exist, a request forwarded to the interface h130 from the broadcaster application h210 can be forwarded to the ROUTE cache manager and the cache storage manager via the local cache manager. Similarly, when the local cache manager, the ROUTE cache manager, and the cache storage manager exist, a response forwarded to the broadcaster application h210 from the interface h130 is forwarded to the interface h130 via the ROUTE cache manager and the local cache manager and then the response is forwarded to the broadcaster application h210. Or, the response is forwarded to the interface h130 via the cache storage manager and the local cache manager and then the response can be forwarded to the broadcaster application h210.

According to a more specific embodiment, cache storage (not depicted) can include a long term cache (not depicted) and a short term cache (not depicted). The long term cache and the short term cache may respectively correspond to the long term cache and the short term cache mentioned earlier in FIGS. 16, 17, 18, 19, 20, 33, 35, 36, 38, 39, 40, 41, 43, 44, 45, 46, and 48.

An embodiment that the broadcast processor includes a tuner, a ROUTE cache, a ROUTE cache manager, a local cache manager, a cache storage manager, and cache storage and the cache storage includes a long term cache and a short term cache is illustrated in FIGS. 18, 19, 20, 21, 33, 36, 38, 40, 41, 45, and 46.

In this case, a file stored in the short term cache can be deleted without permission of the broadcaster application. When an event that capacity exceeds predetermined capacity occurs, the file stored in the short term cache can be deleted. A file stored in the long term cache is not deleted without permission of the broadcaster application.

Meanwhile, as mentioned earlier in FIGS. 15, 34, 37, 42, and 49, the ROUTE cache manager, the local cache manager, and the cache storage manager generate/update a manifest to manage a file stored in each of storages.

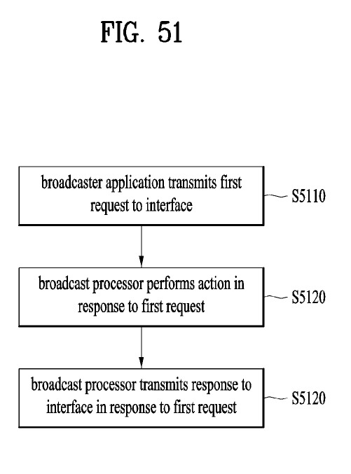

FIG. 51 is a flowchart for a method of processing a broadcast signal according to one embodiment of the present invention.

According to one embodiment of the present invention, a method of processing a broadcast signal can process a broadcast signal using a broadcast processor h100 and a user agent h200. In particular, the method of processing a broadcast signal can be performed by the aforementioned device and each of the steps can be performed by each of elements.

The method of processing a broadcast signal according to one embodiment of the present invention can include the steps of transmitting a first request via an interface that connects the broadcast processor and the broadcaster application [S5110], performing, by the broadcast processor, an action corresponding to the first request [S5120], and transmitting, by the broadcast processor, a first response via the interface in response to the first request [S5130].

In this case, the broadcaster application and the interface can be connected via a websocket protocol and a request and a response may correspond to a JSON-RPC message.

According to a different embodiment of the present invention, the method of processing a broadcast signal can further include the steps of receiving, by the broadcast processor h100, a ROUTE file via a broadcast network and storing the ROUTE file in a ROUTE cache, and storing, by the broadcast processor h100, the ROUTE file stored in the ROUTE cache in cache storage. The steps have been explained with reference to FIGS. 17 and 18.

According to a further different embodiment of the present invention, the method of processing a broadcast signal can further include the step of storing, by the interface, a broadband resource in the cache storage. The step has been explained with reference to FIGS. 17 and 18.

According to a further different embodiment of the present invention, the first request, the action corresponding to the first request and the first response may correspond to the JSON-RPC request and a series of procedures related to the response mentioned earlier in FIGS. 21 to 32.

The internal components of the apparatus may be processors that execute consecutive processes stored in a memory or other hardware components. These may be located inside/outside the apparatus.

In some embodiments, the above-described modules may be omitted, or may be replaced by other modules that perform the same or similar operations.

The above-described parts, modules, or units may be processors or hardware parts that execute consecutive processes stored in a memory (or a storage unit). The steps described in the above-described embodiments can be performed by processors or hardware parts. The modules/blocks/units described in the above-described embodiments can operate as hardware/processors. In addition, the methods proposed by the present invention can be executed as code. Such code can be written on a processor-readable storage medium and thus can be read by a processor provided by an apparatus.

While the present invention has been described with reference to separate drawings for the convenience of description, new embodiments may be implemented by combining embodiments illustrated in the respective drawings. As needed by those skilled in the art, designing a computer-readable recording medium, in which a program for implementing the above-described embodiments is recorded, falls within the scope of the present invention.

The apparatus and method according to the present invention is not limitedly applied to the constructions and methods of the embodiments as previously described; rather, all or some of the embodiments may be selectively combined to achieve various modifications.

Meanwhile, the method according to the present specification may be implemented as code that can be written on a processor-readable recording medium and thus read by a processor provided in a network device. The processor-readable recording medium may be any type of recording device in which data are stored in a processor-readable manner. The processor-readable recording medium may include, for example, read only memory (ROM), random access memory (RAM), compact disc read only memory (CD-ROM), magnetic tape, a floppy disk, and an optical data storage device, and may be implemented in the form of a carrier wave transmitted over the Internet. In addition, the processor-readable recording medium may be distributed over a plurality of computer systems connected to a network such that processor-readable code is written thereto and executed therefrom in a decentralized manner.

In addition, it will be apparent that, although the preferred embodiments have been shown and described above, the present specification is not limited to the above-described specific embodiments, and various modifications and variations can be made by those skilled in the art to which the present invention pertains without departing from the gist of the appended claims. Thus, it is intended that the modifications and variations should not be understood independently of the technical spirit or prospect of the present specification.

Those skilled in the art will appreciate that the present invention may be carried out in other specific ways than those set forth herein without departing from the spirit and essential characteristics of the present invention. Therefore, the scope of the invention should be determined by the appended claims and their legal equivalents, rather than by the above description, and all changes that fall within the meaning and equivalency range of the appended claims are intended to be embraced therein.

In addition, the present specification describes both a product invention and a method invention, and descriptions of the two inventions may be complementarily applied as needed.

### MODE FOR INVENTION

Various embodiments have been described in the best mode for carrying out the invention

### INDUSTRIAL APPLICABILITY

The present invention is usable in a field providing a broadcast signal.

Those skilled in the art will appreciate that the present invention may be carried out in other specific ways than those set forth herein without departing from the spirit and essential characteristics of the present invention. Therefore, the scope of the invention should be determined by the appended claims and their legal equivalents, rather than by the above description, and all changes that fall within the meaning and equivalency range of the appended claims are intended to be embraced therein.

1-13. (canceled)

14. An apparatus for receiving a broadcast signal, the apparatus comprising:
a tuner to receive the broadcast signal including at least one file delivered based on a Real-Time Object Delivery over Unidirectional Transport (ROUTE) protocol;
a storage to store the at least one file,
a manager to manage description information including an identifier for the at least one file,
a user agent to launch a broadcaster application,
the broadcaster application accesses the at least one file based on HTTP requests.

15. The apparatus according to claim 14 further comprising:
a local manager to receive a request for accessing the at least one file from the broadcast application and transfer the request to the manager,
the manager stores the at least one file in the storage.

16. The apparatus according to claim 14,
the description information further includes information on a storage period.

17. The apparatus according to claim 16,
when the information includes a value for a long term storage, the manager stores the at least one file in a long term storage.

18. The apparatus according to claim 16,
when the information includes a value for a short term storage, the manager stores the at least one file in a short term storage.

19. The apparatus according to claim 14,
the broadcaster application sends a first request to store one or more files delivered via broadband based on Application Programming Interface (API),
the one or more files are stored in the storage in response to the first request.

20. The apparatus according to claim 19,
the first request includes information on target location the one or more files to be stored,
the one or more files are stored in a specific location of the storage in response to the first request.

21. The apparatus according to claim 14,
the broadcaster application sends a second request for usage status of the storage based on Application Programming Interface (API),
the broadcaster application obtains information on a quota size of the storage and information on an usage size of the storage in response to the second request.

22. A method of processing a broadcast signal, by a receiver, the method comprising:
receiving, by a tuner, the broadcast signal including at least one file delivered based on a Real-Time Object Delivery over Unidirectional Transport (ROUTE) protocol;
storing, by a storage, the at least one file;
managing, by a manager, description information including an identifier for the at least one file,
launching, by a user agent, a broadcaster application,
accessing, by the broadcaster application, the at least one file based on HTTP requests.

23. The method according to claim 9 further comprising:
receiving, by a local manager, a request for accessing the at least one file from the broadcast application;
transferring, by the local manager, the request to the manager;
storing, by the manager, the at least one file in the storage in response to the request transferred from the local manager.

24. The method according to claim 22,
the description information further includes information on a storage period.

25. The method according to claim 24,
when the information includes a value for a long term storage, the manager stores the at least one file in a long term storage.

26. the method according to claim 24,
when the information includes a value for a short term storage, the manager stores the at least one file in a short term storage.

27. the method according to claim 22 further comprising:
sending, by the broadcaster application, a first request to store one or more files delivered via broadband based on Application Programming Interface (API),
the one or more files are stored in the storage in response to the first request.

28. The method according to claim 22 further comprising:
sending, by the broadcaster application, a second request for usage status of the storage based on Application Programming Interface (API),
obtaining, by the broadcaster application, information on a quota size of the storage and information on an usage size of the storage in response to the second request.
